(19) United States
(12) Patent Application Publication
(10) Pub. No.: US 2025/0370731 A1
(43) Pub. Date: Dec. 4, 2025

(54) Systems And Methods For A Modularized Orchestration Agent, Sub-LLM, And Logic Module Deployment

(71) Applicant: Cisco Technology, Inc., San Jose, CA (US)

(72) Inventors: Umang Agarwal, Menlo Park, CA (US); Seth J. Annabel, Carbondale, CO (US); Akila Balasubramanian, Campbell, CA (US); Nasim Bigdelu, North Vancouver (CA); Kristal Curtis, San Francisco, CA (US); Liang Gou, San Jose, CA (US); Park Kittipatkul, San Jose, CA (US); Christopher Robert Lekas, Kenmore, WA (US); Akshay Mallipeddi, Dublin, CA (US); Amin Moshgabadi, San Diego, CA (US); Katlyn Parvin, Boulder, CO (US); Om Rajyaguru, Westerville, OH (US); Joseph Ari Ross, Redwood City, CA (US); Balaji Reddy Saireddy, San Jose, CA (US); Sahinaz Safari, San Mateo, CA (US); Harsh Vardhan Vashistha, San Francisco, CA (US); Chengyu Yang, Mountain View, CA (US); Hao Yang, San Jose, CA (US)

(21) Appl. No.: 19/227,396

(22) Filed: Jun. 3, 2025

Related U.S. Application Data
(60) Provisional application No. 63/655,572, filed on Jun. 3, 2024.
(60) Provisional application No. 63/661,520, filed on Jun. 18, 2024.
(60) Provisional application No. 63/753,853, filed on Feb. 4, 2025.

(51) Int. Cl. G06F 8/35; G06F 8/41; G06F 40/35

(52) U.S. Cl. CPC G06F 8/35; G06F 8/447; G06F 40/35

(57) ABSTRACT

Some implementations of the disclosure provide a computer-implemented method including operations of receiving, by an orchestration agent, user input corresponding to a user question, wherein generating a response to the user question includes one of generating, editing, or refining programming code, and generating, by the orchestration agent, a prompt instructing a first sub-large language model (LLM) to perform a first task. In response to the prompt, generating, by the first sub-LLM, instructions for a second sub-LLM to perform a second task, wherein results of performing the second task by the second sub-LLM are provided to the first sub-LLM and performing, by the first sub-LLM, the first task utilizing the results of the second task generated by the second sub-LLM. An additional operation includes generating, by the orchestration agent, a GUI that displays the response to the user question, wherein the response includes or is based on the programming code.

### RELATED APPLICATIONS

This application claims the benefit of priority to these applications, U.S. Provisional Application No. 63/753,853, filed Feb. 4, 2025, U.S. Provisional Application No. 63/661,520, filed Jun. 18, 2024, and U.S. Provisional Application No. 63/655,572, filed Jun. 3, 2024, each of which are incorporated by reference in their entirety into this application.

### BACKGROUND

Many enterprise companies seek to understand data pertaining to their operability and network security. For example, an enterprise company may monitor several key performance indicators (KPIs) to track and assess specific measurables or objectives over time. While there are nearly an infinite number of possible KPIs, an enterprise company may monitor several including a net profit margin, a monthly or daily reoccurring revenue, a conversion rate of leads to customers, a number of visitors to a webpage, a click-through rate (CTR) on an ad or email, social media engagement, average resolution time for support tickets, system uptime, etc. As the amount of data that becomes available to an enterprise company, more and more KPIs may be monitored and tracked. However, complications in monitoring occurs as the number of KPIs monitored arises.

As a result of the recent explosion in available data and the consequently the number of KPIs being monitored, enterprise companies have also become heavily invested in observability suites that automate the monitoring, analyzing, and viewing of the data used in KPIs as well as the resultant KPIs themselves. In many instances, the technology underlying an observability suite includes the use of a complex programming language capable of forming logic that, upon execution by one or more processors, automatically obtains the required data for a particular KPI, performs any analysis, manipulation, or filtering needed, and generates a graphical user interface (GUI) configured to display the KPI and any analysis results.

Additionally, Large Language Models (LLMs) have progressed from early language-processing techniques to become sophisticated artificial intelligence (AI) systems reshaping digital communication and content creation. Industries are integrating LLMs in varied ways to streamline operations, boost creativity, and enhance productivity, with applications ranging from customer service to software development and healthcare. Advanced AI agents powered by LLMs are becoming common, allowing businesses to manage customer interactions through natural language understanding, where these agents can handle complex inquiries and generate detailed responses. In creative fields, LLM-based AI agents assist with drafting content, suggesting ideas, and even composing music or visual captions, enhancing creative processes by providing inspiration and augmenting human creativity.

### BRIEF DESCRIPTION OF THE DRAWINGS

Illustrative examples are described in detail below with reference to the following figures:

FIG. 1 is a diagrammatic flow illustrating a communicative coupling between an orchestration agent, a language model (LM), and a plurality of logic modules according to an implementation of the disclosure;

FIG. 2 is a diagrammatic flow illustrating a set of processes included in the automated generation of programming code by a language model deployed by an orchestration agent according to an implementation of the disclosure;

FIG. 3 is a flowchart illustrating an example process of operations for performing a data curation process according to an implementation of the disclosure;

FIG. 4 is a diagrammatic flow illustrating sub-modules and functionality of a language model configured for deployment by an orchestration agent according to an implementation of the disclosure;

FIG. 5 is a diagrammatic flow illustrating detail of an alternative configuration of sub-modules and functionality of a language model configured for deployment by an orchestration agent according to an implementation of the disclosure;

FIG. 6 is a flowchart illustrating an example process of operations for performing generation of programming code in order to answer a natural-language question provided to an orchestration agent by a user according to an implementation of the disclosure;

FIG. 7 is a flowchart illustrating an example process of detailed operations for performing generation of programming code in order to answer a natural-language question provided to an orchestration agent by a user according to an implementation of the disclosure;

FIG. 8 is an example logic module description provided by to the orchestration agent to a language model configured for automated programming code generation according to an implementation of the disclosure;

FIG. 9 is a flowchart illustrating an example process of operations for evaluating the performance of an orchestration agent according to an implementation of the disclosure;

FIG. 10 is a first example graphical user interface configured to deploy an orchestration agent according to an implementation of the disclosure;

FIG. 11 is a second example graphical user interface configured to deploy an orchestration agent according to an implementation of the disclosure;

FIG. 12A is a diagrammatic flow illustrating a communicative coupling between an orchestration agent, a plurality of language models (LMs), and a plurality of logic modules according to an implementation of the disclosure;

FIG. 12B is a flowchart illustrating an example process of operations performed by an orchestration agent of FIG. 12A in executing according to an implementation of the disclosure;

FIG. 13 is a diagrammatic flow illustrating sub-modules and functionality of a language model configured to automatically edit programming code and for deployment by an orchestration agent according to an implementation of the disclosure;

FIG. 14 is a flowchart illustrating an example process of operations for automatically editing programming code by the language model of FIG. 13 according to an implementation of the disclosure;

FIG. 15 is a diagrammatic flow illustrating sub-modules and functionality of a language model configured to automatically increase the efficiency of programming code and for deployment by an orchestration agent according to an implementation of the disclosure;

FIG. 16 is a flowchart illustrating an example process of operations for automatically increasing the efficiency of programming code by the language model of FIG. 15 according to an implementation of the disclosure;

FIG. 17 is a diagrammatic flow illustrating sub-modules and functionality of a language model configured to automatically perform log queries and for deployment by an orchestration agent according to an implementation of the disclosure;

FIG. 18 is a flowchart illustrating an example process of operations for automatically performing log queries by the language model of FIG. 17 according to an implementation of the disclosure;

FIG. 19 is a diagram depicting various subsets of artificial intelligence in accordance with various embodiments of the disclosure;

FIG. 20 depicts different methods of machine-based learning in accordance with various embodiments of the disclosure;

FIG. 21 depicts a machine learning lifecycle in accordance with various embodiments of the disclosure; and

FIG. 22 is an exemplary neural network for use in a fully controlled camera system in accordance with various embodiments of the disclosure.

FIG. 23 is a conceptual illustration of a variety of tokens for utilization within a large language model in accordance with various embodiments of the disclosure;

FIG. 24 is a conceptual illustration of an embedding matrix for a large language model, in accordance with various embodiments of the disclosure;

FIG. 25 is a conceptual illustration of an input prompt converted from a series of tokens into a series of tensors in accordance with various embodiments of the disclosure;

FIG. 26 is a conceptual illustration of an attention layer process within a large language model in accordance with various embodiments of the disclosure;

FIG. 27 is a conceptual illustration of a multi-layer perceptron within a large language model in accordance with various embodiments of the disclosure;

FIG. 28 is a conceptual illustration of an unembedding process within a large language model in accordance with various embodiments of the disclosure;

FIG. 29 is a block diagram illustrating an example computing environment that includes a data intake and query system in accordance with various embodiments of the disclosure;

FIG. 30 is a block diagram illustrating in greater detail an example of an indexing system of a data intake and query system, such as the data intake and query system of FIG. 29 in accordance with various embodiments of the disclosure;

FIG. 31 is a block diagram illustrating in greater detail an example of the search system of a data intake and query system, such as the data intake and query system of FIG. 29 in accordance with various embodiments of the disclosure; and

FIG. 32 illustrates an example of a self-managed network 3200 that includes a data intake and query system in accordance with various embodiments of the disclosure.

### DETAILED DESCRIPTION

In creative fields, LLM-based AI agents may be asked to draft content, suggest ideas, and even compose music or visual captions, which enhances creative processes by providing inspiration and augmenting human creativity. In software development, AI agents may be asked to automate parts of the coding process, generate code snippets, detect bugs, and maintain documentation. However, as LLMs and AI agents support these diverse applications, the demand on GPUs and network infrastructure grows considerably as does the complexity of prompts required to request specific tasks. Typical users are not trained to provide AI agents with specific and particularized prompts that would enable an AI agent to accurately execute the desired tasks. Further, there is an efficiency issue in the execution of prompts that are extremely lengthy due to the inclusion of adequate context to enable the AI agent to return an accurate response.

Some particular implementations of the disclosure provide for a novel deployment of an orchestration agent configured to invoke a specialized agent that includes or is formed of a language model trained or configured specifically to automatically generate programming code of in a specified programming language. Some implementations pertain to receipt of a user input question by an orchestration agent, where the orchestration agent evaluates the user input question and invokes at least the specialized agent to assist in generating a response to the user input question through the automated generation of SignalFlow programs, e.g., programming code written in the SignalFlow programming language and adhering to the required syntax thereof. A clear technical advantage provided by such implementations includes the increased accuracy of the generation of automated programming code through the deployment of a highly trained, specialized agent.

Other implementations of the disclosure provide for a novel deployment of an orchestration agent, a plurality of specialized agents, and a plurality of modularized logic modules that may be invoked by any of the orchestration agent and the plurality of specialized agents. A clear technical advantage of such modularized deployments includes the increased accuracy of generating responses to user input questions received by the orchestration agent. Further, the modularization of the logic modules to perform particularized functions (e.g., retrieval-augmented generation, programming code validation, programming code execution, etc.) leads to decreased processing latency due to particularized prompts provided to one or more specialized agents and a reduction in resource usage at least due to the reusability of the logic modules across multiple specialized agents.

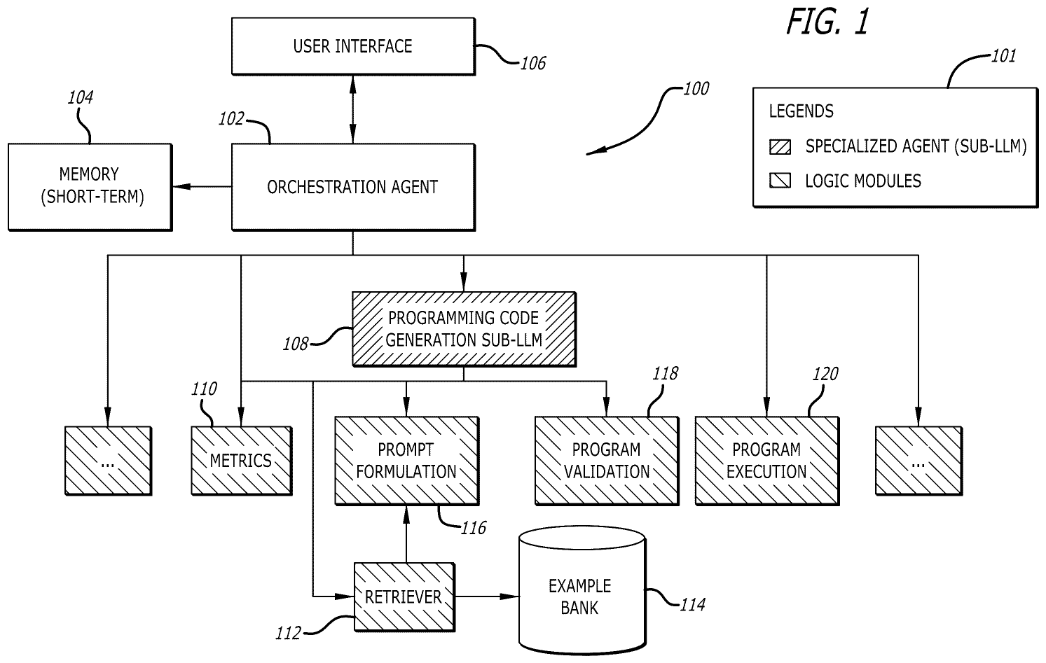

FIG. 1 is a diagrammatic flow illustrating a communicative coupling between an orchestration agent, a language model (LM), and a plurality of logic modules according to an implementation of the disclosure. The operating environment 100 includes a deployable orchestration agent 102 that is coupled to a short-term memory 104, a specialized agent (which may represent a large language model (LLM)), such as the programming code generation sub-LLM 108, and a plurality of logic modules 110, 112, 116, 118, and 120 that may be called by either the orchestration agent 102 or the specialized agent 108. A user may interact with the orchestration agent 102 via a user interface 106.

In some examples, the orchestration agent 102 may be a large language model that is configured to parse a user input question received via the user interface 106, determine a plan for answering the user input question, calling one or more logic modules 110, 112, 116, 118, and 120 and/or the specialized agent 108, and reason with results provided by the logic modules 110, 112, 116, 118, and 120 or the specialized agent 108. For example, a user may provide the following natural-language question: “what is the root cause of high payment service error?” In such an example, the orchestration agent 102 may process the question to determine that the user's intention is to troubleshoot over a particular service. In planning how to answer the question, the orchestration agent 102 may determine that, first, a service having a name such as “payment,” needs to be identified, and second, a logic module needs to be called to determine error breakdown for the service. As a third step, the orchestration agent 102 may then need to determine the breakdown and reason for the possible root cause, which may possibly include invocation of additional logic modules.

In many current examples, the orchestration agent 102 is formed of or includes a language model. The language model may be a closed-source LLM or an open-source LLM. A closed-source LLM should be understood to be a language model whose underlying code, architecture, training data, and weights are proprietary and not publicly available, with an example being OpenAI's GPT-4. An open-source LLM should be understood to be a language model copies of which are available for download by the public, where the underlying code, architecture, and pre-trained weights of such copies may be accessed and modified. Examples of open-source LLMs include Mistral 7B, GPT-NeoX, and FLAN-T5.

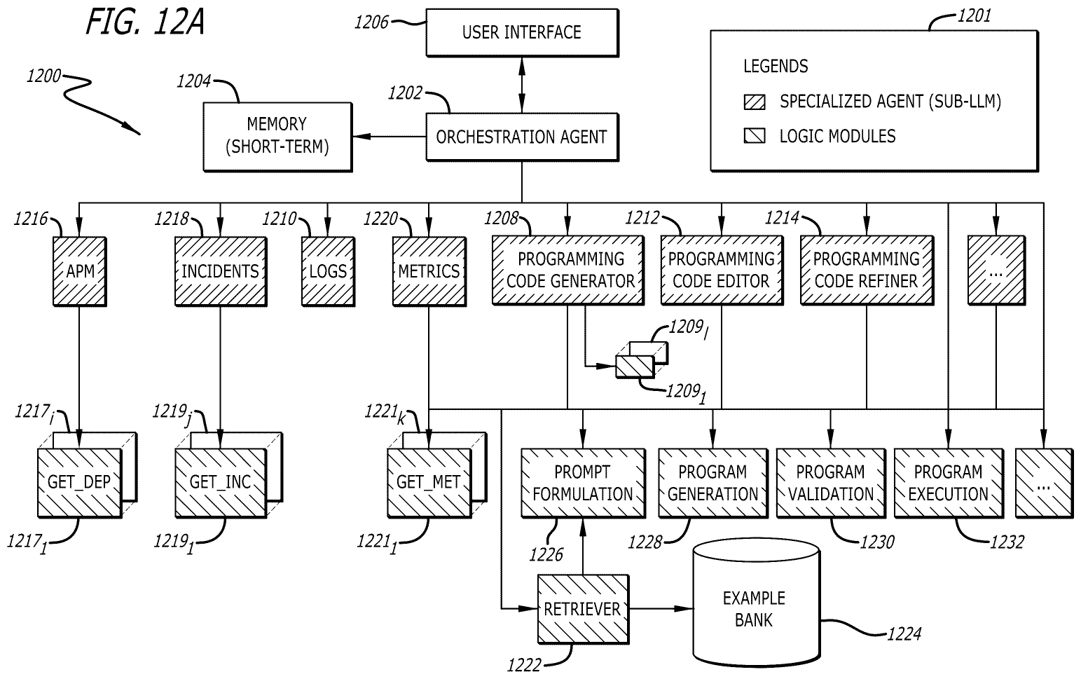

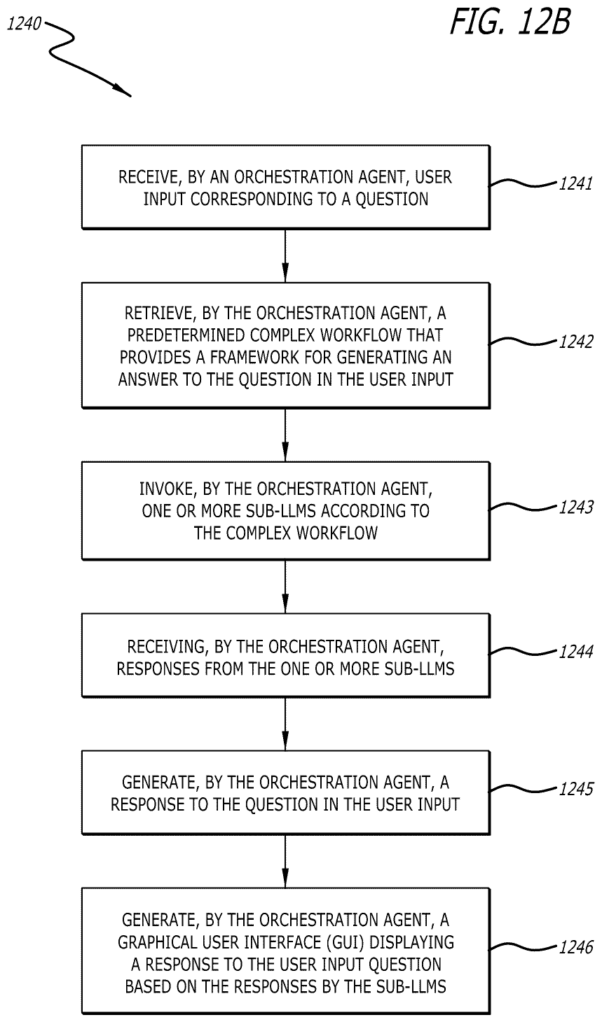

The orchestration agent 102 includes a function calling feature that is capable of selecting and invoking the sub-LLM 108 and/or one or more logic modules 110, 112, 116, 118, and 120 to perform a task indicated in the user input question and typically described in plain language. The orchestration agent 102 obtains knowledge of the sub-LLM (or multiple sub-LLMs as seen in FIG. 12A) and the available logic modules from a list of sub-LLMs and a list of logic modules, which each list providing a function description for each sub-LL or logic module. The orchestration agent 102 may then parse a user input question, determine what sub-LLM(s) and/or logic modules need to be called to obtain the answer to the user input question, and then invoke one or more sub-LLMs and/or logic modules with the necessary parameters generated by the orchestration agent 102. For a complicated task, invocation of a plurality of logic modules may be chained together to obtain a final answer. As discussed below, the orchestration agent 102 may advantageously invoke a sub-LLM to handle a task, which in turn invokes one or more logic modules. As a result, various technical benefits arise including increased efficiency, improved processing latency, and reduced resource cost. Specifically, when the orchestration agent 102 invokes a sub-LLM such as the programming code generation sub-LLM 108, the orchestration agent 102 is in effect delegating to the sub-LLM 108 as the sub-LLM 108 may invoke one or more logic modules (e.g., the logic modules 112 and 116 prior to processing a prompt and then subsequently invoke the logic module 118 following processing of a prompt resulting in automated generation of programming code).

While an LLM-based orchestration agent is discussed throughout the disclosure, the orchestration agent 102 may also be formed of or include a decision tree that influences or determines which logic modules to use. In such examples, the orchestration agent 102 may also rely on an LLM to generate text that explains the results of the logic modules called, e.g., as a natural-language response or generate one or more graphical interfaces such as charts or plots.

As used herein, the term “programming code” may refer to text provided according to a specific syntax (a programming language) that may take the form of executable instructions (which may include compiling) or other data involved in processing performed by a network device.

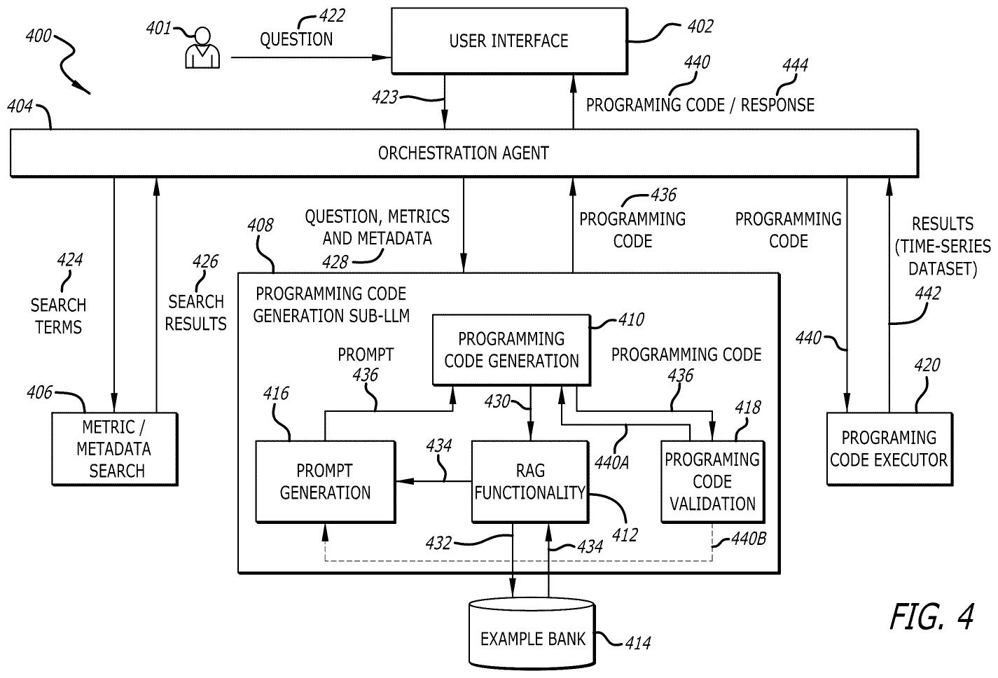

As used herein, the term “logic module” may refer to an external utility or software component that is provided to enhance the capabilities of the orchestration agent 102. For example, a logic module may be a software module that is executable by the orchestration agent 102 through an Application Programming Interface (API) call such that the execution of the logic module enables the orchestration agent 102 to perform a specific task that is outside the scope of the intrinsic functionalities of the orchestration agent 102 (e.g., of the language model forming the orchestration agent 102). In some instances, a logic module may also be another language model (also referred to as a specialized agent or “sub-LLM,” (sub-large language model (LLM)) because this sub-LLM is invoked specifically to aid the orchestration agent 102 in generating a high quality response to a user input question), which may focus on a more specialized task and may receive a different prompt instruction from the orchestration agent 102 than that received from the user directly, where the second prompt is created by the orchestration agent 102, and typically computes on a subcontext (e.g., not the full context available to the orchestration agent 102). FIG. 1 illustrates several example logic modules within the operating environment 100 including a metrics logic module 110, a retriever logic module 112 coupled to an example bank 114, a prompt formulation logic module 116, a program validation logic module 118, and a program execution logic module 120. The functionality of each logic module will be discussed in further detail, such as with the discussion of FIG. 4.

As one example illustrating the operability of the orchestration agent 102, a user input question may be received that recites; “Show me AWS instances with high CPU utilization.” To answer such a question (or statement), the orchestration agent 102 may follow a four step process. A first step may include parsing the user input question to detect search terms that may be utilized to invoke a logic module configured to identify metric names that address the user input question, then invoking the logic module with the search terms detected by the orchestration agent 102. As a second step, the orchestration agent 102 may invoke a second logic module configured to retrieve the metadata of the identified metrics (e.g., metrics logic module 110). As a third step, the orchestration agent 102 may invoke a sub-LLM with specialized programming code generation capabilities (e.g. the programming code generation sub-LLM 108), which the orchestration agent 102 would prompt by supplying (i) a task description generated from the user input question, and (ii) metadata previously retrieved via a logic module. The sub-LLM 108 may then invoke one or more logic modules to assist in generation of the programming code required to answer a prompt provided by the orchestration agent 102. As an example, the sub-LLM 108 may invoke a logic module for retrieval augmented generation (RAG) (e.g., retriever logic module 112) to obtain context of similar task description/programming code pairs (e.g., from the example bank 114), which will assist in generation of programming code to answer the prompt generated by a prompt formulation logic module 116. The sub-LLM 108 may also invoke a logic module to validate the syntax of its generated code via external API (e.g., invoke the program validation logic module 118). The sub-LLM 108 may correct any syntax errors by utilizing feedback messages provided by validation logic modules in several turns. As a fourth step, the orchestration agent 102 may call a logic module configured to execute the programming code generated by the sub-LLM 108 within the user's environment to ensure accurate, real-time results are retrieved (e.g., program execution logic module 120). Finally, the orchestration agent 102 may generate text, e.g., natural-language such as English, to present the results of the analyses to the user.

While the above provides an example as to how the orchestration agent 102 may be deployed to answer a user input question, there are several challenges with deploying an orchestration agent to complete such tasks. For instance, as the number of logic modules that are made available for use by an orchestration agent, the complexity of selecting the right logic module increases, which leads to higher error rates and more hallucinations in the outcome. This problem is exacerbated for complicated tasks, which may be defined by the requirement to chain multiple logic modules together in order to obtain a final answer. Additionally, an orchestration agent may need to carry on a long context history, which introduces more token cost, which increases the cost of each user input question analyzed by the orchestration agent 102.

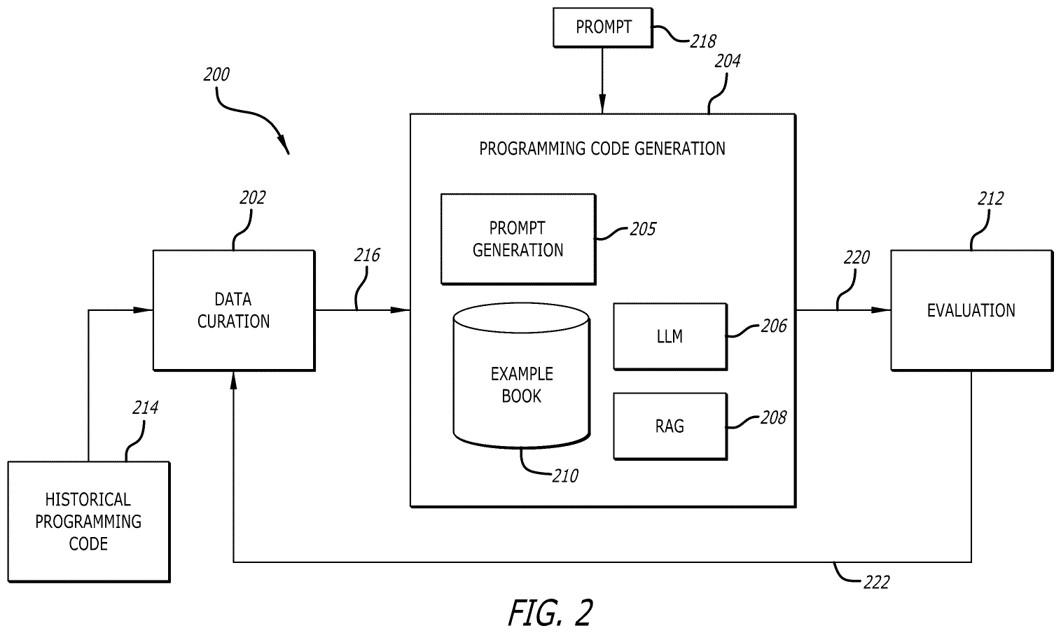

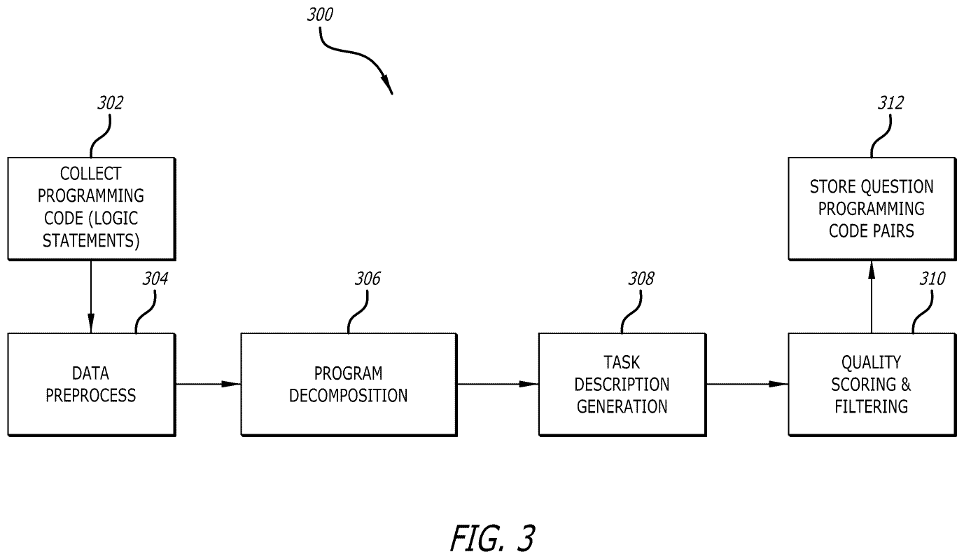

FIG. 2 is a diagrammatic flow illustrating a set of processes included in the automated generation of programming code by a language model deployed by an orchestration agent according to an implementation of the disclosure. The simplified diagrammatic flow of FIG. 2 provides an overview of the cycle for generating programming code that includes a data curation phase 202, a programming code generation phase 204, and an evaluation phase 212. The data curation phase 202 enables the curation of the example bank 210 that is utilized in a RAG process discussed below. In particular, the data curation phase 202 may include the curation of a dataset of pairs of natural-language questions and associated programming code (e.g., programming code that, upon execution, provides at least a partial response to the natural-language question) (“historical data pairs”). The operations involved in the data curation phase 202 are discussed in further detail with respect to FIG. 3 but generally include a collecting a large dataset of historical data pairs 214, performing pre-processing on the historical data pairs, decomposing the programming code into smaller, independent units, automated generation of a task description for independent units, and a scoring/filtering operation, where those independent units of programming code that pass the scoring/filtering operation are stored in the example bank 210 (stored historical data pairs 216).

The programming code generation phase 204 may include the receipt of a prompt 218, by the LLM 206, where the prompt 218 is provided by an orchestration agent such as the orchestration agent 102 of FIG. 1. The LLM 206 may represent a sub-LLM such as the programming code generation sub-LLM 108 of FIG. 1.

The programming code generation phase 204 will be described in greater detail below, such as with respect to FIG. 4. Generally, following receipt of the prompt 218, the RAG component 208 may retrieve historical data pairs from the example bank 210 that meet a threshold level of similarity with the prompt 218. A prompt generation logic module 205 may then generate a second prompt for the LLM 206 based on the prompt 218 and the data retrieved by the RAG component 208. The LLM 206 may then generate programming code 220 in response to the second prompt based at least in part on the retrieved historical data pairs. As noted above, additional detail is provided below as to the programming code generation at least with respect to FIG. 4 including detail as to metric or metadata retrieval, prompt generation, programming code validation, and optionally, programming code execution.

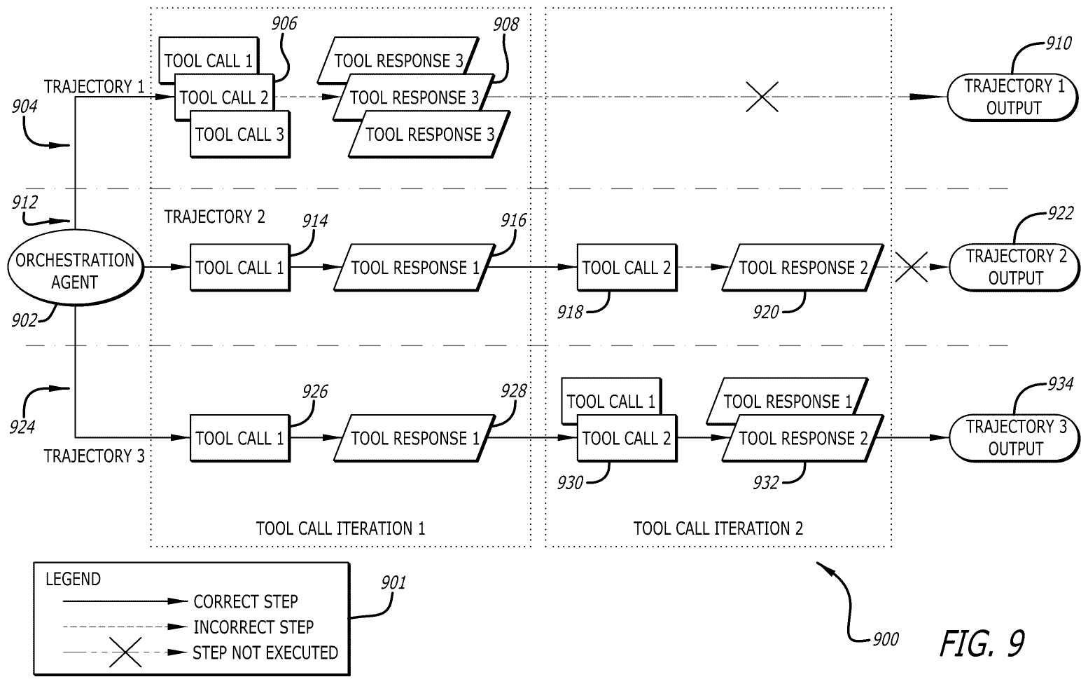

The evaluation phase 212 may be performed to provide insight on the performance of the LLM 206 and done so when a ground truth answer is known for a prompt provided to the programming code generation phase 204. The evaluation phase 212 need not require execution of the generated programming code 220. In some examples, the evaluation phase 212 may include either or both of an embedding-based similarity approach and/or a LLM-based scoring approach. The embedding-based similarity approach includes determining how close the generated programming code 220 is to a known ground truth programs. The LLM-based scoring approach may alternatively or additionally utilized to compare the generated programming code segment 220 and the known ground truth. Such an approach may include prompting an evaluator sub-LLM with a user input question, the generated program 220, and the known ground truth with instructions to score the generated program 220 based on various factors (e.g., which functions are used, relevance to the user's original input question, brevity, etc.), and to give an explanation justifying the scoring. An additional alternative method for evaluating the performance of the sub-LLM is illustrated in FIG. 9 and discussed below.

FIG. 3 is a flowchart illustrating an example process of operations for performing data curation according to an implementation of the disclosure. Each block illustrated in FIG. 3 represents an operation in the process 300 performed by, for example, a data curation logic that is executable by one or more processors. It should be understood that not every operation illustrated in FIG. 3 is required. In fact, certain operations may be optional to complete aspects of the process 300. The discussion of the operations of process 300 may be done so with reference to any of the previously described figures. It should be understood flowcharts disclosed herein that represent operations performed by logic that is executable by one or more processors may be referred to as a computerized method or a computer-implemented method. The operations may be conducted by hardware in combination with software and/or firmware.

The process 300 begins with an operation of obtaining historical data including programming code as well as various metadata, including chart titles and descriptions (block 302). The collected historical data then undergoes a data preprocessing that includes anonymizing and masking sensitive information (e.g., custom metric names, organization information) (block 304). The data preprocessing may also include validating each programming code segment (program), which determines whether the programming code segment is capable of executing without syntax errors. In some embodiments, the validating operation is performed by the program validation logic module 118 of FIG. 1. The programming code segments that do not pass the validation operation (e.g., are not capable of being executed without a syntax error) are disposed and not utilized in the data curation process.

Of those programming code segments that pass the validation operation, many of the programming code segments are quite complex, and represent multi-step logic. Thus, a decomposition step is performed on the programming code segments (block 306). The decomposition step is intended to extract useful building blocks to include in the example bank 114 of FIG. 1 for retrieval via RAG. In some examples, the program decomposition step includes deployment of a sub-LLM configured to decompose complex programming code segments into independent units, with an independent unit being defined as itself being an executable programming segment. The decomposition step includes generating a prompt for the sub-LLM (“decomposition LLM”) that includes chart descriptions, chart titles, and metrics metadata. The decomposition LLM is then provided with the prompt that requests that provided programming code segments be decompose into independent units. The decomposition step may also include the decomposition LLM being prompted to score the decomposed independent units such that those having a score below a predetermined threshold may be disposed. In some examples, the prompt may include criteria or principles pertaining to high quality independent units. The prompt may also include a request that a textual reasoning be provided for the score. The decomposition step may further comprise validating the remaining independent for syntactic correctness, e.g., by prompting the programming code validation logic module 118 of FIG. 1 to perform the validation task.

Following the decomposition of the programming code segments into smaller, independent units, the data curation process of method 300 includes an automated, two-stage approach resulting in the generation of task descriptions for the larger programming code segments, which will be assigned to the independent units forming the larger segments as metadata or the like (block 308). The two-stage approach includes (i) task instruction generation, and (ii) question generation. For task instruction generation, a sub-LLM is prompted to generate task instructions that are intended to provide details for understanding the task performed by a programming code segment. The sub-LLM (“task description generation LLM”) is provided a prompt that includes a programming code segment from which a set of independent units were derived and context that assists the task description generation LLM in generating task instructions. For question generation, the task description generation LLM is then provided a second prompt that includes the content of the first prompt and additionally the previously generated task instruction with instructions to generate natural-language questions that would be solved by executing the programming code segment. In some examples, the second prompt may instruct the task description generation LLM to generate both casual and detailed questions that would be solved by the task of the programming code segment.

As an optional step in the data curation process, a sub-LLM may be asked to score the LLM-generated questions for complexity and diversity (block 310). In some examples, the sub-LLM is provided a prompt instructing the sub-LLM to score a particular question (or both casual and detailed questions) for a particular programming code segment based on criteria set forth in the prompt that provides guidelines on diverse and complex/simple questions. Questions that are assigned low scores, e.g., below a predetermined threshold, may be filtered out and disposed. The remaining programming code segments, independent units, and questions of questions/programming code and/or questions/independent units) are then stored in a datastore, such as the example bank 114 of FIG. 1 (block 312).

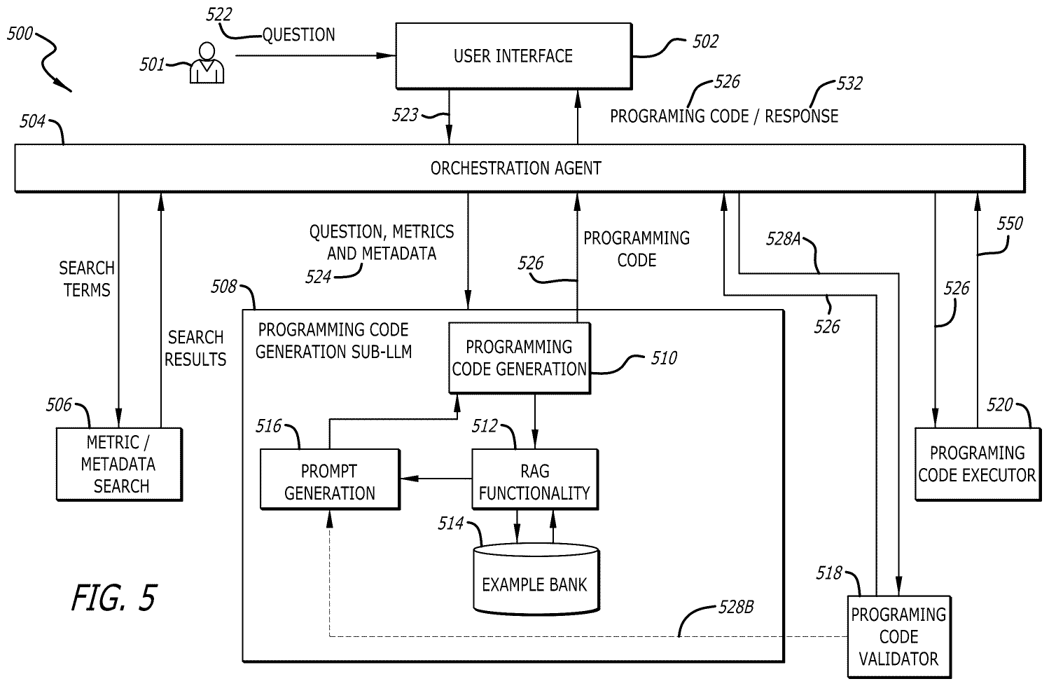

FIG. 4 is a diagrammatic flow illustrating sub-modules and functionality of a language model configured for deployment by an orchestration agent according to an implementation of the disclosure. The operating environment 400 includes a deployable orchestration agent 404, logic modules includes a metric/metadata search logic module 406 and a programming code execution logic module (programming code executor) 420 as well as programming code generation sub-LLM 408 that is configured (trained) with the capability to perform certain functionalities culminating in the automated generation of programming code. The functionalities may include programming code generation 410, retrieval-augmented generation (RAG) 412, prompt generation 414, and programming code validation 418. As shown, the RAG functionality 412 may include retrieval of data from an example bank 414. In other instances, as will be discussed below with respect to FIGS. 5 and 12-18, certain functionalities of the sub-LLM 408 may be modularized into individual logic modules that are invoked by a sub-LLM via an API call.

The example illustrated in FIG. 4 includes a user 401 providing a user input question 422 to the orchestration agent 404 via a user interface 402. The user interface 402 may include or receive chat history 423 between the user and the orchestration agent 404 (where the user input question 422 and the chat history are illustrated collectively as input 423 to the orchestration agent 404). The orchestration agent 404 may evaluate the user input 423 by determining a plan for answering the user input question 422, which may pertain to a user's desire to obtain some insight into their networking environment, where determining such insight requires the generation of programming code and execution thereof (e.g., in a programming language configured for refine real-time data processing and analytics for monitoring and alerting such as SignalFlow). An illustrative example of such a user input question may include, “What is the CPU usage for all Kubernetes nodes?”

In such an example, the orchestration agent 404 may obtain metrics/metadata 426 that pertain to the user's networking environment (e.g., to determine which Kubernetes nodes are present in the environment), which are needed to automatically generate programming code that will, upon execution, perform data retrieval, data processing, data analysis, and provide a status as to the data, which may be in the form an alert or graphical display of a time-series dataset. Thus, as a step in an evaluation plan derived by the orchestration agent 404, the metric/metadata search logic module 406 may be invoked through the provision of search terms 424 with a set of search results 426 being returned.

The orchestration agent 404 then crafts a prompt 428 for the programming code generation sub-LLM 408 that includes at least an aspect of the user input question 422 as well as the metrics/metadata search results that were retrieved. The prompt 428 may also include a task description of programming code that is to be generated by the sub-LLM 408 in order for the orchestration agent 404 to provide a response to the user input question 422. The sub-LLM 408 may perform a RAG functionality 412, e.g., retrieval-augmented generation, based on the task description 432 provided by the orchestration agent 404, which is configured to return RAG results 434 from an example bank 414. The RAG results 434 may be example programming code statements that are associated with a task description having at least a threshold level of similarity to the task description 432. The sub-LLM 408 then performs a prompt generation functionality, e.g., augmenting the prompt 428 with the RAG results 434, resulting in generation of a prompt 436.

The prompt 436 is then executed by the sub-LLM 408 and the programming code generation functionality 410 results in the generation of programming code 436. Using the example above, the automatically generated programming code 436 may include the following SignalFlow statements (note that no specific metrics/metadata are included in this illustrative example but would otherwise be following retrieval of such as illustrated in FIG. 4):

$$\begin{matrix}cpu\_usage = data ( ‘ kub ernetes . node . cpu . utilization ’ ) \\ output ( cpu\_usage , label = “ CPU Usage per Node ” )\end{matrix}$$

Continuing the example illustrated in FIG. 4, following generation of the programming code 436, the sub-LLM 408 performs programming code validation 418 of the programming code 436. The programming code validation 418 includes determining whether the programming code 436 is capable of being executed without causing a syntax error. In such an example, the prompt 428 may include specific instructions to the sub-LLM 408 to perform a validation operation.

The validation result 440A generated as a result of the programming code validation 418 may indicate that programming code 436 is valid (no known syntax errors have been identified) and may be provided to the orchestration agent 404. When the validation fails, one or more syntax errors may be identified in the validation results 440B. Optionally, the validation results 440B may provide suggestions on how to correct the syntax errors. The programming code 436 may be corrected and validation 418 may be performed again, where multiple cycles of revisions may occur until the validation result 440A indicates no syntax errors. The programming code 436 is then provided to the orchestration agent 404 in response to the prompt 428. The orchestration agent 404 may reason over the user input question 422 and determine whether the programming code 436 is to be returned in the user interface 402 or is to be executed by the programming code execution logic module 420, with the execution result 442 (e.g., a time-series dataset) returned to the orchestration agent 404 for subsequent return to the user 401 via the user interface 402 as part of the response 444.

FIG. 5 is a diagrammatic flow illustrating detail of an alternative configuration of sub-modules and functionality of a language model configured for deployment by an orchestration agent according to an implementation of the disclosure.

The operating environment 500 is similar to the operating environment 400 in FIG. 4 in that is includes a deployable orchestration agent 504, logic modules includes a metric/metadata search logic module 506, a programming code execution logic module (programming code executor) 520, and a programming code generation sub-LLM 508 that is configured (trained) with the capability to perform certain functionalities culminating in the automated generation of programming code. The distinction between the operating environments 400, 500 is that the programming code validation functionality 418 of FIG. 4 has been modularized to form the programming code validation logic module 518, e.g., moving the specific functionality outside of the internal workflow of the sub-LLM 508. As a result, the orchestration agent 504 may provide a more tailored prompt 524 to the programming code generation sub-LLM 508 and separately invoke the programming code validation logic module 518 following processing by the sub-LLM 508.

Aside from the modularization of the programming code validation functionality into a distinct logic module, the processing flow operates similarly between the operating environments 400, 500. As a brief overview of the processing flow of the operating environment 500, a user 501 provides a user input question 522 to an orchestration agent 504 via the user interface 502. The orchestration agent 504 may receive the user input question 522 and a chat history (collectively shown as input 523). The orchestration agent 504 may obtain metrics/metadata that pertain to the user's networking environment, which are needed to automatically generate programming code that will, upon execution, perform data retrieval, data processing, data analysis, and provide a status as to the data, which may be in the form an alert or graphical display of a time-series dataset. Thus, as a step in an evaluation plan derived by the orchestration agent 504, the metric/metadata search logic module 506 may be invoked through the provision of search terms with a set of search results being returned.

The orchestration agent 504 then crafts a prompt 524 for the programming code generation sub-LLM 508 that includes at least an aspect of the user input question 522 as well as the metrics/metadata search results that were retrieved. The prompt 524 may also include a task description of programming code that is to be generated by the sub-LLM 508 in order for the orchestration agent 504 to provide a response to the user input question 522. The sub-LLM 508 may deploy RAG functionality 512 using the task description of the programming code provided by the orchestration agent 504. The RAG functionality 512 of the sub-LLM 508 retrieves RAG results from an example bank. The sub-LLM 508 the performs prompt generation 516, which may include augmenting the prompt 524 provided by the orchestration agent with the RAG results.

The prompt is then executed by the sub-LLM 408, which includes programming code generation 510, resulting in the generation of programming code 526. The sub-LLM 508 returns the programming code 526 to the orchestration agent 504, which invokes the programming code validation logic module 518 by providing the programming code 526. The programming code validation logic module 518 determines whether the programming code 526 is capable of being executed without causing a syntax error and returns a validation result 528A to the orchestration agent 504 when the programming code 526 passes validation and returns a validation result 528B to the sub-LLM 508 such that a new prompt may be generated including feedback from the programming code validation logic module 518 such as identification of any syntax issue and, optionally, recommendations on fixing any such issues.

Upon being validated by the programming code validation logic module 518, the orchestration agent 504 may reason over the user input question 522 and determine whether the programming code 526 is to be returned in the user interface 502 or is to be executed by the programming code execution logic module 520, with the execution result 530 (e.g., a time-series dataset) returned to the orchestration agent 504 for subsequent return to the user 501 via the user interface 502 as part of the response 532.

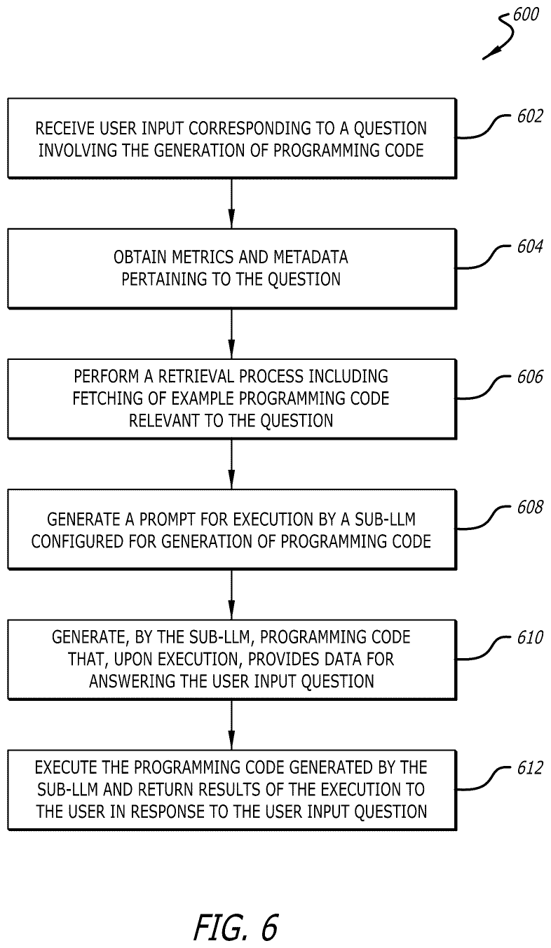

FIG. 6 is a flowchart illustrating an example process of operations for performing generation of programming code in order to answer a natural-language question provided to an orchestration agent by a user according to an implementation of the disclosure. Each block illustrated in FIG. 6 represents an operation in the process 600 performed by, for example, the system illustrated in FIG. 1, that is executable by one or more processors. It should be understood that not every operation illustrated in FIG. 6 is required. In fact, certain operations may be optional to complete aspects of the process 600. The discussion of the operations of process 600 may be done so with reference to any of the previously described figures.

The process 600 begins with an operation of receiving, by an orchestration agent, user input corresponding to a question (“user input question”) involving the generation of programming code (block 602). In some instances, the user input question may explicitly request generation of programming code. However, in other instances, the user input question may require the generation and execution of programming code, e.g., against data of a datastore within a user's environment, where the orchestration agent parses the user input question to determine a plan for generating a final answer that includes a step of programming code generation. The following provides an example of a user input question that would require generation (and execution) of programming code to answer: “What is the average CPU utilization . . . ?” As discussed herein, the orchestration agent may invoke a sub-LLM to generate programming code that would provide metrics for answering the user input question as follows: data (“cpu.utilization”).mean( ).publish( )—and including any environment specific parameters.

Once the orchestration agent has determined a plan for generating an answer to the user input question, the orchestration agent may invoke a logic module to obtain metrics and metadata pertaining to the user input question (block 604). Following the retrieval metrics and metadata that pertain to the user input question, the programming code generation workflow receives a prompt from the orchestration agent 102, and in particular, the retriever component 112 performs a RAG process that may include performance of a semantic similarity search against an example bank using the prompt provided by the orchestration agent 102 (block 606). The most relevant examples retrieved via the RAG process are provided to the prompt generation component 116, which generates a prompt for execution by a sub-LLM, such as the programming code generation sub-LLM 108 of FIG. 1. The use of the RAG retrieval approach enhances the responses (code generation) by the sub-LLM 108 by providing contextually relevant information.

In response to the prompt generated by the prompt generation component, the sub-LLM 108 generates programming code that, upon execution by one or more processors, is configured to provide data for answering the user input question (block 610). As discussed above, one example programming code generated by the sub-LLM 108 may be programming code such as a set of one or more statements written according to the syntax requirements of a particular programming code language, e.g., the SignalFlow programming language. The programming code generated by the sub-LLM 108 may then be executed, e.g., by the programming code execution component 120 of FIG. 1, and the results returned to the user in response to the user input questions (block 612). In some examples, the orchestration agent 102 receives the results from the programming code execution component 120 and may generate a text description of the results, display the results in a graphical visual, etc.

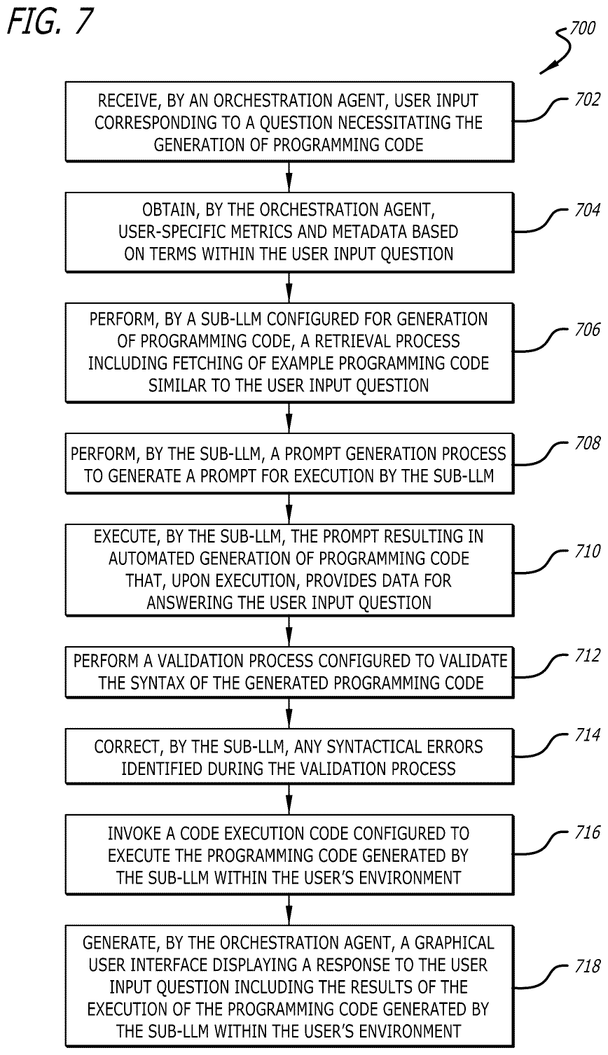

FIG. 7 is a flowchart illustrating an example process of detailed operations for performing generation of programming code in order to answer a natural-language question provided to an orchestration agent by a user according to an implementation of the disclosure. Each block illustrated in FIG. 7 represents an operation in the process 700 performed by, for example, the systems disclosed herein. It should be understood that not every operation illustrated in FIG. 7 is required. In fact, certain operations may be optional to complete aspects of the process 700.

The process 700 begins with an operation of receiving, by an orchestration agent formed of or including a large language model (LLM), a natural language question from a user requesting or involving the generation of programming code in the syntax of a particular programming code language, e.g., SignalFlow (block 702). The orchestration agent is configured to parse the natural language question enabling the orchestration agent to determine whether metrics or metadata may be required for or assist in the generation of SignalFlow, the execution of which at least in part answers the natural language question. Following the parsing of the natural language question, the orchestration agent obtains metrics and/or metadata specific to the user or the user's environment based on terms within the natural language question (block 704). In some examples, the orchestration agent may obtain the metrics and/or metadata by invoking a logic module, such as the metrics component logic module 110 of FIG. 1, that is configured to query one or more datastores based on parameters provided by the orchestration agent.

A prompt is then generated by the orchestration agent that includes the metrics and/or metadata, where the prompt instructs a specialized agent, e.g., a sub-LLM, configured for a particular task or tasks, one of which may be generation of SignalFlow programming code. As the specialized agent is a sub-LLM, such as the programming code generation sub-LLM 108 of FIG. 1 or the programming code generation sub-LLM 408 of FIG. 4, the specialized agent may also invoke one or more logic modules in order to respond to the prompt provided by the orchestration agent. Thus, the programming code generation sub-LLM may perform a retrieval-augmented generation (RAG) process either through inherent functionality or through invoking a retrieval component (logic module) such as the retrieval component 112 of FIG. 1 that performs the retrieval augment generation (RAG) process (block 706). The RAG process may include fetching of examples of stored SignalFlow programming code relevant to the natural language question by performing a semantic similarity search between the prompt provided by the orchestration agent and curated question/SignalFlow programming code pairs. A data curation process for curating question/programming code pairs is discussed above, for example with respect to FIG. 3. Following retrieval of semantically similar question/SignalFlow programming code pairs, the sub-LLM may perform a prompt generation process resulting in generation of a new prompt for the sub-LLM that includes at least appending the retrieved question/SignalFlow programming code pairs to the prompt provided by the orchestration agent (block 708). The prompt generation process may be performed either through inherent functionality or through invoking a prompt generation logic module such as the prompt formulation logic module 116 of FIG. 1.

The sub-LLM may then process the prompt resulting in the automated generation of SignalFlow programming code (block 710). The sub-LLM may then perform a validation process through an inherent functionality or by invoking a validation logic module, such as the program validation logic module 118 of FIG. 1, to validate the syntax of the generated SignalFlow programming code (block 712). In validating the syntax, the validation process may determine whether the generating SignalFlow programming code is executable without generating a syntax error. In the event that the validation process indicates that the generated SignalFlow programming code includes one or more syntactical errors, the sub-LLM corrects the syntax of the generated SignalFlow programming based on the results of the validation process (block 714). In some examples, the revised SignalFlow programming code may pass through the validation process again following correction of the syntactical errors.

Once the generated SignalFlow programming code has passed the validation process (e.g., no syntactical errors or the errors have been corrected), the sub-LLM returns the generated SignalFlow programming code to the orchestration agent, which may invoke an execution logic module, such as the programming code execution logic module 120 of FIG. 1 or the programming code execution logic module 420 of FIG. 4, to execute the generated SignalFlow programming code within the user's environment (block 716). In some examples, the orchestration agent may provide user credentials to access aspects of the user's environment, such as particular datastores. Finally, following execution of the generated SignalFlow programming code, the orchestration LLM may generate a graphical user interface (GUI) that displays a response to the natural language question including or based on the results of the execution of the SignalFlow programming code generated by the sub-LLM (block 718).

As discussed below, in some examples, prior to invoking the programming code execution logic module, the orchestration agent may first generate a GUI displaying the SignalFlow programming code to the user and requiring initiation of the execution of the SignalFlow programming code by subsequent user input. In some examples, the orchestration agent may also display estimated resource usage metrics to the user, such as an estimated time to execute, an estimated cost for execution, etc.

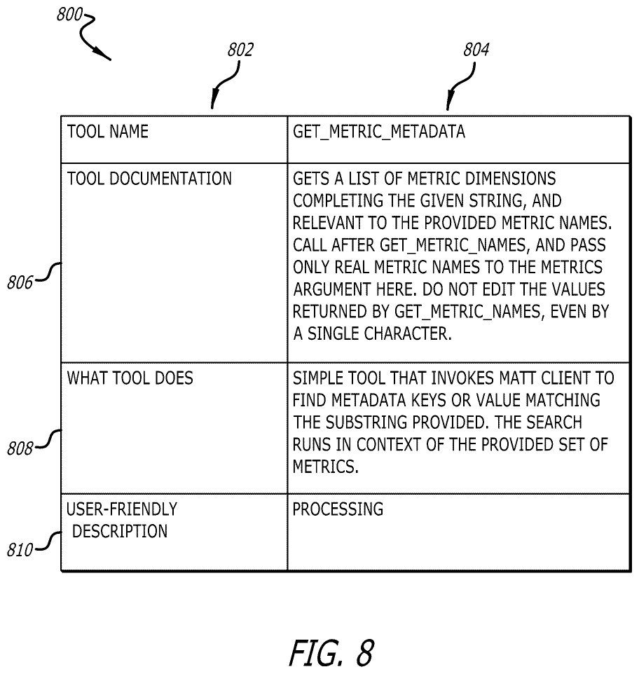

FIG. 8 is an example logic module description provided by to the orchestration agent to a language model configured for automated programming code generation according to an implementation of the disclosure. As is understood by those having ordinary skill in the art, a language model may invoke a logic module that is configured to perform specific functionality that may augments the functionality of the language model. For instance, a logic module may be configured with specialized expertise to perform a function with higher accuracy or with knowledge of a specific data set not available to the language model or otherwise on which the language model was not trained. Alternatively, the logic module may be configured to perform tasks that the language model is not natively trained to do (e.g., generate pictorial representations from text). A logic module may take the form of an individual function (e.g., logic, programming code, etc.), an API, or a larger system that may be comprised of multiple functions. Examples of logic modules may include web searching logic modules, image generation logic modules, data analysis or manipulation logic modules, etc.

In order for a language model, such as the orchestration agent 102 or the programming code generation sub-LLM 108 both of FIG. 1, the language model is typically provided with a logic module description for each logic module such as the logic module description 800 as shown in FIG. 8. A logic module description provides the data necessary for the language model to understand what functionality the logic module provides and what parameters are needed to invoke the logic module. As an example, the logic module description 800 takes the form of a table having a two columns 802, 804 and four rows 806, 808, 810, 812; however, it should be understood that logic module descriptions may take different forms such as varying sized tables, full text descriptions, etc. The text provided in the logic module description 800 is merely illustrative and not intended to be limiting in any manner.

FIG. 9 is a flowchart illustrating an example process of operations for evaluating the performance of an orchestration agent according to an implementation of the disclosure. The flow diagram 900 of FIG. 9 illustrates a trajectory based approach for data collection and metric definition enabling an evaluation of the performance of an orchestration agent as disclosed herein. Implementation of the evaluation procedure illustrated in FIG. 9 includes a ground truth data collection phase and an evaluation phase.

In the ground truth data collection phase, for a given query, ground truth data is collected for both the logic module use trajectories and final responses. To note, there may be multiple trajectories that arrive at the same correct answer. This phase includes providing the same prompt to the orchestration agent multiple times, e.g., running multiple trials, and collecting all trajectories and responses. The correct answers and corresponding trajectories may be selected based on experiential or expert knowledge. Once the ground truth data has been collected through the multiple trials, the evaluation phase evaluates the performance of the orchestration agent during the multiple trials according to two metrics: a trajectory match, and an embedding-based similarity for final responses. FIG. 9 illustrates how the trajectory of a response within the multiple trials is matched. When the order of logic module use is fully matched with the ground truth, it is regarded as a correct run.

The flow diagram 900 provides an abstracted example of the trajectory matching process. An orchestration agent 902 may be provided with a prompt multiple times, e.g., to run multiple trials. While three instances are shown in FIG. 9, it should be understood that this number may be much greater, e.g., 50, 100, 1000, etc. The first trajectory 904, e.g., the first trial, illustrates that the orchestration agent 902 performed a first step 906 of invoking three logic modules, e.g., in parallel, and received a first set of responses from the logic modules (responses 908), which lead to a first trajectory output 910. As illustrated, receiving the responses 908 was an incorrect step.

The second trajectory 912, e.g., the second trial, illustrates that the orchestration agent 902 performed a first step 914 of invoking a first logic module, which provided a first response 916 and subsequently performed a second step 918 of invoking a second logic module, which provided a second response 920. The response 920 from the second logic module lead to a second trajectory output 922. The illustration of the second trajectory 912 may be understood to show that the first and second logic modules may be invoked serially. As illustrated, receiving the response 920 provided by the second logic module was an incorrect response.

The third trajectory 924, e.g., the third trial, illustrates that the orchestration agent 902 performed a first step 926 of invoking a first logic module, which provided a first response 928 and subsequently performed a second step 930 of invoking the first and second logic modules, which provided a second set of responses 932. The second set of responses 932 lead to a third trajectory output 934. As illustrated, receiving the second set of responses 932 resulted in a correct response.

To measure the final response, the embeddings of a particular response and the selected ground truth response are determined. Then, the cosine similarity is taken between the embeddings of the particular response and the ground truth response. The same evaluation procedure may be repeated for each trajectory and corresponding response such that the performance of the orchestration agent may be determined based on (i) a percentage of trial runs where the trajectory matched the ground truth trajectory (or one of a plurality of ground truth trajectories) and (ii) the percentage of responses where the cosine similarity with the ground truth response satisfied a threshold comparison (e.g., met or exceeded a threshold similarity value).

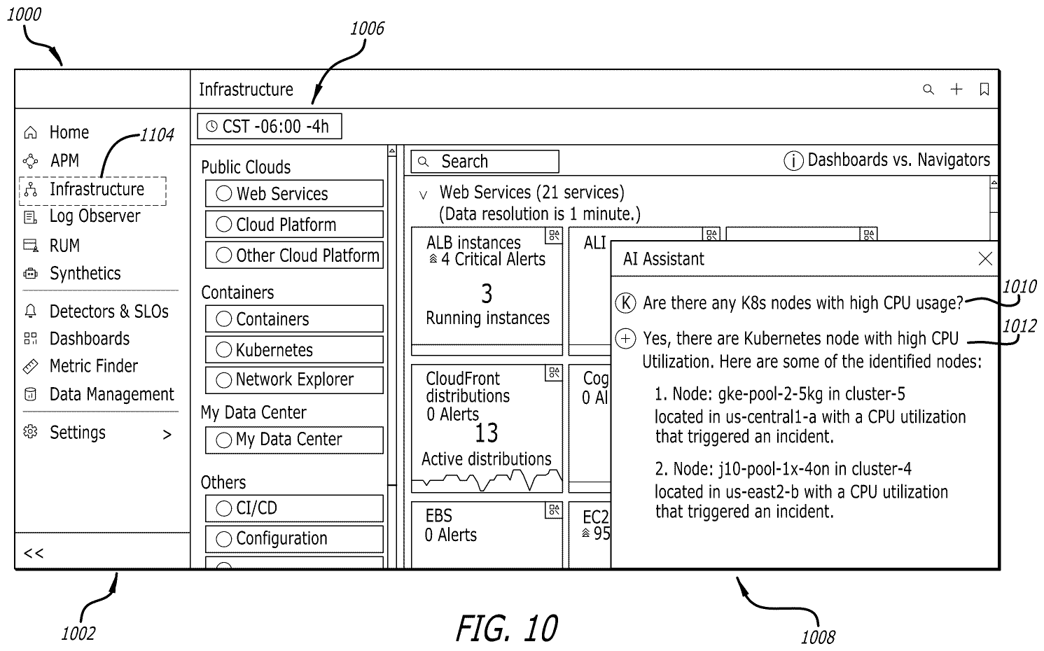

FIG. 10 is a first example graphical user interface configured to deploy an orchestration agent according to an implementation of the disclosure. The display 1000 of FIG. 10 may be displayed on a display screen of a network device that is configured with one or more processors and non-transitory, computer-readable medium on which instructions (logic) may be stored. The instructions may comprise the artificial intelligence (AI) assistant logic that is configured to receive user input via a user interface (e.g., the chat interface 1008, which may correspond to the user interface 106 of FIG. 1). The display 1000 may comprise a web page that is rendered in a web browser application processing on the network device. In other examples, the display 1000 may be part of a dedicated software application (“app”) that is downloaded and executing on the network device.

The display 1000 is shown to include a side panel 1002 that enables selection of various features that may pertain to a comprehensive, integrated solution designed to provide real-time, full-stack visibility across an information technology (IT) environment (“observability product”). FIG. 10 illustrates that the “Infrastructure” module 1004 of the observability product has been selected and is shown in the body component 1006 of the display 1000. The Infrastructure module 1004 provides insights and analytics into the operability and functioning of infrastructure components of an IT environment including public clouds, containers, a data center, etc. For example, the Infrastructure module 1004 may provide insights to the number of instances of application load balancers (ALBs) running, the number of alerts for the running ALB instances, a number of active CloudFront distributions, etc.

Additionally, an AI assistant interface (e.g., the chat interface) 1008 may also be displayed that is configured to enable user interaction with an orchestration agent, such as the orchestration agent 102 of FIG. 1. As discussed throughout the disclosure, the chat interface 1008 receives user input such as a user input question 1010 that is to be evaluated by a language model and displays a response 1012 to the user input question.

Specifically, the user input question 1010 may be transmitted to an orchestration agent, such as the orchestration agent 102 of FIG. 1 or the orchestration agent 404 of FIG. 4. The orchestration agent may be configured, as discussed throughout the disclosure, to analyze and parse the user input question 1010, determined a plan for answering the user input question 1010, and invoking one or more sub-LLMs and/or logic modules, such as the metric/metadata search module 406 (logic module), the programming code generation sub-LLM 410 (sub-LLM), and/or the programming code executor 420 (logic module).

In the example illustrated in FIG. 10, the user input question 1010 asks, “Are there any k8s nodes with high CPU usage?” In order to answer such a question, it may be necessary for the orchestration agent receiving the user input question 1010 to invoke a programming code generation sub-LLM and subsequently a programming code execution logic module in order to retrieve data pertaining to CPU usage of running Kubernetes (k8s) nodes within the user's IT environment and subsequently perform a threshold comparison between the retrieved CPU and one or more predetermined thresholds. Such a set of operations enables the orchestration agent to identify k8s nodes with high CPU usage and return a list of such identified k8s nodes in the chat interface 1008.

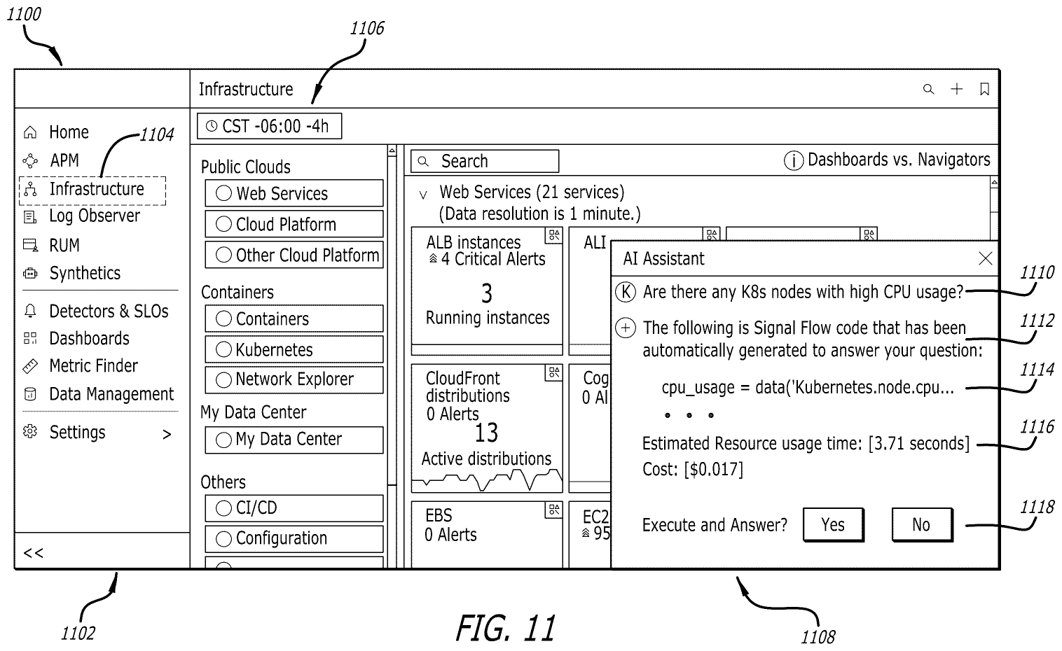

FIG. 11 is a second example graphical user interface configured to deploy an orchestration agent according to an implementation of the disclosure. The display 1100 of FIG. 11 may, like the display 1000 of FIG. 10, be displayed on a display screen of a network device. The same discussion pertaining to the network device and various display configurations in FIG. 10 equally applies to the display 1100 of FIG. 11.

The display 1100 is shown to include a side panel 1102 that enables selection of various features that may pertain to a comprehensive, integrated solution designed to provide real-time, full-stack visibility across an information technology (IT) environment (“observability product”). FIG. 11 illustrates that the “Infrastructure” module 1104 of the observability product has been selected and is shown in the body component 1106 of the display 1100, where the Infrastructure module 1104 may be the same as the Infrastructure module 1104. Additionally, an AI assistant interface (e.g., the chat interface) 1108 may also be displayed that is configured to enable user interaction with an orchestration agent in the same manner as the AI assistant interface 1008.

FIG. 11 illustrates an alternative implementation of the interaction between the user and an orchestration agent, which may be the orchestration agent 102 of FIG. 1 or the orchestration agent 404 of FIG. 4. In the example illustrated in FIG. 11, the user input question 1110 is shown to be the same as that asked in FIG. 10, “Are there any k8s nodes with high CPU usage?” As in the implementation in FIG. 10, in order to answer such a question, it may be necessary for the orchestration agent receiving the user input question 1110 to invoke a programming code generation sub-LLM and subsequently a programming code execution logic module in order to retrieve data pertaining to CPU usage of running Kubernetes (k8s) nodes within the user's IT environment and subsequently perform a threshold comparison between the retrieved CPU and one or more predetermined thresholds. However, the implementation of FIG. 11 differs from the implementation of FIG. 10 in that the response 1112 provides the programming code generated through deployment of the orchestration agent (programming code 1114), e.g., through an invocation of logic modules and/or sub-LLMs are discussed throughout the disclosure, in the AI assistant interface 1108. The orchestration agent may optionally provide estimated resource usages metrics 1116 such as an estimated processing time and an estimated cost (for use of LLM, when applicable). The AI assistant interface 1108 may ask the user to confirm the orchestration agent should proceed with execution, such as through the prompt 1118. The AI assistant interface 1108 may provide specific user interface (UI) components configured to receive user input (Yes/No) or may be configured to receive user input through text.

In implementations like that shown in FIG. 11, providing an estimated resource usage provide technical advantages to the user, which may be include allowing the user to select to have the programming code 1114 executed when the estimated resource usage is not above a time or cost threshold. Additionally, the user may copy and the programming code 1114 into an alternative interface and execute the programming code via that methodology. In some instances, the execution of automatically generated code, without user consent, could exceed resource usage thresholds. Thus, by providing the user with the programming 1114, and optionally, estimated resource usage metrics, technical advantages are realized, especially when extreme resource usage is avoided through requiring user consent or instructions to execute.

FIG. 12A is a diagrammatic flow illustrating a communicative coupling between an orchestration agent, a plurality of language models (LMs), and a plurality of logic modules according to an implementation of the disclosure. The operating environment 1200 includes a deployable orchestration agent 1202 that is coupled to a short-term memory 1204, a plurality of specialized agents (which may each represent a large language model (LLM)), such as the programming code generator 1208 (programming code generation sub-LLM 1208), a logs sub-LLM 1210, a programming code editor 1212 (programming code editor sub-LLM 1212), a programing code refiner 1214 (programming code refining sub-LLM 1214), etc. Additionally, the orchestration agent 1202 and the plurality of specialized agents may be coupled to a plurality of logic modules 1216, 1218, 1220, 1222, 1226, 1228, 123, 1232, etc. A retrieval logic module 1222 may be coupled to an example bank 1224. A user may interact with the orchestration agent 1202 via a user interface 1206. A legend 1201 provides shading details distinguishing a sub-LLM (specialized agent) from a logic module.

In some examples, the orchestration agent 1202 may be similar to the orchestration agent 102 in FIG. 1, e.g., be a large language model that is configured to parse a user input question received via the user interface 1206, determine a plan for answering the user input question, calling one or more specialized agents 1208, 1210, 1212, 1214, etc., and/or one or more logic modules 1216, 1218, 1220, 1222, 1226, 1228, 123, 1232, etc., and reason with results provided by such the specialized agents and/or logic modules.

As with the orchestration agent 102, the orchestration agent 1202 may be formed of or include a language model, either a closed-source or an open-source LLM. The orchestration agent 1202 includes a function calling feature that is capable of selecting and invoking one or sub-LLMs 1208, 1210, 1212, 1214, etc., and/or one or more logic modules 1216, 1218, 1220, 1222, 1226, 1228, 123, 1232, etc., to perform a task indicated in the user input question and typically described in plain language. The orchestration agent 1202 obtains knowledge of the sub-LLMs and logic modules in the same manner as orchestration agent 102. The orchestration agent 1202 may then parse a user input question, determine what sub-LLM(s) and/or logic modules need to be called to obtain the answer to the user input question, and then invoke one or more sub-LLMs and/or logic modules with the necessary parameters generated by the orchestration agent 1202. For a complicated task, invocation of a plurality of sub-LLMs and logic modules may be chained together to obtain a final answer. As discussed below, the orchestration agent 1202 may advantageously invoke a sub-LLM to handle a task, which in turn invokes one or more logic modules. As a result, various technical benefits arise including increased efficiency, improved processing latency, and reduced resource cost. Specifically, when the orchestration agent 1202 invokes a sub-LLM such as the programming code editor sub-LLM 1212, the orchestration agent 1202 is in effect delegating to the sub-LLM 1212 execute a prompt to edit provided programming code according to a natural language description provided in the user input question and subsequently invoke the programming code validation logic module 1230.

Advantageously, for a subsequent user input question that asks the orchestration agent 1202 to generate programming code based on a natural language task description, the orchestration agent 1202 may follow the same evaluation procedure including invoking a sub-LLM such as the programming code generation sub-LLM 1208, which may invoke one or more logic modules, execute a prompt to generate programming code according to a natural language description provided in the user input question and subsequently invoke the programming code validation logic module 1230. Thus, the modularization of the orchestration agent 1202, the sub-LLMs 1208, 1210, 1212, 1214, etc., and the logic modules 1216, 1218, 1220, 1222, 1226, 1228, 123, 1232, etc., enables reuse of the same logic module, the programming code validation logic module 1230, by multiple sub-LLMs, so long as each sub-LLM provides the required parameters. In this example, such parameters may include programming code written in a particular syntax (programming language).

As should be understood, the configuration of the operating environment 1200 provides numerous novel aspects and technical advantages over current configurations of LLM deployments. A first novel aspect includes the utilization of a plurality of sub-LLMs by an orchestration agent to accomplish varying tasks, where each sub-LLM provides particular expertise (e.g., programming code generation, programming code editing, programming code refinement, etc.). A second novel aspect includes the modularization of functionality into logic modules that may be invoked by a plurality of sub-LLMs as well as the orchestration agent. Additional novel aspects include the operability of each of the programming code generation sub-LLM 1208, the logs sub-LLM 1210, the programming code editor sub-LLM 1212, and the programming code refining sub-LLM 1214.

Additionally, a first technical advantage of the modularization shown in FIG. 12A is the improvement in latency processing, resource usage, and accuracy, which results from the orchestration agent 1202 providing prompts to the sub-LLMs that do not include code or instructions to instruct and guide the sub-LLM in performing tasks that are accomplished by the logic modules. For example, in integrated examples in which a programming code generation sub-LLM is tasked with performing a RAG process, generating the programming code, and validating the programming code, the prompt provided by the orchestration agent is very long (creating many tokens) and may be cause confusion for the programming code generation sub-LLM (e.g., the RAG instructions may be incorporated into the programming code generation functionality causing inaccuracies in the programming code). In contrast, the modularized deployment shown in FIG. 12A enables the orchestration agent to provide a targeted prompt to each sub-LLM, where the sub-LLM then invokes one or more modularized logic modules on its own to complete certain tasks (such as programming validation).

A second technical advantage provided by the modularized deployment of FIG. 12A is the reusability of the logic modules by sub-LLMs or orchestration agent. As noted above in an illustrative example, multiple sub-LLMs may invoke the same logic module during evaluation of two separate user input questions merely by providing the necessary parameters. This deployment configuration reduces the amount of code, training, and prompt length required for sub-LLMs that are requested to perform a wide range of functionalities (e.g., RAG, programming code generation, and programming code validation). A third technical advantage provided by the modularized deployment of FIG. 12A is that each logic module may be individually amended and/or updated. This allows for targeted revisions to logic modules (e.g., support for validation of additional programming languages need only to be performed once in the modularized deployment) compared to the need to update several sub-LLMs.

FIG. 12B is a flowchart illustrating an example process of operations performed by an orchestration agent of FIG. 12A in executing according to an implementation of the disclosure. Each block illustrated in FIG. 12B represents an operation in the process 2400 performed by, for example, the system of FIG. 12A. It should be understood that not every operation illustrated in FIG. 12B is required. In fact, certain operations may be optional to complete aspects of the process 2400. The discussion of the operations of process 2400 may be done so with reference to any of the previously described figures.

The process 2400 begins with an operation of receiving, by an orchestration agent 1202 formed of or including a large language model (LLM), user input corresponding to a question (block 1241). An illustrative example of such a user input question may include, “What is the AWS EC2 CPU utilization percentage for instance i-e8b1df4b using mean?”

In response to receipt of the question, the orchestration agent 1202 may retrieve a predetermined complex workflow that provides a framework for generating answer to the question (block 1242). In some examples, the orchestration agent 1202 may parse the question and determine an intent of the question through the use of natural language processing (NLP), classification models, semantic similarity matching, and/or rule-based parsing to determine the user's intent in asking the question. Based on the intent, the orchestration agent 1202 may retrieve a corresponding workflow. In accordance with the retrieved complex workflow, the orchestration invokes one or more sub-LLMs (block 1243). In many instances, the complex workflow may indicate that results of one sub-LLM are to be provided to another sub-LLM, where the results are provided to the orchestration agent 1202, which invokes another sub-LLM or one sub-LLM provides results directly to a second sub-LLM. The latter may be done in accordance with instructions provided by the orchestration agent 1202 to the initial sub-LLM.

As an example complex workflow that may be utilized in generating an answer to the questions, the orchestration agent 1202 may invoke a first subLLM such as the metrics sub-LLM 1220, which in turn calls one or more tools such as any of the tools 1221₁-1221ₖ (collectively or individually, 1221), which may be a search_charts tool, a search_detectors tool, and a get_metric_integration_filters tool, where each of these tools 1221 may be called in parallel (or called serially). The metrics sub-LLM 1220 may then call additional tools passing the results from the previously called tools to the additional tools such as a get_metric_names tool, followed by a get_metric_metadata tool. The metrics subLLM 1220 then analyzes the results of the tools it invoked to determine a value of metric= “aws.cc2.cpu.utilization” and metadata={key1:{values_subset:[value1, value2, . . . ], cardinality: ‘high’}. These values are either provided to the orchestration agent 1202, which provides the metric results to a second sub-LLM, e.g., the programming code generator sub-LLM 1208 (or such is provided directly between sub-LLMs), which reads the result and calls a tool to generate programming code, e.g., a generate_signalflow_program tool (not shown), and then calls a second tool to execute the programming code, e.g., an execute_signalflow_program tool (not shown). The tools called by the programming code generator sub-LLM 1208 utilize the results obtained and generated by the metrics sub-LLM 1220, and the execute_signalflow_program tool executes the programming code generated by the generate_signalflow_program tool.

The orchestration agent 1202 receives the responses from one or more of the plurality of sub-LLMs and generates a response to the question (blocks 1244, 1245). In some instances, the orchestration agent generates a graphical user interface (GUI) displaying a response to the user input question based on the responses by the sub-LLMs that is displayed within a chatbot interface. For example, the orchestration agent 1202 reads the result from programming code generator sub-LLM 1208 and returns an answer to the user such as: “The mean AWS EC2 CPU utilization percentage for instance i-e8b1df4b is 54% over the last week”. To note, the result to such a question may be specific and particularized to the user's environment. The orchestration agent 1202 and any of the sub-LLMs and/or tools invoked or called in generating an answer to the question may be provided certain environment data and/or access to the user's environment, such as access to databases for parsing and querying. In some instances,

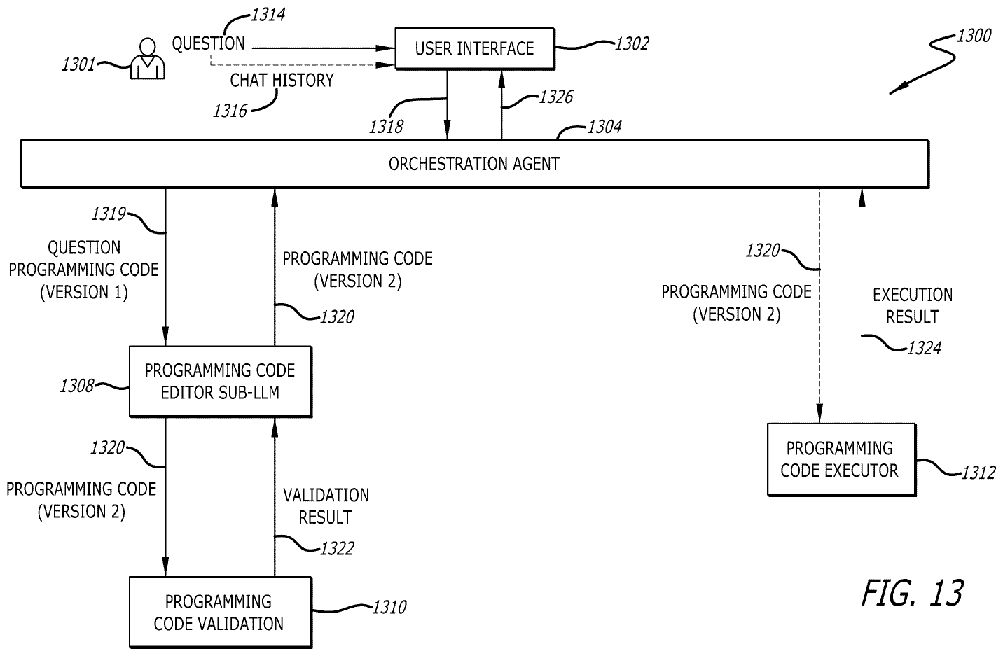

FIG. 13 is a diagrammatic flow illustrating sub-modules and functionality of a language model configured to automatically edit programming code and for deployment by an orchestration agent according to an implementation of the disclosure. The operating environment 1300 includes a deployable orchestration agent 1304, a programming code editor sub-LLM 1308, a programming code validation logic module 1310, and a programming code executor logic module 1312. The flow of data and processing illustrated in FIG. 13 provides an illustrative example as to how the modularization deployment of FIG. 12A may operate.

The example illustrated in FIG. 13 includes a user 1301 providing a user input question 1314 to the orchestration agent 1304 via a user interface 1302. The user interface 1302 may include or receive chat history 1316 between the user and the orchestration agent 1304 (where the user input question 1314 and the chat history 1318 are illustrated collectively as input 1318 to the orchestration agent 1304). The orchestration agent 1304 may evaluate the user input question 1314 by determining a plan for answering the user input question 1314, which may pertain to a user's desire to edit previously generated programming code. In such an example, the orchestration agent 1304 invokes the programming code editor sub-LLM 1308 by providing a prompt 1319 including the user input question 1314 and the programming code to be edited (version 1). The programming code editor sub-LLM 1308 evaluates the prompt 1319 and edits the programming code (version 1) resulting in programming code (version 2) 1320.

Continuing the example illustrated in FIG. 13, the programming code editor sub-LLM 1308 invokes the programming code validation logic module 1310 by providing parameters (and optionally instructions), e.g., via an API, which include at least the programming code (version 2) 1320. The programming code validation logic module 1310 may be configured to validate the programming code (version 2) 1320, which includes determining whether the programming code (version 2) 1320 is capable of being executed without causing a syntax error. Thus, the programming code validation logic module 1310 may be comprised of a rule set or heuristics that assess the syntactical accuracy of programming code provided to the logic module. In other examples, the programming code validation logic module 1310 may be a machine learning model that analyzes the syntax of the programming code validation logic module 1310 with respect to a particular programming language. The validation result 1322 generated by the programming code validation logic module 1310 (e.g., “yes”/“no”; ‘1’/‘0’, or some other indication as to the validation result) is provided to the programming code editor sub-LLM 1308. In some instances when a syntax error has been identified, the programming code validation logic module 1310 will identify such in the validation result 1322, and optionally, provide suggestions on how to correct the syntax error. The programming code validation logic module 1310 will then correct the error and send the revised programming code (version 3) to the programming code validation logic module 1310 for validation, where multiple cycles of revisions may occur until the validation result 1322 indicates no syntax errors. The programming code (version 2, or subsequent version) 1320 is provided to the orchestration agent 1304 in response to the prompt 1319. The orchestration agent 1304 may reason over the user input question 1314 and determine whether the programming code (version 2, or subsequent version) 1320 is to be returned in the user interface 1302 or is to be executed by the programming code execution sub-LLM 1312, with the execution result 1324 (e.g., a time-series dataset) returned to the orchestration agent 1304 for subsequent return to the user 1301 via the user interface 1302.

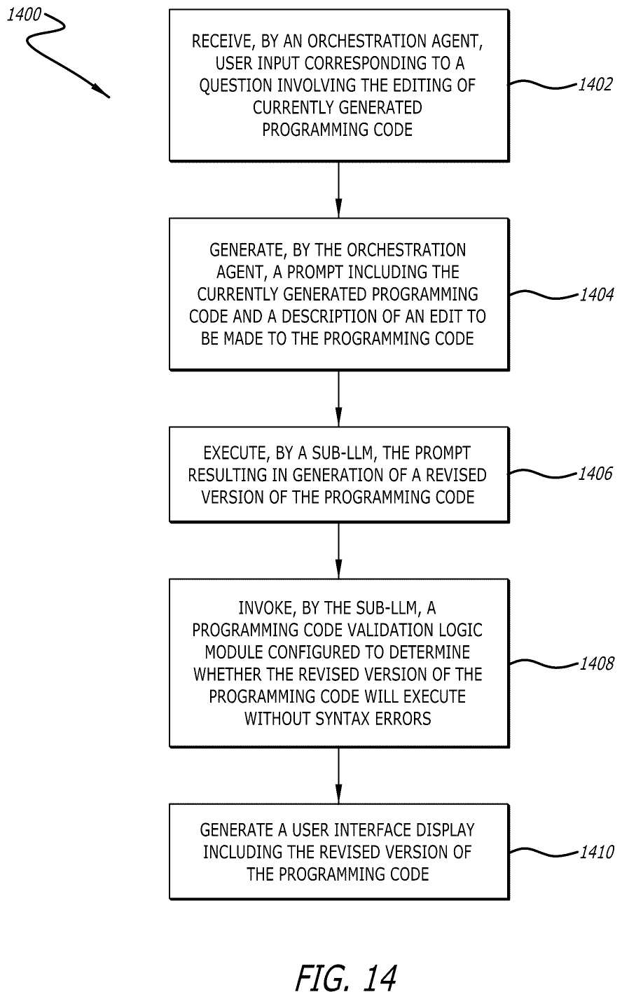

FIG. 14 is a flowchart illustrating an example process of operations for automatically editing programming code by the language model of FIG. 13 according to an implementation of the disclosure. Each block illustrated in FIG. 14 represents an operation in the process 1400 performed by, for example, the system of FIG. 13. It should be understood that not every operation illustrated in FIG. 14 is required. In fact, certain operations may be optional to complete aspects of the process 1400. The discussion of the operations of process 1400 may be done so with reference to any of the previously described figures.

The process 1400 begins with an operation of receiving, by an orchestration agent formed of or including a large language model (LLM), user input corresponding to a question involving the editing of currently generated programming code (block 1402). An illustrative example of such a user input question may include, “Lower the threshold to have a value of 50 in the following SignalFlow statement:

$$cpu\_alert = cpu\_usage . mean ( by = [ ' kubernetes\_node ' ] ) . filter ( value > 80 ) ”$$

Following receipt of the user input question, the orchestration agent may generate a prompt including the currently generated programming code (e.g., the SignalFlow statement above) and a description of an edit to be made to the programming code (block 1404). In some instances, the prompt generated by the orchestration agent may merely include providing the user input question to the programming code editor sub-LLM. In other instances, the orchestration agent may craft a prompt instructing the programming code editor sub-LLM to perform one particular task when the user input questions includes a plurality of requested tasks. For example, if the user requests both an editing of programming code and an execution of the edited version, the orchestration agent may craft a prompt that instructs the programming code editor sub-LLM to edit provide programming edit but does not instruct on execution, which may be done by the orchestration agent by invoking a programming code execution logic module upon receipt of the edited programming code.

The programming code editor sub-LLM then executes the prompt resulting in generation of a revised version of the programming code (block 1406). Using the example above, the revised version of the programming code may include the following SignalFlow statement:

$$cpu\_alert = cpu\_usage . mean ( by = [ ' kubernetes\_node ' ] ) . filter ( value > 50 )$$

Following generation of the revised version of the programming code, the programming code editor sub-LLM may invoke a programming code validation logic module via an API call with instructions to validate the revised version of the programming code (block 1408). Importantly, as the programming code editor sub-LLM is itself a language model, it has the capability to perform API calls to logic modules and instruct a logic module to perform a particular task, e.g., validate a programming code statement where the input to the logic module includes the programming code statement. In some instances, the programming code validation logic module may require additional input such as a particular programming language. In other instances, a plurality of programming code validation logic module may be accessible to the programming code editor sub-LLM, where each programming code validation logic module is configured to validate programming code according to the syntax of a specific programming language. In some instances, the workflow of the programming code editor sub-LLM instinctively invokes a programming code validation logic module following generation of a revised version of programming code. In other instances, the prompt from the orchestration agent may include an explicit instruction to perform validation.

Following the validation process, when the revised version of the programming code has been successfully validated, e.g., determined not to include syntax errors that would prevent or interfere with proper execution thereof, the orchestration agent generates a user interface display including the revised version of the programming code (block 1410). As noted, an optional operation may include automated execution of the revised programming code based on the user input question and the reasoning performed by the orchestration agent to determine whether execution is desired by the user.

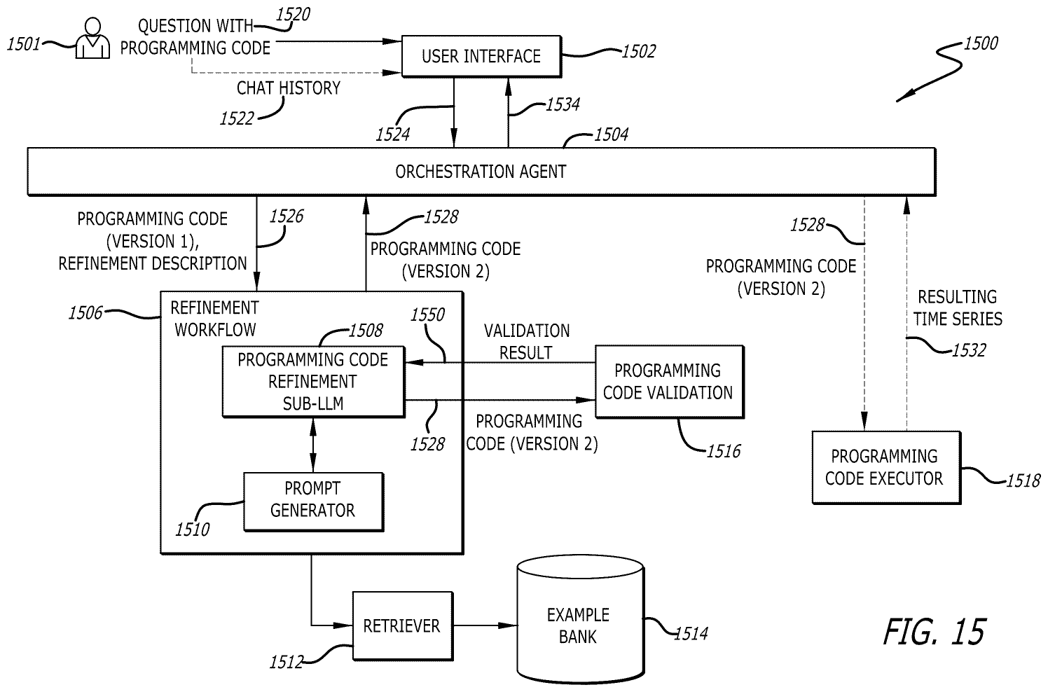

FIG. 15 is a diagrammatic flow illustrating sub-modules and functionality of a language model configured to automatically increase the efficiency of programming code and for deployment by an orchestration agent according to an implementation of the disclosure. The operating environment 1500 includes a deployable orchestration agent 1504, a programming code refinement sub-LLM 1508, a prompt generator 1510, a retriever logic module 1512 coupled to an example bank 1514, a programming code validation logic module 1516, and a programming code executor logic module 1532. The flow of data and processing illustrated in FIG. 15 provides an illustrative example as to how the modularization deployment of FIG. 13 may operate. In particular, FIG. 15 illustrates a refinement workflow 1506 that includes a prompt generator 1510 configured to invoke a retriever logic module 1512 to perform RAG processing through access of the example bank 1514. It should be understood that the functionality of the prompt generator 1510 may be included within the programming code refinement sub-LLM 1508.

The example illustrated in FIG. 15 includes a user 1501 providing a user input question 1520 to the orchestration agent 1504 via a user interface 1502. The user interface 1502 may include or receive chat history 1522 between the user and the orchestration agent 1504 (where the user input question 1520 and the chat history 1522 are illustrated collectively as input 1524 to the orchestration agent 1504).

The orchestration agent 1504 may evaluate the user input question 1520 by determining a plan for answering the user input question 1520, which may pertain to a user's desire to refine previously generated programming code (“refining programming code”), which may refer to improving the efficiency of executing the programming code, improving the latency processing, reducing the resource usage required for execution, etc. In such an example, the orchestration agent 1504 invokes the programming code refinement sub-LLM 1508 by providing a prompt 1526 including the user input question 1520 and the programming code (version 1) that is to be edited. In some instances, the programming code refinement sub-LLM 1508 evaluates the prompt 1526, and invoke a retriever logic module 1512 to perform a RAG process to retrieve programming code examples that have at least a threshold level of similarity to the programming code (version 1), e.g., based on a task description of the programming code and/or a refinement description, each which may be provided by the orchestration agent 1504. A prompt generator 1510 may then generate a prompt for the programming code refinement sub-LLM 1508 including the user question 1520, the programming code (version 1), a refinement description provided by the orchestration agent (optional), and any retrieved examples via the RAG process. It should be understood that the prompt generator 1510 may be incorporated into the programming code refinement sub-LLM 1508. The prompt generated by the prompt generator 1510 is then executed resulting in generation of a refined programming code (version 2) 1528.

Continuing the example illustrated in FIG. 15, the programming code refinement sub-LLM 1508 invokes the programming code validation logic module 1516 by providing parameters (and optionally instructions), e.g., via an API, which include at least the programming code (version 2) 1528. The programming code validation logic module 1516 may be configured to validate the programming code (version 2) 1528, which includes determining whether the programming code (version 2) 1528 is capable of being executed without causing a syntax error. Thus, the programming code validation logic module 1516 may be comprised of a rule set, heuristics, or a machine learning model that analyzes the syntax of the programming code validation logic module 1310 with respect to a particular programming language. The validation result 1530 generated by the programming code validation logic module 1516 is provided to the programming code refinement sub-LLM 1508. In some instances when a syntax error has been identified, the programming code validation logic module 1516 will identify such in the validation result 1530, and optionally, provide suggestions on how to correct the syntax error. The programming code validation logic module 1516 will then correct the error and send the revised programming code (version 3) to the programming code validation logic module 1516 for validation, where multiple cycles of revisions may occur until the validation result 1530 indicates no syntax errors. The programming code (version 2, or subsequent version) 1528 is provided to the orchestration agent 1504 in response to the prompt 1526. The orchestration agent 1504 may reason over the user input question 1520 and determine whether the programming code (version 2, or subsequent version) 1528 is to be returned in the user interface 1502 or is to be executed by the programming code execution sub-LLM 1518, with the execution result 1532 (e.g., a time-series dataset) returned to the orchestration agent 1504 for subsequent return to the user 1501 via the user interface 1502.

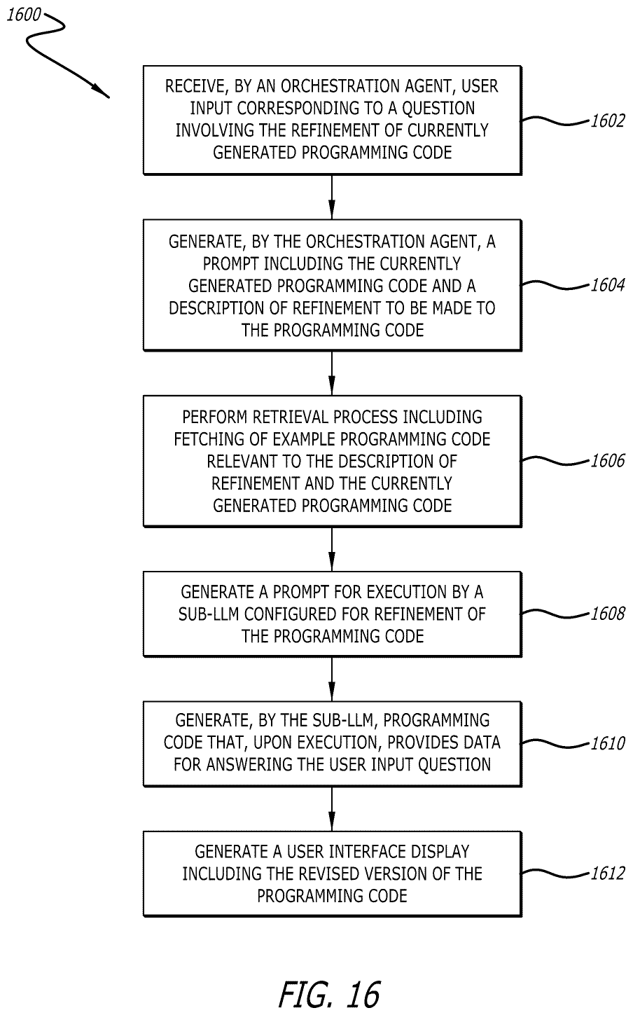

FIG. 16 is a flowchart illustrating an example process of operations for automatically increasing the efficiency of programming code by the language model of FIG. 15 according to an implementation of the disclosure. Each block illustrated in FIG. 16 represents an operation in the process 1600 performed by, for example, the system of FIG. 15. It should be understood that not every operation illustrated in FIG. 16 is required. In fact, certain operations may be optional to complete aspects of the process 1600. The discussion of the operations of process 1600 may be done so with reference to any of the previously described figures.

The process 1600 begins with an operation of receiving, by an orchestration agent formed of or including a large language model (LLM), user input corresponding to a question involving the refinement of currently generated programming code (block 1602). An illustrative example of such a user input question may include, “Please improve the efficiency of the following SignalFlow statement by filtering according to kubertnetes and prod clusters:
cpu_usage=data(‘kubernetes.node.cpu.utilization’)”

Following receipt of the user input question, the orchestration agent may generate a prompt including the currently generated programming code (e.g., the SignalFlow statement above) and a description of a refinement to be made to the programming code (block 1604). In some instances, the prompt generated by the orchestration agent may merely include providing the user input question to the programming code refinement sub-LLM. In other instances, the orchestration agent may craft a prompt instructing the programming code refinement sub-LLM to perform one particular task when the user input questions includes a plurality of requested tasks, as discussed above with respect to FIG. 14. As part of the refinement workflow 1506, the refinement process may benefit from providing the programming code refinement sub-LLM 1508 with examples of efficient programming code that is similar to the programming code (version 1) provided by the user 1501. Thus, the programming code refinement sub-LLM 1508 (or the prompt generator 1510) may invoke a retriever logic module 1512 to perform a RAG process that includes retrieving examples of programming code that meet certain efficiency benchmarks and have at least a threshold level of similarity to the programming code (version 1) from an example bank 1514. In some instances, the efficiency benchmarks may be indicated via metadata for a programming code example stored within the example bank 1514. The refinement description or a task description describing the purpose of programming code provided by the orchestration agent may be utilized by the retriever logic module 1512 when performing the RAG process. The prompt generator 1510 may then generate a prompt for the programming code refinement sub-LLM 1508 that includes at least the programming code (version 1), a refinement description (provided by the orchestration agent), and any retrieved examples from the example bank 1514.

The programming code refinement sub-LLM then executes the prompt generated by the prompt generator 1510 resulting in generation of a revised version of the programming code (block 1610). As noted above, the prompt generator 1510 may be combined with the programming code refinement sub-LLM 1508 in some examples. Using the example above, the revised version of the programming code may include the following SignalFlow statement (e.g., added filters to reduce the amount of fetched data):

$$\begin{matrix}cpu\_usage = data ( ' kubernetes . node . cpu . utilization ' , \\ filter = filter ( ' kubernetes\_cluster ' , ' prod - cluster ' ) )\end{matrix}$$

Following generation of the revised version of the programming code, the programming code refinement sub-LLM may invoke a programming code validation logic module via an API call with instructions to validate the revised version of the programming code (block 1612). Importantly, as discussed above with respect to FIG. 14, the programming code refinement sub-LLM is itself a language model, it has the capability to perform API calls to logic modules and instruct a logic module to perform a particular task. Following the validation process, when the revised version of the programming code has been successfully validated, e.g., determined not to include syntax errors that would prevent or interfere with proper execution thereof, the orchestration agent generates a user interface display including the revised version of the programming code (block 1614). As noted, an optional operation may include automated execution of the revised programming code based on the user input question and the reasoning performed by the orchestration agent to determine whether execution is desired by the user.

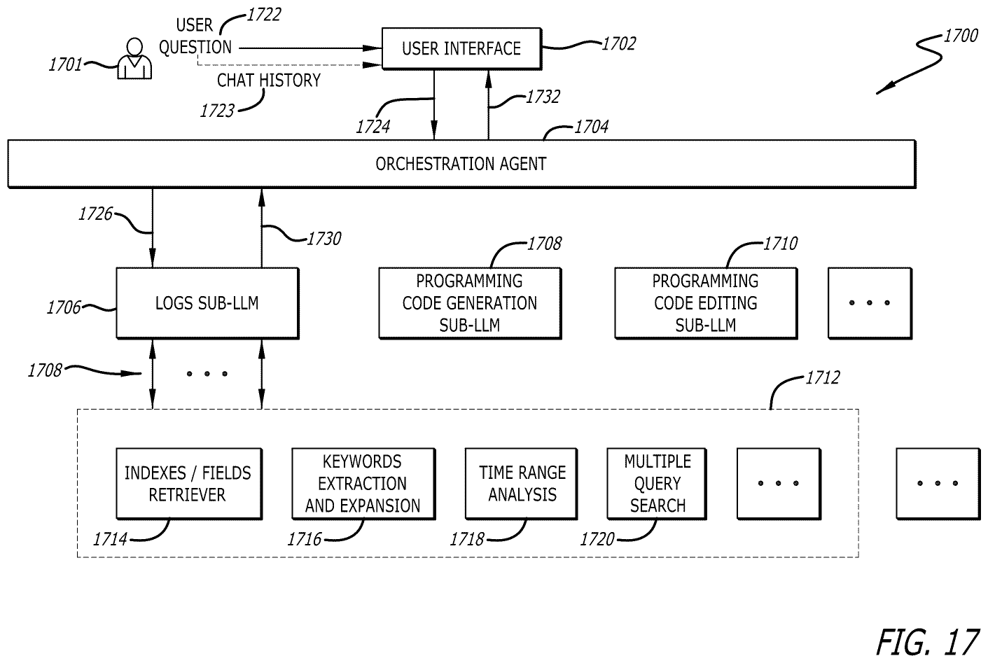

FIG. 17 is a diagrammatic flow illustrating sub-modules and functionality of a language model configured to automatically perform log queries and for deployment by an orchestration agent according to an implementation of the disclosure. The operating environment 1700 includes a deployable orchestration agent 1704, a plurality of sub-LLMs including at least a logs sub-LLM 1706, a programming code generation sub-LLM 1708, a programming code editing sub-LLM 1710, etc., and a plurality of logic modules includes at least a logs-specific set of logic modules including at least an indexes/fields retriever 1714, a keywords extraction and expansion logic module 1716, a time range analysis logic module 1718, a multiple query search logic module 1720, etc.

The example illustrated in FIG. 17 includes a user 1701 providing a user input question 1722 to the orchestration agent 1704 via a user interface 1702. The user interface 1704 may include or receive chat history 1723 between the user 1701 and the orchestration agent 1704 (where the user input question 1722 and the chat history 1723 are illustrated collectively as input 1724 to the orchestration agent 1704).

The orchestration agent 1704 may evaluate the user input question 1722 by determining a plan for answering the user input question 1722, which may pertain to or other involve the retrieval and analysis of logs. As used herein, a “log” may include a timestamped text-based record of an event happening within a networking system. Additionally, the term “event” may refer to a discrete portion of machine data that can be associated with a timestamp. The orchestration agent 1704 generates a prompt 1726 for the logs sub-LLM 1706, which is specifically trained, configured, and fine-tuned to respond to prompts involving log queries and analysis by invoking one or more logic modules and synthesizing the results, which may include summarizing, filtering, or analyzing a set of logs returned from the execution of one or more search queries against a log data store. The logs sub-LLM 1076 parses the prompt 1726 and determines which logic modules need to be invoked to generate one or more search queries that will return logs to respond to the prompt 1726.

As an example, the logs sub-LLM 1706 may parse the prompt 1726 and invoke the indexes/fields retriever logic module 1714 that is configured to indexes and fields corresponding to the user 1701, which are used in composing a search query. The indexes/fields retriever logic module 1714 may communicatively connect to a logs data store platform (e.g., a collection of one or more logs data stores). The indexes/fields retriever logic module 1714 may retrieve fields using an API call (e.g., a REST API call) to the logs data store platform that returns a summary or listing of fields within the data stored by the logs data store platform. In some examples, the API call may be made to a fieldsummary endpoint within a data intake and query system deployment. Additionally, the indexes/fields retriever logic module 1714 may retrieve indexes using query to the data intake and query system deployment that returns a summary or listing of available indexes within the data intake and query system deployment. In some examples, the query may be a getConnectionIndexes query made via an API call using a connection identifier (ID) to a Log Observer Connect (LOC) platform, which may refer to the logs data store platform. For example, the connection ID, along with appropriate credential information or tokens, may enable the orchestration agent 1704, the sub-LLM 1706, and logic modules to connect to a networking environment of the user 1701 to access the logs data store platform and exchange data with a data intake and query system operating therein. Additionally, the logs sub-LLM 1706 may invoke the keywords extraction and expansion logic module 1716 to extract keywords from the prompt 1724 and, optionally, expand the scope of the extracted keywords based on synonyms of the extracted keywords (e.g., expand “outage” to “failure”). The time range analysis tool 1718 may also be invoked to determine a time range implicated in the prompt 1726, which may include an analysis for a time range within the user question 1722.

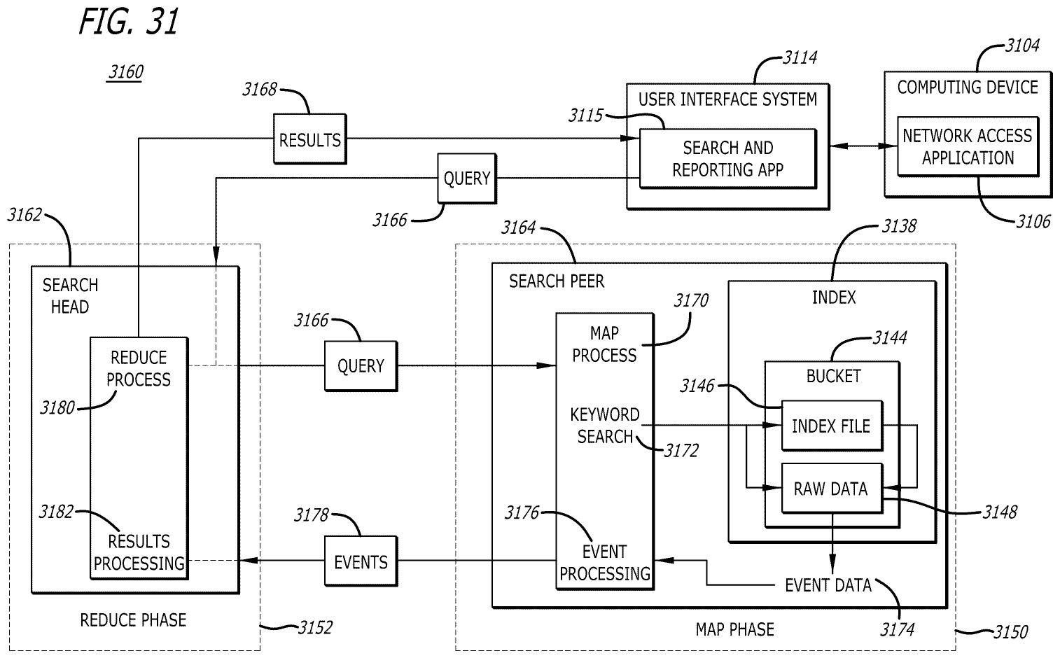

The logs sub-LLM 1706 may the generate a search query, e.g., in a search processing language such that as discussed below at least with respect to FIG. 31, based on the results returned by the logic modules invoked. In some examples, the logs sub-LLM 1706 may populate a search query template configured to cause performance of a search against a data store and return a set of logs. For instance, the logs sub-LLM 1706 may populate the search query template with returned fields/indexes, returned keywords, and a returned time range. The logs sub-LLM 1706 may then cause execution of the search query by a data intake and query system instance against a specified data store and receive a set of one or more logs in return. In some instances, no logs may be returned based on the search query. The logs may be clustered and then analyzed by the logs sub-LLM 1706. In some instances, additional keywords may be extracted from the returned logs to expand or contract the scope of the search query, where the search query may be revised and executed to retrieve a second set of logs. Alternatively, or in addition, the logs sub-LLM 1706 may adjust the search query template to alter the scope of the search, such as by altering the Boolean pattern utilized in the search query (e.g., changing “OR” or “AND” or vice versa). The prompt 1726 provided by the orchestration agent 1704 may provide instructions or directions on which approach to utilize in altering the scope of the search, if needed. For example, when a very large set of logs are returned, e.g., 10,000 logs, the scope may be narrowed by using additional filters and/or fewer keywords, or adjusting the Boolean pattern in the search query by changing one or more uses of “OR” to “AND”. The reverse may be true when expanding the scope of the search query when a limited number of logs are returned (or no logs returned).

In some instances, the prompt 1726 may include a complex request or instruction requiring the generation or population of multiple search queries with different fields, different keywords, and different Boolean patterns. The population of multiple search queries may be performed by invoking the multiple query search logic module 1720. Each search query may then be executed with the returned logs summarized, synthesized, and/or analyzed by the logs sub-LLM 1706 (or the orchestration agent 1704) based on user question 1722.

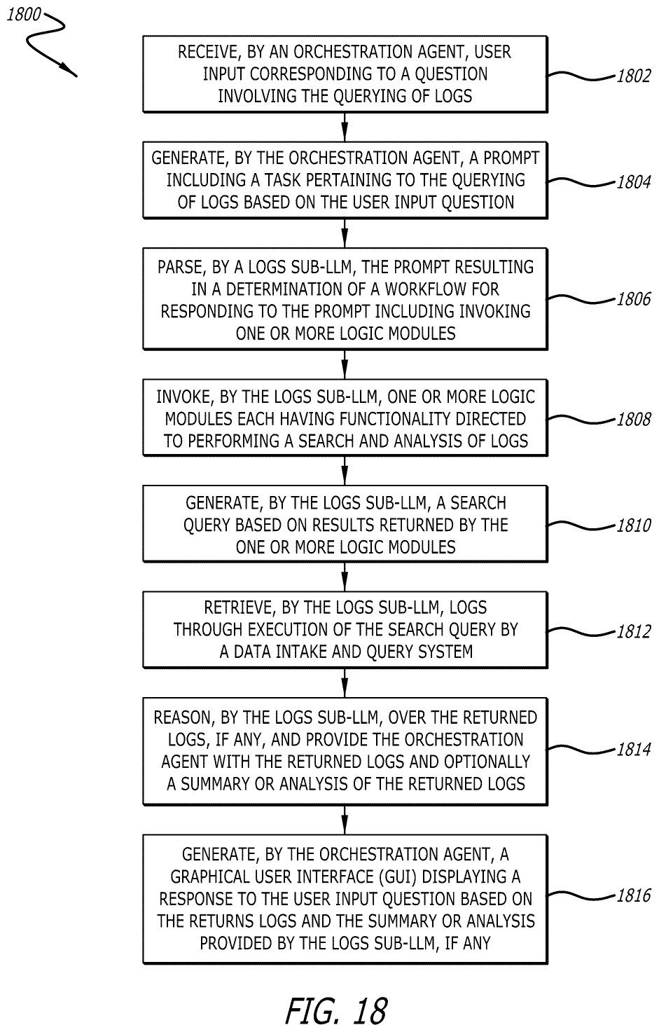

FIG. 18 is a flowchart illustrating an example process of operations for automatically performing log queries by the language model of FIG. 17 according to an implementation of the disclosure. Each block illustrated in FIG. 18 represents an operation in the process 1800 performed by, for example, the system of FIG. 17. It should be understood that not every operation illustrated in FIG. 18 is required. In fact, certain operations may be optional to complete aspects of the process 1800. The discussion of the operations of process 1800 may be done so with reference to any of the previously described figures, and particularly with reference to FIG. 17.

The process 1800 begins with an operation of receiving, by an orchestration agent formed of or including a large language model (LLM), user input corresponding to a question involving the querying of logs (block 1802). Following receipt of the user input question, the orchestration agent may generate a prompt including user input corresponding to a question involving the querying of logs (block 1804). In some instances, the prompt generated by the orchestration agent may merely include providing the user input question. In other instances, the orchestration agent may craft a prompt that includes details on how to generate an initial set of keywords and how to navigate through the logs using the generated keywords along with time range instructions, and different Boolean patterns to try. Additionally, the prompt generated by the orchestration agent may include instructions on operations to perform or steps to follow depending on a number of logs retrieved.

The prompt is provided to a logs sub-LLM, which parses the prompt resulting in a determination of a workflow for responding to the prompt including invoking one or more logic modules and subsequently invoke the one or more logic modules (blocks 1806, 1808). In parsing the prompt, the logs sub-LLM may determine a plan for responding to the prompt, which may include invoking or more logic modules, especially those having specialized functionality directed to log-related operations such as keyword extraction and expansion, time range analysis, index/field retrieval, etc.

Each of the one or more logic modules may perform specialized tasks, such as those discussed above with respect to FIG. 17, and return information such as indexes/fields of data stored in the user's environment, keywords and time ranges extracted from the prompt provided by the orchestration agent, etc. The logs sub-LLM then generates a search query based on results returned by the one or more logic modules (block 1810). In some examples, the generation of the search query involves populating a search query template configured to retrieve logs upon execution, which may be performed by a data intake and query system processing in the user's environment. The logs sub-LLM then retrieves a set of logs through execution of the search query by a data intake and query system (block 1812). As the search query has been generated based on terms in the prompt provided by the orchestration agent and/or the user question provided to the orchestration agent, the retrieved logs are relevant to providing a response to the prompt provided by the orchestration agent. The logs sub-LLM may then reason over the returned logs, if any (e.g., in some instances, no logs meet the filters and criteria of a search query), and provide the orchestration agent with the returned logs and, optionally, a summary or analysis of the returned logs (block 1814). The orchestration agent may then generate a graphical user interface (GUI) displaying a response to the user input question based on the returns logs and the summary or analysis provided by the logs sub-LLM, if any.

The following provides an illustrative example of a user question and a reasoning trace provided in response to the user question that explain the steps taken by the logs sub-LLM. The illustrative user question is, “Look for any relevant error logs for the paymentservice in the bits-jp environment.” The illustrative reasoning trace is: “I conducted a series of searches to find relevant error logs for the **paymentservice** in the **bits-jp** environment. Here's a summary of the steps taken and the results obtained:
1. **Initial Search**: I searched for logs containing keywords related to errors, specifically looking for terms like “error”, “failure”, “exception”, and “critical” combined with “paymentservice” and “bits-jp”. Unfortunately, no logs were found.
2. **Refined Search**: I then narrowed the search by removing the “bits-jp” keyword and focused on just “error” and “paymentservice”. Again, no logs were retrieved.
3. **Further Refinement**: I continued to refine the search by using broader terms like “error” and “paymentservice” with “bits” instead of “bits-jp”. Still, no relevant logs were found.
4. **Broadened Search**: Finally, I broadened the search by using “OR” to include any logs that contained “error” or “paymentservice” or “bits”. This time, I retrieved several logs, but they did not specifically indicate errors related to the **paymentservice**.
###Retrieved Logs

Here are some of the logs retrieved during the final search:
1. **Log Entry 1**:
   **Timestamp**: 2024-11-15T09:53:13.690-08:00
   **Service**: currencyservice
   **Message**: “conversion request successful”
   **Severity**: info
2. **Log Entry 2**:
   **Timestamp**: 2024-11-15T09:53:13.529-08:00
   **Service**: frontend
   **Message**: “request complete”
   **Severity**: debug
3. **Log Entry 3**:
   **Timestamp**: 2024-11-15T09:53:11.000-08:00
   **Service**: paymentservice
   **Message**: “Charging through ButtercupPayments”
   **Severity**: info

###Conclusion: Despite multiple attempts to find error logs specifically for the **paymentservice** in the **bits-jp** environment, no relevant error logs were found. The logs retrieved were primarily informational and did not indicate any errors.”

In response to various issues described herein, devices and methods discussed herein provide for an SRv6-enabled AI scheduler that can offer an open-standard, vendor-neutral solution optimizing load distribution across network links, significantly enhancing cluster performance. These embodiments can include various uses within the AI field and can be utilized by various industries. Often, these methods, devices, and/or systems can incorporate one or more large language models (LLMs).

As those skilled in the art will recognize, Artificial Intelligence (AI) is a broad field within computer science focused on creating systems that can simulate aspects of human intelligence. These systems can range from simple rule-based programs to sophisticated models capable of learning, adapting, and making decisions based on data. AI spans various branches, including robotics, computer vision, natural language processing, and reinforcement learning, each aiming to enable machines to perform tasks that traditionally require human cognition. The potential of AI lies in its ability to enhance decision-making, improve efficiency, and even drive innovation across industries. With rapid advancements in computational power and algorithm design, AI is becoming increasingly embedded in our daily lives, powering applications from personal assistants to autonomous vehicles and even aiding in scientific research and complex problem-solving.

Machine learning (ML) is a crucial subset of AI that involves systems learning from data to make predictions or decisions without being explicitly programmed for each task. Unlike traditional software, which relies on hard-coded rules, machine learning systems use algorithms that identify patterns and adjust their behavior based on experience. ML includes various techniques, such as supervised learning, unsupervised learning, and reinforcement learning, each suited to different kinds of tasks. For example, supervised learning is commonly used in classification tasks, while reinforcement learning drives decision-making in dynamic environments. ML serves as the foundation for many modern AI applications, as it enables systems to generalize from data and improve over time. As such, ML systems are central to the development of more advanced AI models and applications, including those that require nuanced understanding, like image recognition and language processing.

Large Language Models (LLMs) represent a specific application of machine learning within AI, focused on understanding and generating human language. Positioned within the broader field of natural language processing (NLP), LLMs utilize advanced machine learning architectures, particularly deep learning and transformer models, to process vast amounts of text data. Through this training, LLMs develop the ability to capture context, generate coherent responses, and perform complex language-based tasks, making them valuable tools in a range of applications, from chatbots to content creation and data analysis.

By processing vast amounts of text data, these LLMs can capture intricate patterns, nuances, and contextual relationships within language, allowing them to respond with relevance and a degree of fluency previously seen only in human communication. Broadly, LLMs work by breaking down text into tokens, converting them into vector representations, and using complex architectures with attention layers and multi-layer perceptrons to generate contextually appropriate responses. This process can enable the models to understand context, recall relevant information, and even produce creative or technical outputs based on learned knowledge. Their impact spans multiple industries. For example, they can support customer service, automate repetitive tasks, assist with brainstorming and writing, and even provide foundational support in software development and data analysis.

As those skilled in the art will recognize, the principles underlying LLMs can be generalized to other forms of AI models that handle diverse types of data, such as audio, visual, and even multimodal information. While LLMs are specialized for processing and generating language, similar architectures and concepts apply to Large Audio Models (LAMs), Large Vision Models (LVMs), and Large Foundation Models (LFMs) that incorporate multiple data types. These models operate on the same foundational ideas such as breaking down complex input (whether sounds, images, or mixed formats) into smaller, structured units, transforming these into numerical representations, and using layers of processing to capture relationships, context, and patterns within the data. Just as LLMs use tokens and embeddings for text, LAMs may segment and analyze audio signals, while LVMs and LFMs might extract features from images or combine textual and visual data for a richer, holistic understanding. This generalizable framework can enable AI to address tasks across different domains, making it possible to train models that understand, generate, and respond to varied data formats, whether in speech recognition, image analysis, or other complex, cross-functional applications. Consequently, the discussion of LLMs opens doors to understanding a broader landscape of AI technologies that share structural similarities yet target distinct types of information.

In many embodiments, the first stage in processing with an LLM can involve breaking down text into tokens, which are individual units that may represent words, subwords, or characters. This process, called tokenization, can assign each unique token a specific identifier, providing a standard format that the model can use to handle text more systematically. By transforming language input into a structured sequence of tokens, the model can gain a foundation that supports further transformations and simplifies working with complex text.

In more embodiments, the model may use an embedding matrix to convert each token into a dense vector, capturing its semantic meaning in numerical terms. The embedding matrix may hold a unique vector representation for each token, designed so that similar words or concepts can be positioned near each other in the model's multi-dimensional space. This approach can help the model achieve a form of conceptual understanding, where tokens with related meanings may be encoded in ways that reflect their relationships. By producing these vector representations, the model can start to develop a nuanced understanding of each token's role within a broader context.

With tokens now represented as vectors, the model can organize these vectors into an array that may hold the sequence of tokens from the original input text. This array can preserve the order of tokens, structuring them as a unified dataset for further processing. By arranging token information in this structured format, the model can prepare the data for a sequence of processing layers that may work to extract patterns and relationships within the data. Each vector within the array can carry information about a token's meaning and context, positioning the data for deeper levels of processing.

In further embodiments, an LLM can include one or more attention layers, which can enable the model to compare different parts of the input sequence and assess their contextual relevance. These attention layers may allow the model to assign varying levels of focus across tokens depending on the patterns it detects, highlighting words or phrases that can carry the most significance in a given context. By adjusting its focus across the sequence, the model can capture relationships between tokens that may not be apparent from isolated words. The attention mechanism can help the model build a detailed understanding, determining which parts of the input should influence the output most strongly.

Once these attention layers have established relationships within the input, the data may pass through one or more Multi-Layer Perceptrons (MLPs). In further embodiments, MLPs are fully connected neural networks that can refine the data further by identifying additional complex relationships and patterns. This stage may allow the model to distill its understanding of the input text, building on insights from the attention layers to develop an even more structured form of comprehension. The MLPs can support the model's ability to respond with greater relevance and coherence by transforming these contextual insights into a format ready for output.

Finally, in various embodiments, the refined data may reach an unembedding layer, where the model can translate its internal vector representations back into tokens. At this stage, the model can select the most probable next token based on the processed data, starting to generate a coherent output sequence. This transformation can allow the model to return from its internal numerical understanding to human-readable language, producing tokens that form a meaningful response. By iterating through these steps, the model can generate an output sequence that aligns with the context of the input, completing the journey from initial text input to comprehensible, contextually relevant output.

In specific embodiments described herein related to large-scale AI training clusters, data parallelism is a commonly adopted approach that allows multiple GPUs to operate in parallel on the same task across extensive datasets. This setup requires frequent synchronization of memory between GPUs, especially as training jobs may involve more than 15,000 iterations. After each iteration, GPUs must often communicate and exchange data, resulting in periodic, bursty flows.

Related to this are Queue Pairs (QPs) that are related to systems that rely on Remote Direct Memory Access (RDMA) for efficient data transfer. A QP can consist of two primary components, including a send queue and a receive queue. Together, these queues manage the flow of data between different nodes in a network, allowing one side to send data while the other receives it. In certain networking technologies, QPs enable direct memory access from one computer to another without involving the host CPU, greatly reducing latency and increasing data transfer speed. This is especially useful in distributed computing environments, where tasks like training machine learning models require the rapid exchange of large volumes of data across multiple machines.

Related to this, Network Interface Cards (NICs) include the hardware responsible for handling data transmission between nodes utilizing QPs. This can allow for greater parallelism and load balancing across network connections. This ability to handle numerous QPs simultaneously enables NICs to manage data flow effectively, distributing network traffic across multiple channels to optimize bandwidth and reduce bottlenecks. In distributed machine learning and AI applications, where large-scale models like LLMs may benefit from consistent, high-speed data exchange between processing units, NICs with QP capacity are desired. However, NICs have a finite capacity for QP flows, meaning they can only manage a limited number of simultaneous data streams, which restricts the number of connections or data transfers it can efficiently handle at once.

Currently, load-balancing mechanisms struggle with the large flows required by LLMs. Hash-based load balancing is particularly prone to issues like hash polarization, where specific flows are repeatedly directed through the same network paths, leading to congestion. This congestion results in significant delays in job completion times, impacting overall training efficiency and scaling. Addressing this challenge of hash polarization is essential to optimize network flow distribution and ensure that training clusters can operate at peak efficiency, minimizing delays and enabling faster AI model training. hash polarization is also problematic.

Additionally, the limited QP (i.e., flows) capacity of NICs presents a further constraint. For example, the NIC performance degrades when using more than a hundred QPs. This prevents breaking down these large flows into smaller, more manageable flows. As a result, the flow characteristics cannot be adjusted to reduce their impact on the network, necessitating a different approach to minimize congestion and polarization. Overcoming this constraint is desired for improving network efficiency in AI training environments and reducing job completion times. Finally, AI training clusters can often suffer from congestion and delays due to hash polarization in load balancing. Current solutions, including Differentiated Services Field (DSF) or User Datagram Protocol (UDP) port manipulation, have limitations in interoperability, adaptability to topology changes, and scalability.

To address these challenges, embodiments described herein teach an SRv6-enabled AI scheduler which can offer an open-standard, vendor-neutral solution that optimizes load distribution across network links, significantly enhancing cluster performance. In many embodiments, dynamic load balancing using Micro-Segment Identifier (uSID) lists are utilized by mapping the Queue Pairs (QPs) of the same source-destination pair (SRC, DST) to multiple disjoint uSID lists. This approach can ensure an even distribution of load across all links in the fabric, effectively mitigating polarization and congestion. Built on the open-standard Segment Routing over IPv6 (SRv6) framework, it can be fully interoperable with diverse vendor ecosystems, ensuring seamless compatibility.

In some embodiments, each uSID list is continuously monitored for health using Intelligent Path Monitoring (IPM), enabling rapid detection and response to path failures for enhanced resilience. Additionally, the solution offers deployment flexibility, as it can be implemented on either Network Interface Cards (NICs) or Top-of-Rack (ToR) switches, accommodating various infrastructure configurations.

In additional embodiments to address the polarization and congestion challenges in AI training clusters, a deterministic Source Routed AI Fabric can be utilized. For example, it is envisioned that various implementations may utilize SRv6 to steer traffic between GPUs, offering a scalable and open-standards-based method that enhances load distribution across network fabric links. Upon job orchestration, each source and destination (SRC, DST) may be mapped to multiple (K) disjointed uSID lists. These uSID lists may be precomputed with the specific objective of balancing traffic load across the network fabric by factoring in link utilization, using a weighted assignment that optimizes link usage and prevents congestion. It should be appreciated that the mechanism may be executed at the DPU (NIC) or at the TOR, depending on where we want to push the “intelligence”.

It is envisioned that the Scheduler, upon job orchestration, for each (SRC, DST) GPU pair it computes multiple disjoint uSID lists that are installed in both homing ToRs of the NIC associated with that GPU. The TOR receives an RDMA over Converged Ethernet v2 (ROCEv2) packet of the form: Eth, IP(SRC, DST), UDP, BTH (QP_identifier). The TOR steers all traffic for that (SRC, DST) into the set of uSID lists that were computed by the controller. The specific SID list to be used can be picked according to ECMP hashing using as input parameters (IP_SRC, IP_DST, UDP_Ports, QP_id). The routers along the DC fabric can steer according to the specific SID list. If, either through the congestion mechanisms (ECN, DCQCN) or through the IPM measurements, it is detected that that specific path is not performing well, then the uSID list can be disabled and the traffic is repathed or otherwise rerouted to another disjoint uSID list. It should be appreciated that the change from the old uSID list to the new uSID list may be flowlet-based (i.e., waiting for a specific amount of time without traffic within the flow to avoid any mis-ordering).

In many embodiments, the Scheduler computes multiple disjoint uSID lists for each source-destination pair (SRC, DST) during job orchestration. On the Network Interface Card (NIC), each Queue Pair (QP) can be assigned two uSID lists: a primary list and a backup list. The NIC crafts the ROCEv2 packet and adds an additional IPV6 header containing the uSID list associated with that QP. As the packet traverses the data center fabric, the routers steer it based on the specific SID list. If performance issues are detected through congestion mechanisms such as ECN or DCQN, or through Intelligent Path Monitoring (IPM) measurements, the system disables the affected uSID list and seamlessly switches to the backup list. The controller may subsequently install a new uSID list on the NIC to ensure optimal performance for future transmissions.

In additional embodiments, traffic associated with each QP may be evenly distributed across multiple, dynamically selected paths in the network fabric, effectively removing polarization without requiring proprietary solutions. By leveraging SRv6's capabilities, embodiments of the disclosure provide a resilient, standardized method for managing high throughput, synchronized GPU communication in AI clusters, thereby improving overall job completion times and network efficiency. Those skilled in the art will appreciate the open standard and interoperability of the embodiments described herein. Furthermore, the various mechanisms may be implemented on the NIC, or on the Top-of-Rack, thereby by adding flexibility to one or more deployment options. To that end, SID lists may be combined with IPM for health monitoring. Consequently, path disruption may be adjusted while maintaining optimal load distribution.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

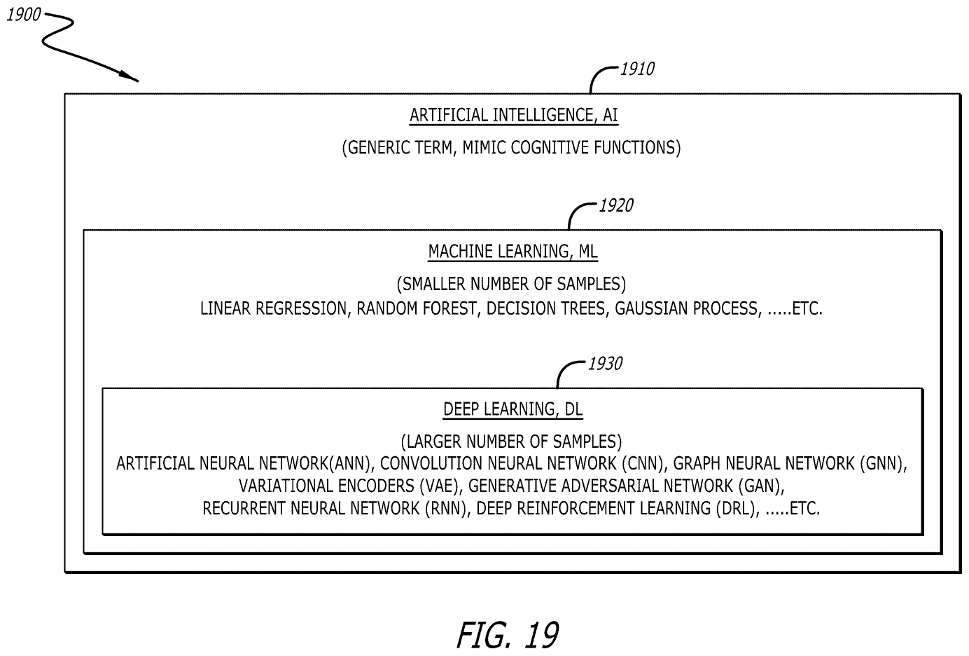

Referring to FIG. 19, a diagram 1900 depicting various subsets of artificial intelligence in accordance with various embodiments of the disclosure is shown. Artificial intelligence (AI) 1910 is typically understood in the art to be the development of machines and algorithms that mimic human intelligence, for example, by optimizing actions to achieve certain goals. At its core, AI 1910 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 1910 can be considered a generic term because it encompasses a wide range of subfields and techniques, from simple rule-based systems to advanced machine learning and deep learning models. These AI techniques are used to simulate various aspects of human cognition. For example, machine learning (ML) 1920 allows computers to learn from data patterns without explicit programming for each task, while natural language processing (NLP) enables machines to understand and generate human language. Deep learning (DL) 1930, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 1910 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 1920 is a subset of Artificial Intelligence (AI) 1910 that focuses on the development of algorithms and statistical models that enable computers to learn and make decisions from data without explicit programming. In traditional programming, a computer is given a fixed set of rules to follow, but ML 1920 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 1920. These algorithms can handle various data types, including numerical, categorical, and structured datasets like spreadsheets or grids. One of the key strengths of ML is its ability to generalize from the training data to make accurate predictions on new, unseen data.

However, traditional ML methods rely heavily on feature engineering, wherein human experts manually identify the most relevant features or patterns within the data. For example, when using ML 1920 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 1900) to learn effectively.

Deep Learning (DL) 1930 is a specialized subset of Machine Learning (ML) 1920 that employs multi-layered artificial neural networks to automatically learn complex patterns and representations from large, often unstructured datasets. Inspired by the way the human brain processes information, DL 1930 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 1930 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 2300 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini batches can be utilized to prevent the network from becoming overly specialized to the training set.

CNNs are a specific type of ML 1930 neural network designed to work particularly well with image data, making them highly relevant for image and video data processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction that is relevant to the underlying process being executed.

While CNNs are well-suited for grid-based data like images, many real-world problems in can involve non-grid data. This type of data may better be represented as a graph, where nodes represent entities (e.g., specific items) and edges represent relationships between them (e.g., characteristics, values, etc.). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an entity or the properties of a related to that or associated entities.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This can allow for the generation of new data by sampling points from the latent space. Similarly, GANs often consist of two components: a generator that creates fake/generated data and a discriminator that tries to distinguish between real and fake data. The two components can be trained in a competitive process where the generator tries to “fool” the discriminator, leading to increasingly realistic generated data.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex data simulations. In various embodiments, DRL can be used in scenarios where an optimal decision needs to be made. The combination of RL and DL can allow for learning from raw data, making it a powerful tool for dynamic and real-time decision-making within various embodiments.

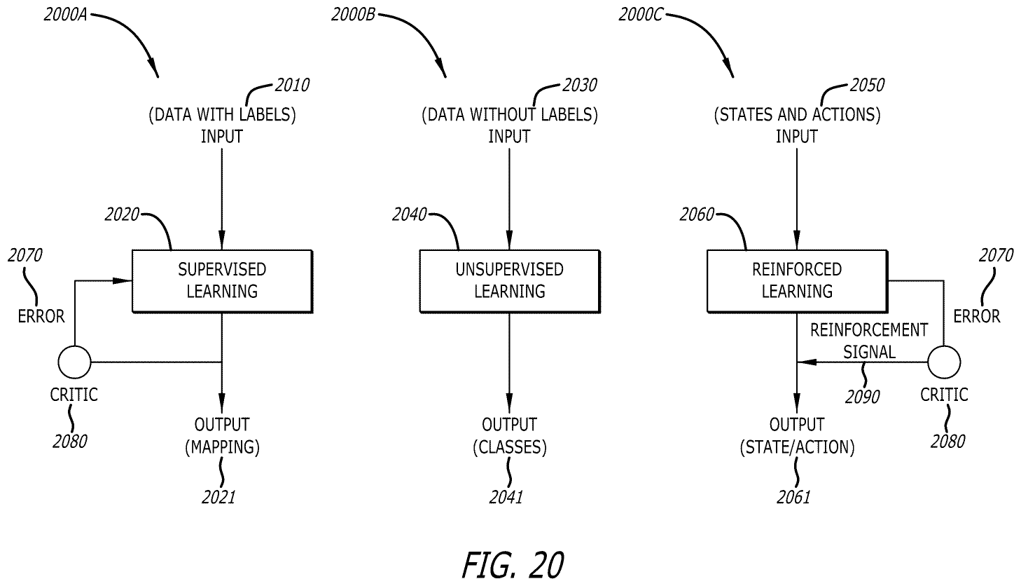

Although a specific embodiment for a diagram 1900 depicting various subsets of artificial intelligence suitable for carrying out the various steps, processes, methods, and operations described herein is discussed with respect to FIG. 19, any of a variety of systems and/or processes may be utilized in accordance with embodiments of the disclosure. For example, other subset may be present and available for use within AI 1910. Those skilled in the art will recognize that the diagram 1900 presented in FIG. 19 is simplified for illustration purposes and various methods and techniques may interact with other areas (ML 1920 with DL 1930, etc.). The elements depicted in FIG. 19 may also be interchangeable with other elements of FIGS. 20-28 as required to realize a particularly desired embodiment.

Referring to FIG. 20, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 20, a supervised learning system 2000A is shown. The supervised learning system 2000A can be configured with a supervised learning model 2020 that accepts input data 2010 and generates an output 2021. However, the output data is often reviewed by a critic 2080 that can determine one or more errors 2070 that are fed back into the supervised learning model 2020 for use in updating.

Supervised learning systems 2000A are often considered the simplest machine learning model to understand in which input data (such as training data) has a known label or result as an output. So, the supervised learning model 2020 can be understood to work on the principle of input-output pairs. As such, a function can be trained using a training data set, which is then applied to unknown data and makes some predictive performance. Supervised learning is task-based and mostly tested on labeled data sets.

Supervised learning systems 2000A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain routing pathway is optimal or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features.

Again, in the embodiment depicted in FIG. 20, an unsupervised learning system 2000B is shown. The unsupervised learning system 2000B can be configured with an unsupervised learning model 2040 that accepts input data 2030 and generates an output 2041. Unlike other model types, there are no critics or error signals to process. Unsupervised learning models 2040 can implement the learning process opposite to supervised learning, which means it enables the model to learn from an unlabeled training dataset. Based on the unlabeled dataset, the unsupervised learning model 2040 can predict the output. Using an unsupervised learning system 2000B, the unsupervised learning model 2040 can learn hidden patterns from the dataset by itself without any supervision. In various embodiments, unsupervised learning models 2040 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 20, a reinforcement learning system 2000C is shown. The reinforcement learning system 2000C can be configured with a reinforcement learning model 2060 that accepts input data 2050 and generates an output 2061. In reinforcement learning, the reinforcement learning model 2060 learns actions for a given set of states that lead to a goal state. In the embodiment depicted in FIG. 20, a critic 2080 can receive or otherwise notice an error 2070 within the reinforcement learning model 2060 actions, and adjust the outcome/output such that the “reward” or “punishment” is adjusted to better model the future behaviors or processing of the reinforcement learning model 2060.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 20, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 20 may also be interchangeable with other elements of FIGS. 19 and 21-28 as required to realize a particularly desired embodiment.

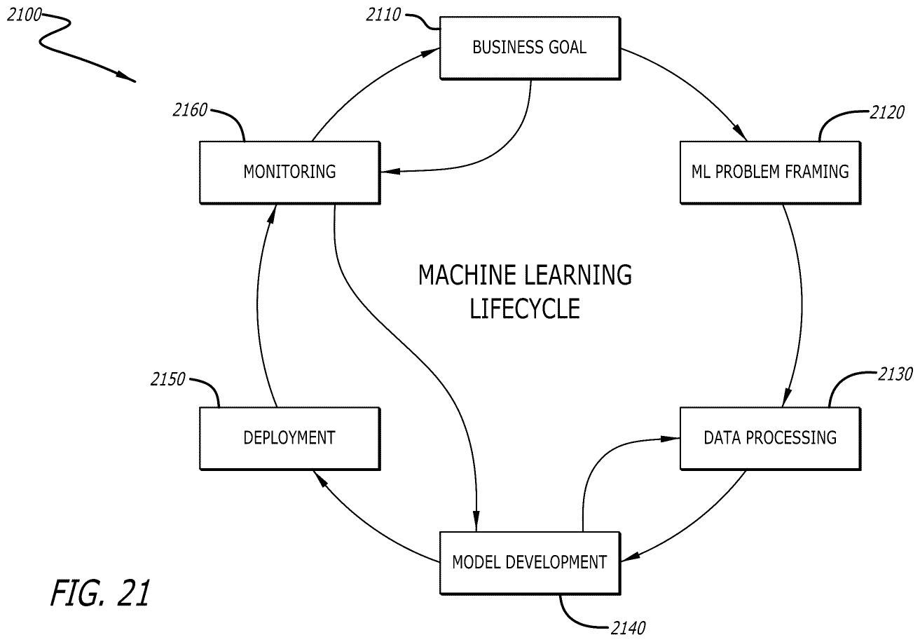

Referring to FIG. 21, a machine learning lifecycle 2100 in accordance with various embodiments of the disclosure is shown. During the development of machine learning systems, the embodiment depicted in FIG. 21 can provide a framework for how to structure the design and maintenance of these systems. This machine learning lifecycle 2100 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 2100 emphasizes that developing a machine learning model is not a one-time effort but an iterative process requiring ongoing monitoring and adjustment. The feedback loop inherent in the machine learning lifecycle 2100 allows for continual refinement and optimization of models to maintain their accuracy and relevance.

In many embodiments, a first stage of the machine learning lifecycle 2100 is identifying the business goal 2110, which sets the overall direction and purpose of the ML project. This can involve understanding the specific problems or opportunities within the business or project that machine learning can address. A clear business goal 2110 ensures that the project remains focused on delivering tangible value. Without a well-defined goal, it can be challenging to align the subsequent stages of the ML lifecycle 2100, as the choice of model, data processing methods, and performance metrics can all depend on what the business aims to achieve.

Establishing a proper business goal 2110 can also involve engaging with key stakeholders and developers to gather requirements and set success criteria. It can provide a roadmap that outlines what success looks like and helps in framing the ML problem. Clearly defined goals not only help guide the project but also provide benchmarks for evaluating the effectiveness of the deployed model once it enters production.

Once the business goal 2110 is established, various embodiments take a next step involving ML problem framing 2120, wherein the goal is translated into a specific machine learning task. This can involve selecting the appropriate type of ML problem, such as classification, regression, clustering, or recommendation, and defining the target variables or outputs. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 2130 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 2130 can require or at least benefit from careful planning and iterative refinement. Once the data is processed, it is typically split into training, validation, and test sets to develop and evaluate the model, ensuring that it generalizes well to new, unseen data.

Model development 2140 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 2140, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 2130.

In further embodiments, deployment 2150 is the stage where the developed model is integrated into the production environment to perform its intended tasks. This phase may involve setting up the necessary infrastructure, such as APIs or cloud-based services, to allow the model(s) to process live data and generate predictions. Deployment 2150 can transform the model from a research tool into a functional component of a business process or product, providing real-time insights, automations, or decisions.

Proper deployment 2150 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 2110.

In more embodiments, monitoring 2160 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 2160, teams can identify when the model's performance drops and requires retraining or adjustments to align with the evolving data.

Monitoring 2160 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 2130 and model development 2140, to refine the model(s) as needed. This iterative process allows the machine learning system to adapt and maintain its alignment with the original business goal 2110 over time.

Although a specific embodiment for a machine learning lifecycle 2100 suitable for carrying out the various steps, processes, methods, and operations described herein is discussed with respect to FIG. 21, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 21 may also be interchangeable with other elements of FIGS. 19-20 and 22-28 as required to realize a particularly desired embodiment.

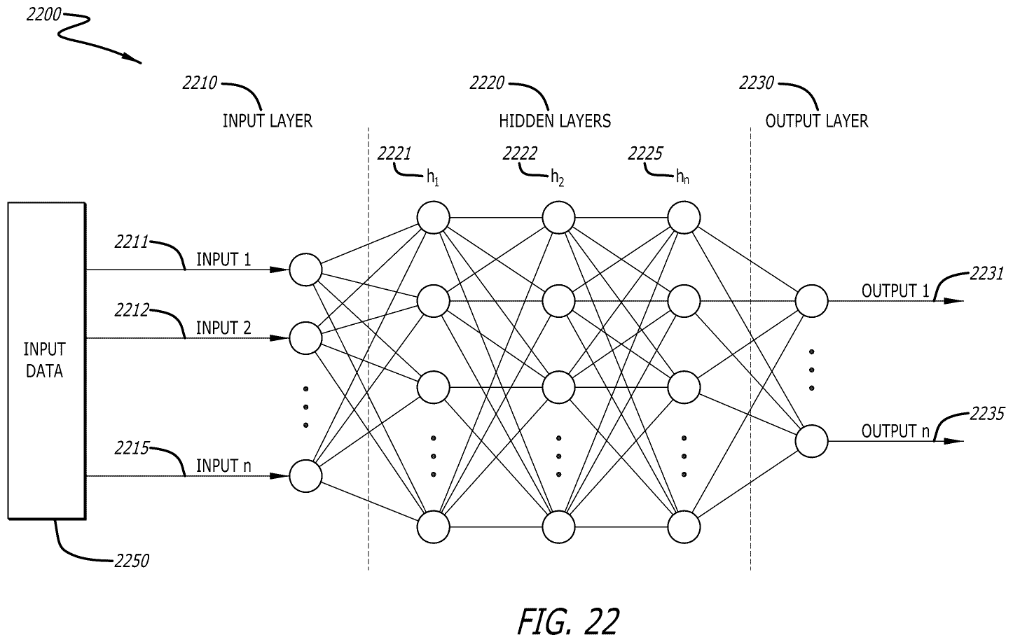

Referring to FIG. 22, an exemplary neural network 2200 in accordance with various embodiments of the disclosure is shown. The embodiment depicted specifically depicts a feedforward neural network with multiple layers. This type of network consists of an input layer 2210, one or more hidden layers 2220, and an output layer 2230. Each layer contains nodes (or neurons) that are interconnected, representing how data flows through the network. The input layer 2210 can receive raw data, which is then processed by the hidden layers 2220 through weighted connections and activation functions. These hidden layers 2220 can enable the network to learn complex patterns and relationships within the data.

The final output layer 2230 produces the network's predictions or classifications based on the processed input. The interconnected nature of the nodes allows the neural network 2200 to learn from data during training by adjusting the weights of connections to minimize prediction errors. This structure is the foundation of deep learning models, as adding more hidden layers 2220 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 2200 depicted in the embodiment of FIG. 22, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 22 is presented as an exemplary ML solution that may be deployed within one or more methods or systems described herein.

In many embodiments, the input layer 2210 is the first layer in a neural network 2200 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 2200 are generally scaled i.e., normalized to have a zero mean and/or unit standard deviation. Scaling can also be applied to the input of hidden layers (using batch or layer normalization) to improve the stability of neural network 2200.

Unlike the hidden layers 2220 and output layers 2230, the input layer 2210 typically does not perform any computations or transformations on the data. Its primary function is often to pass the input data to the next layer in the network, the first hidden layer 2221. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 2210 itself does not modify the data, it sets the stage for the neural network to extract complex patterns and relationships through the deeper layers. This flexibility in handling various types of input make the neural network 2200 a powerful tool for a diverse set of applications.

With respect to the embodiments described herein, the input layer may be configured with a plurality of inputs providing input data 2250. As those skilled in the art will recognize, input data 2250 can vary in form, structure, or size based on the specific application desired. For example, in large language models, the input may be one or more tokens taken from an input provided by a user. The neural network 2200 may also be a more specific step or sub-step within a larger AI/ML system. In some embodiments, the neural network 2200 may be a part of a multi-layer perceptron within a large language model. However, as those skilled in the art will recognize, additional setups can be configured to format the input data 2250 in a satisfactory way prior to processing by the neural network 2200.

In a number of embodiments, the neural network 2200 may comprise a plurality of hidden layers 2220. The embodiment depicted in FIG. 22 comprises a first hidden layer 2221, a second hidden layer 2222, and an nth hidden layer 2225, which are denoted as h₁, h₂, and hn respectively. In many embodiments, the hidden layers 2220 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 2221 h₁ receives direct input from the input layer, transforming the raw data into an initial set of features. For example, in an image recognition task, this layer might begin identifying basic patterns, such as edges or simple textures. The output of the first hidden layer 2221 is then passed to a second hidden layer 2222 h₂, which builds upon the features identified by the first hidden layer 2221. This deeper layer might start recognizing more complex patterns, such as shapes or specific object components, by combining the lower-level features identified earlier. This can continue on until a last, nth hidden layer 2225 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 2221 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 2230 is often the final layer in a neural network and is responsible for producing the network's predictions or classifications based on the information processed through the previous hidden layers 2220. Each neuron in the output layer 2230 can represent a specific outcome or category that the model can predict. In the embodiment depicted in FIG. 22, the outputs are labeled as “output 1” to “output n,” indicating that the network can be designed to have a varying number of outputs depending on the nature of the problem being solved for. For example, in a binary classification task (e.g., an email is spam vs. an email is safe), there would typically be a single output neuron that provides a probability score for one of the two classes/outcomes. In contrast, for multi-class classification (e.g., determining an optimal path from many to transmit data), the output layer would contain multiple neurons, each corresponding to a different class.

The number of neurons in the output layer 2230 can also designed specifically for other types of tasks, such as regression, where the model can predict continuous values. In such cases, the output layer 2230 might contain a single neuron representing a numerical prediction, such as the price of a house or the temperature forecast, etc. Alternatively, in complex applications like multi-label classification (where each input can belong to multiple classes simultaneously), the output layer 2230 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 2200 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 22, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 22, which is an illustrative example meant to make it easier to explain the basic concepts of neural networks and how they process information. The specific features and functions described herein are not intended to be limiting to this specific embodiment. Additionally, the elements depicted in FIG. 22 may also be interchangeable with other elements of FIGS. 19-3 and 23-28 as required to realize a particularly desired embodiment.

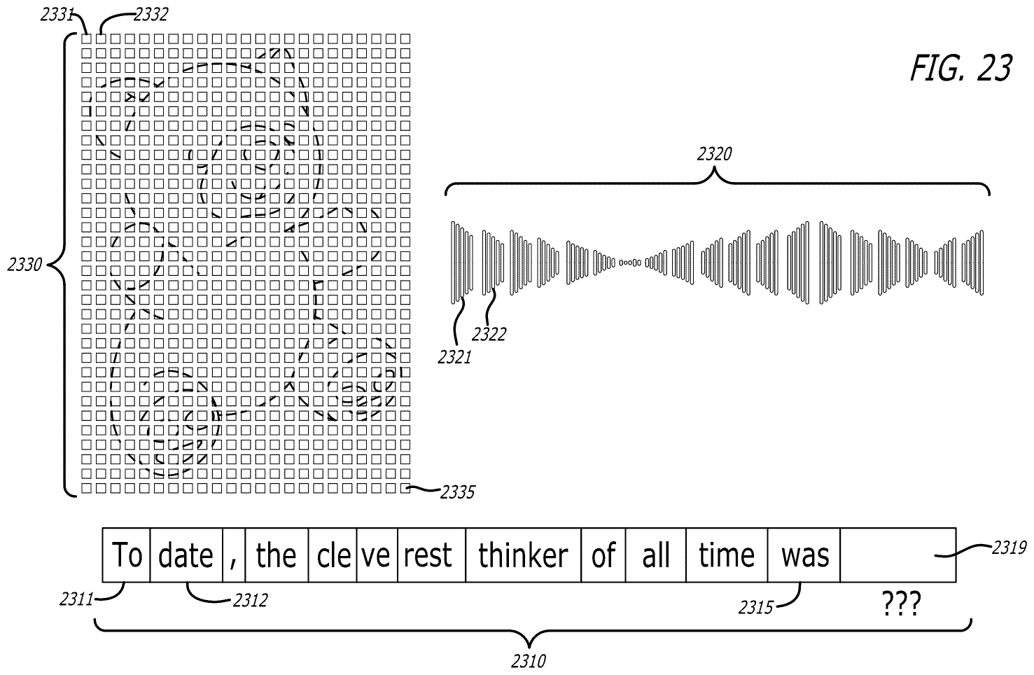

Referring to FIG. 23, a conceptual illustration of a variety of tokens for utilization within a large language model in accordance with various embodiments of the disclosure is shown. While most people are familiar with typing commands directly into a computer, interacting with a large language model (LLM) typically involves using prompts that are broken down into smaller units called tokens. These tokens can be segments of the original input prompt, such as individual words, subwords, or characters, allowing the model to process the prompt in manageable, structured pieces for a more nuanced understanding.

In fact, tokens are most often a fundamental unit of data used to represent a larger, general input for large language models (LLMs) and similar AI systems. In the context of LLMs, tokens are segments of text derived from the input prompt, where each token represents a manageable piece of the input, such as a word, part of a word, or a character. This segmentation can allow the model to break down complex text into simpler, consistent units that can be processed independently and then understood in relation to each other. By dividing input data into tokens, LLMs can handle language in a structured, flexible manner, adapting to diverse text inputs, from full sentences to specialized jargon or short phrases.

In many embodiments, tokens can serve as building blocks, enabling models to interpret language by analyzing these discrete parts and their relationships. For instance, in English, tokens often correspond to whole words, but when dealing with specialized vocabulary, slang, or languages with compound words, tokens might represent subwords or even single characters. This tokenization approach helps to maintain a balance between flexibility and precision, as smaller tokens allow the model to handle unfamiliar or highly specific terms more effectively. In a number of embodiments, each token can be encoded with a unique identifier that the model can use to differentiate it from others, preserving the distinct meaning or function it carries in context.

In the embodiment depicted in FIG. 23, a textual input prompt 2310 is shown as divided up into a plurality of tokens. A first token 2311 includes the word “To” while a second token comprises the next word “date”. In some embodiments, the first token 2311 can be configured to include the space between “To” and “date”. This small change can be utilized by the LLM to further divine meaning from the textual input prompt 2310. The number of tokens can vary depending on the type of input provided. This can extend from the first token 2311 to the nth or last token 2315 within the textual input prompt 2310. This last token 2319 can be utilized to indicate a requested or projected response 2319.

Beyond text, similar tokenization principles may apply to other data types when used in models that process audio or visual input. For audio data, tokenization can involve dividing a sound file into slices, where each token might represent a short segment of audio, perhaps a fraction of a second or a small, meaningful slice of a larger waveform. By breaking audio down in this way, the model can analyze specific sounds, pitches, or rhythms within the context of the entire recording. This segmentation enables the model to interpret audio inputs in a structured format, similar to how language is tokenized, making it easier to process complex auditory patterns and understand sounds in a sequential manner.

In the embodiment depicted in FIG. 23, the audio input prompt 2320 is shown divided into a plurality of audio slices. The first audio token 2321 comprises a number of samples within the audio input prompt 2320. Likewise, the second audio token 2322 comprises a second number of samples within the audio input prompt 2320. This slicing of the audio input prompt 2320 can continue throughout the rest of the remaining audio such that when all tokens have been processed, the system can determine a best guess for the next audio token that should be appended to the end of the audio input prompt 2320.

In the case of visual data, such as images, tokenization often involves segmenting the image into smaller chunks or patches, each of which becomes a visual token. These tokens represent different parts of the image, like color regions, edges, or textures, which the model can examine individually. Visual tokens enable the model to capture the intricate details within an image by focusing on manageable portions, while still considering their relationships to the broader visual structure. This approach allows AI systems to interpret complex images by analyzing these visual segments in the same way LLMs handle text tokens, offering a structured method for processing and understanding visual content.

In the embodiment depicted in FIG. 23, the image data prompt 2330 is divided into a plurality of smaller visual tokens. The first visual input token 2331 is shown as a small square portion of the original, larger image. This procedure of processing various chunks of the original image data prompt 2330 can occur on these smaller portions of the image, such as the second visual input token 2331, up to an including the nth visual input token 2339. Each of these smaller visual tokens can be processed individually, but often in parallel to each other.

The concept of tokens is therefore versatile, allowing diverse types of input, whether text, sound, or images, to be converted into standardized, model-friendly formats. Tokenization creates a consistent framework for representing complex data types in a way that artificial intelligence systems can process effectively. This segmentation enables each model, regardless of the input type, to dissect and examine different parts of the data with a fine level of granularity, which is especially important when working with highly detailed or nuanced inputs. This tokenized structure can enable the model to interpret the input systematically, providing a foundation for further processing and understanding of the information encapsulated within each token.

Although a specific embodiment for a variety of tokens for utilization within a large language model suitable for carrying out the various steps, processes, methods, and operations described herein is discussed with respect to FIG. 23, any of a variety of systems and/or processes may be utilized in accordance with embodiments of the disclosure. In many non-limiting examples, the type and number of tokens can vary depending on the specific application desired and/or the amount of available processing power available to handle the input prompt. The elements depicted in FIG. 23 may also be interchangeable with other elements of FIGS. 19-22 and 24-27 as required to realize a particularly desired embodiment.

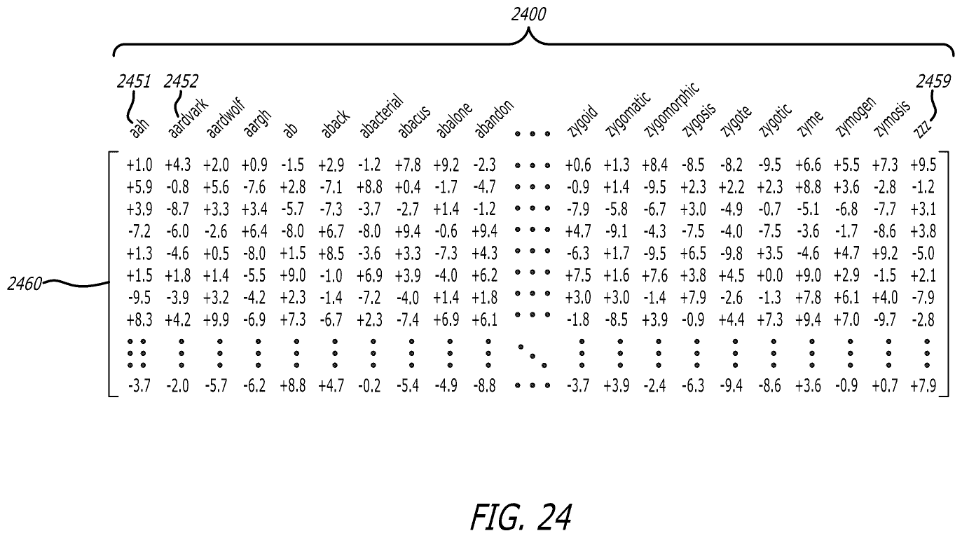

Referring to FIG. 24, a conceptual illustration of an embedding matrix 2400 for a large language model, in accordance with various embodiments of the disclosure is shown. In many embodiments of large language models (LLMs), embedding matrices are components that enable the model to interpret tokens in a mathematically accessible way. An embedding matrix 2400 is essentially a large table of vector representations, where each token in the model's vocabulary is assigned a unique vector, or array of numbers, that captures its initial meaning in relation to other tokens. When an input prompt is tokenized, each token can be matched with a corresponding entry in the embedding matrix 2400. In a number of embodiments, this lookup process can provide the token with an initial value, or embedding, which represents the token in a multi-dimensional space. These embeddings allow the model to recognize patterns, relationships, and meanings in language beyond simple string matching, forming the foundation for all further processing within the model.

In a number of embodiments, each entry in the embedding matrix 2400 is a vector of fixed size, with each dimension in the vector representing a distinct feature or aspect of the token's meaning. For example, words that are semantically or contextually similar may have embeddings that place them close to one another in this multi-dimensional space. This spatial relationship allows the model to capture a form of conceptual proximity wherein synonyms or related terms might occupy nearby areas in this space, while antonyms or unrelated words are farther apart. By assigning each token an embedding with specific values, the matrix can encode subtle linguistic and contextual information into numerical form, enabling the model to work with tokens in a highly structured, yet flexible, manner.

In the embodiment depicted in FIG. 24, the embedding matrix 2400 is associated with every known word in the English language. In other words, the matrix has a column associated with each of the around 50,000 or so words in English. Each column of the embedding matrix 2400 comprises a vector 2460 which associates the corresponding word to a location with a multi-dimensional space. For example, the first word 2451 “aah” has a corresponding vector 2460 from the first entry +1.0, to the nth entry −3.7. Likewise, the second word 2452 “aardvark” has another column of vector values associated with it starting at +4.3 and ending in-2.0. Finally, the nth word 2459 “zzz” is associated with a corresponding vector 2460 that includes the values in the column starting at +9.5 to +7.9. As each token is processed, it is assigned the corresponding vector 2460 taken from the embedding matrix 2400.

The embedding matrix 2400 is typically learned during the model's training phase. As the model is exposed to vast amounts of text, it iteratively adjusts the values in the embedding vectors to capture the relationships between tokens more accurately. Through this process, embeddings evolve to represent the associations, contexts, and distinctions that the model has observed across its training data. For instance, words that frequently appear together or in similar contexts may have embeddings that reflect this association. The embedding matrix 2400 thus serves as a kind of “knowledge base” for initial token relationships, giving the model a structured way to approach the vast variability in language.

This embedding approach is highly efficient because it enables the model to generalize across contexts and recognize similarities even with previously unseen tokens. For example, even if a token or phrase in a prompt has not been encountered during training, the model can infer its meaning based on the embeddings of other, similar tokens. This generalization is possible because embeddings capture both specific meanings and broader patterns, allowing the model to interpret novel inputs based on its learned understanding of language structure and relationships. By embedding tokens in a shared space, the model can gain a foundational understanding of language that it can apply across various prompts and contexts. This arrangement can allow the LLM to move beyond a rigid, word-by-word interpretation and instead engage with language as a rich network of interconnected meanings and ideas.

Although a specific embodiment for an embedding matrix for a large language model suitable for carrying out the various steps, processes, methods, and operations described herein is discussed with respect to FIG. 24, any of a variety of systems and/or processes may be utilized in accordance with embodiments of the disclosure. For example, similar concepts associated with the embedding matrix 2400 of FIG. 24 can be applied to other types of embedded matrices associated with other data types. It is contemplated that the embedding matrix is only limited by the types of input data that it is configured to process. The elements depicted in FIG. 24 may also be interchangeable with other elements of FIGS. 19-23 and FIGS. 25-27 as required to realize a particularly desired embodiment.

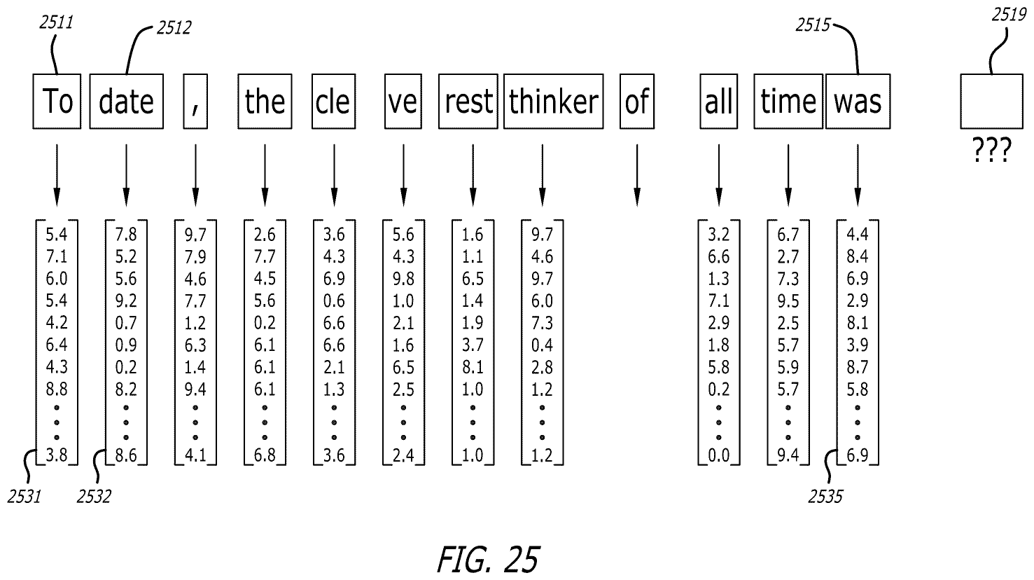

Referring to FIG. 25, a conceptual illustration of an input prompt converted from a series of tokens into a series of tensors in accordance with various embodiments of the disclosure is shown. In many embodiments, when an input prompt is converted into tokens, each of these tokens is then transformed through an embedding matrix to yield a unique vector representation, known as an embedding. This embedding is often a numerical array, or tensor, that encodes the token's position, context, and meaning within a multi-dimensional space. Essentially, once the tokenized prompt passes through the embedding matrix, each token is matched with a tensor that captures both its individual characteristics and its relationships to other tokens in the model's vocabulary. These tensors form the foundational representation of the prompt, providing structured data that the model can process to understand and generate contextually relevant responses.

Each tensor associated with a token after embedding can represent a fixed number of dimensions, often hundreds or even thousands, depending on the model's architecture. These dimensions give the tensor a rich structure, with each element in the tensor reflecting different features of the token's meaning. For instance, certain dimensions might encode aspects related to semantic similarity, part of speech, or contextual nuances observed during training. By encoding these complex features into a tensor, the model gains a detailed, flexible understanding of the token's role in the input prompt, which becomes critical for capturing context, sentiment, and intent in language processing tasks.

In various embodiments, the collection of tensors generated from the embedded tokens can create a high-dimensional representation of the entire prompt, with each tensor holding a unique set of values corresponding to its specific token. Because each tensor encodes information about a single token, the model can recognize patterns in the prompt by examining the relationships between these tensors. For example, words that often appear together may have similar values in certain dimensions of their tensors, allowing the model to capture implicit relationships and context within the input. This organized structure of tensors provides the model with a map of the prompt that it can analyze to make inferences about meaning, order, and emphasis.

In the embodiment depicted in FIG. 25, the first token 2511 is associated with the word “To” and has a corresponding tensor 2531 which is an array in multi-dimensional space. Likewise, the second token 2512 is associated with a second tensor 2532. Each token within the input prompt is subsequently associated with a corresponding tensor, up to the last and nth token 2515 which is associated with the nth tensor 2535. Processing these input prompt tokens will yield a projected or otherwise best fit for what the next token/word 2519 will be.

In further embodiments, the use of tensors can allow the model to handle complex language structures efficiently, as each token's tensor can interact with others in ways that reflect natural language dependencies. By representing each token as a tensor, the model can apply various mathematical operations across these tensors to analyze and synthesize information. These operations enable the model to determine which tokens are most relevant to one another within the context of the prompt. For instance, determining the vector difference between two related words like “man” and “woman” may be applied to a different context to determine similar words like applying that same vector difference to the vector associated with “uncle” to lead to the vector associated with the word “aunt”.

Although a specific embodiment for an input prompt converted from a series of tokens into a series of tensors suitable for carrying out the various steps, processes, methods, and operations described herein is discussed with respect to FIG. 25, any of a variety of systems and/or processes may be utilized in accordance with embodiments of the disclosure. For example, the number of elements within a tensor can number in the thousands, or even tens of thousands, depending on the complexity of the model. Additionally, in various embodiments, the position of the token within the input prompt can also be encoded within the tensor, which may be done by processing some additional value to the original tensor. The elements depicted in FIG. 25 may also be interchangeable with other elements of FIGS. 19-24 and FIGS. 26-28 as required to realize a particularly desired embodiment.

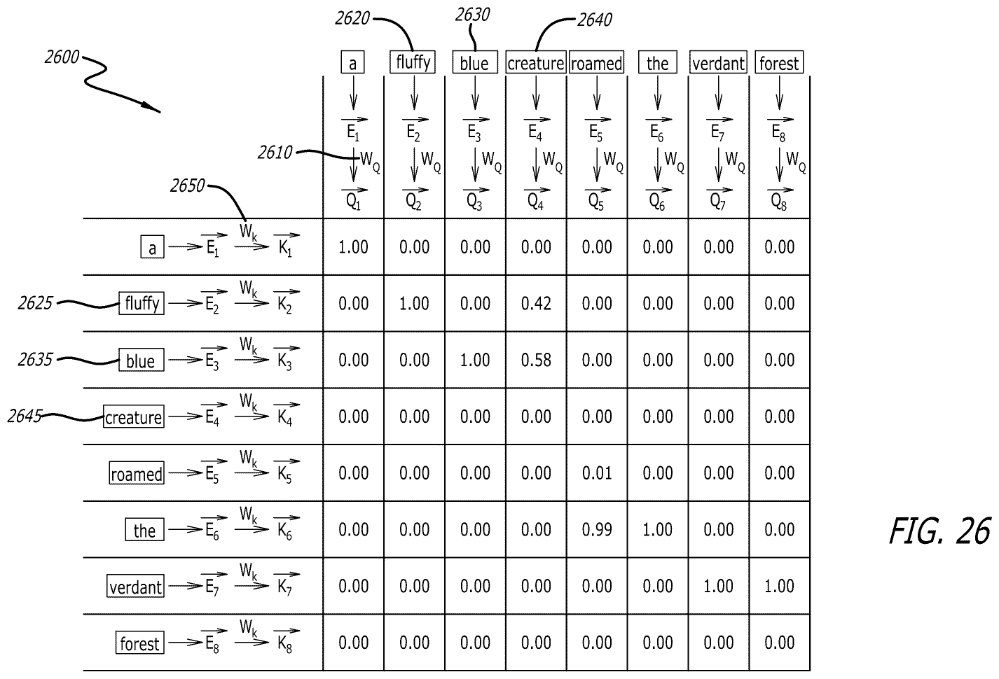

Referring to FIG. 26, a conceptual illustration of an attention layer process 2600 within a large language model in accordance with various embodiments of the disclosure is shown. When processing languages such as English, understanding the context of each word or token within an input prompt is beneficial. As such, many embodiments herein comprise at least one attention layer for processing the embedded tokens.

Take for example, the following three sentences: “I saw an American shrew mole,” “Measure one mole of carbon dioxide,” and “Take a biopsy of that mole”. Each of these sentences utilize the word “mole” in distinct contexts, demonstrating how language can carry multiple meanings based on surrounding words and phrases. In natural language processing, understanding these varied meanings requires the model to consider each token in relation to its neighbors, which is where attention layers become crucial. By focusing on the surrounding context of each instance of “mole,” an attention layer can discern whether it refers to an animal, a unit of chemical measurement, or a skin lesion. In many embodiments, the context, or set of nearby tokens, can allow the model to assign different meanings to “mole” depending on which other words are present, such as “American shrew” in the first case, “carbon dioxide” in the second, and “biopsy” in the third.

In a number of embodiments, attention layers can enable the model to weigh the relevance of each neighboring token to identify the specific meaning of “mole” in each phrase. For example, in “An American shrew mole,” the attention mechanism can emphasize the tokens “American” and “shrew,” which typically appear in contexts related to animals, thus guiding the model to interpret “mole” as a small mammal. Conversely, for the phrase “One mole of carbon dioxide,” however, the presence of “carbon dioxide” and the numerical term “one” shifts the focus toward scientific terminology, signaling that “mole” refers to a unit of chemical measurement. Similarly, in “Take a biopsy of that mole,” attention is drawn to the medical term “biopsy,” leading the model to interpret “mole” as a skin lesion. Through this mechanism, attention layers allow the model to dynamically adapt its understanding of words based on context, handling polysemous terms (words with multiple meanings) with greater accuracy.

In this way, attention layers can help the model “tease out” the correct meanings by selectively focusing on relevant tokens within the prompt. By assigning higher weights to contextually significant words, the model can make nuanced distinctions between different senses of the same token. This ability to disambiguate words based on context is essential for LLMs to generate accurate and meaningful responses, as it enables them to navigate the inherent complexity and flexibility of human language.

In literature, the generation of “attention” with these attention layers is described as:

$$Attention ( Q , K , V ) = soft max ( \frac{{QK}^{T}}{\sqrt{{d}_{k}}} ) V$$

Wherein Q represents the query matrix which itself is a placeholder for the “query” vectors derived from each embedded token in the input sequence. When processing language, each token (or word) is associated with a specific query vector that encodes what that token is “looking for” in other tokens within the sequence. In many embodiments, these query vectors are produced by multiplying the token embeddings by a learned weight matrix specific to the queries. The query serves as a way for the model to actively seek out relevant information from other tokens, allowing it to identify connections or dependencies between different parts of the sequence. Thus, queries capture the intention or focus of each token as it interacts with the rest of the input.

K is associated with the key matrix consisting of “key” vectors, which are similarly derived from the input sequence. Each token has an associated key vector that represents the essential information it holds. While queries represent what each token is searching for, keys encode what each token offers in terms of information. Keys are generated by multiplying token embeddings with a learned weight matrix distinct from that used for queries. The relationship between queries and keys determines how strongly one token will attend to another, allowing the model to weigh the relevance of each token to each other token within the sequence.

The term QK^{T} therefore represents the dot product between the query and key matrices. This operation calculates the similarity (or relevance) between each query vector and each key vector, effectively measuring how much attention one token should give to another. The resulting score indicates how strongly each token should focus on every other token, capturing the relationships within the input sequence. This relevance score is fundamental to the attention mechanism, as it serves as the basis for distributing focus across the sequence.

Within the above equation, V stands for “value”, insomuch as a value matrix contains “value” vectors, which can represent the actual content information associated with each token. Unlike queries and keys, which often work to determine the relevance of tokens to each other, values contain the data the model will pass along through the attention layer. Value vectors are produced by multiplying token embeddings with a learned weight matrix specific to values. These value vectors carry the contextual information that the model will use when constructing output, ensuring that the information emphasized by the attention mechanism is carried forward in processing.

The division by \sqrt{dₖ} is a scaling factor where dₖ denotes the dimensionality of the query and key vectors. Without this scaling, the dot product values in QK^{T} could become large as the number of dimensions increases, which would push the SoftMax function towards extreme values, creating an unstable learning process. By scaling with \sqrt{dₖ}, the model normalizes the scores, keeping gradients more manageable and stabilizing the SoftMax output, which aids in more effective learning and model convergence.

In the embodiment depicted in FIG. 26, an input prompt of “a fluffy blue creature roamed the verdant forest” is being processed through the attention filter 2600. Each of these tokens, such as the first token 2610 are subject to processing through a query vector 2610 shown as W_{Q}. In a very simplistic way (and described herein for illustrative purposes), the token has an associated query vector 2610 that can “ask” questions in a numerical way such as, but not limited to, “are there any adjectives in front of me”? In response, words that are adjectives before the creature token 2640 are more likely to be activated later on.

Specifically, each token has an associated vector/tensor written down herein as E₁, E₂ onward to E₈. Each of these vectors/tensors can be multiplied by or otherwise processed by a corresponding query matrix (shown as W_{Q}) to generate a query vector, denoted by Q₁, Q₂ onward to Q₈. Likewise, the same tokens, such as the first key token 2625, second key token 2635, and fourth key token 2645 can be processed through a key matrix (shown as Wₖ) to generate a corresponding key vectors denoted by K₁, K₂, and the like. Finally, for each token, the dot product of the query vector and key vector are determined. These values are then operated on through a type of SoftMax filter to generate a specific format of numbers such that each value will be placed between 0 and 1, and the sum off all values within a column shall be equal to 1. In this way, we can see that the “fluffy” token 2620 and “blue” token 2630 output a large value in association with the token “creature” as those tokens are adjectives describing the creature token 2640. Similar values appear when “the” and “verdant” are compared to the token “forest”.

In a variety of embodiments, the result of this dot product is an “attention vector” that can be added to the original vector such that a new modified attention vector is created. The goal is to move the vector associated with the token to a spot on the multi-dimensional space that is closer to other related terms. This output can then be sent to one or more multi-layer perceptron (MLPs).

Although a specific embodiment for an attention layer process 2600 within a large language model suitable for carrying out the various steps, processes, methods, and operations described herein is discussed with respect to FIG. 26, any of a variety of systems and/or processes may be utilized in accordance with embodiments of the disclosure. For example, the process described herein with reference to FIG. 26 and the attention models is presented in a simplistic fashion in order to allow for increased comprehension. However, those skilled in the art would recognize that other steps or attention model types may be utilized such as, but not limited to multi-head attention, and multi-head attention. The elements depicted in FIG. 26 may also be interchangeable with other elements of FIGS. 19-25 and FIG. 27-28 as required to realize a particularly desired embodiment.

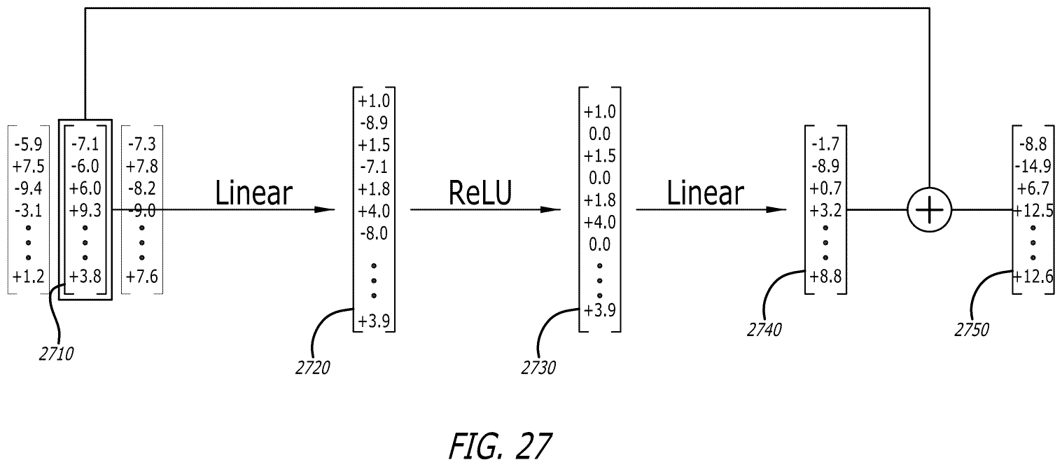

Referring to FIG. 27, a conceptual illustration of a multi-layer perceptron within a large language model in accordance with various embodiments of the disclosure is shown. In many embodiments within large language models (LLMs), multi-layer perceptrons (MLPs) play a role in refining and processing information after it has passed through the attention layers. MLPs, in the context of LLMs, are often positioned after each attention layer to add further transformations to the information embedded within each token. After the attention layer has modified each token's vector based on context and relationships with other tokens, this modified vector is then passed through an MLP. This MLP typically consists of a sequence of linear transformations, combined with a non-linear activation function, such as ReLU (Rectified Linear Unit). By applying these transformations, the MLP can help to fine-tune the representation of each token, capturing essential details and storing “factual” information that the model may rely on later.

The process can begin with a linear transformation, which expands the dimensions of the modified vector 2710, essentially mapping it to a higher-dimensional space. In the embodiment depicted in FIG. 27, the original modified vector 2710, which is typically an output of an attention layer, is processed through a linear transformation to yield a first output vector 2720. This initial expansion can allow the MLP to encode more complex information within each vector, giving it more capacity to capture and retain meaningful details.

After this expansion, various embodiments can apply a ReLU activation function, which introduces non-linearity into the processing. ReLU is particularly effective because it enables the model to focus on positive values within the vector, setting any negative values to zero. This step allows the model to highlight certain features within the token's vector while suppressing others, helping it differentiate important from less relevant information within the encoded representation. In the embodiment depicted in FIG. 27, the ReLU output vector 2730 is subsequently processed through another linear transformation.

In a number of embodiments, this second linear transformation can down-project the vector back to its original dimensionality. This step can ensure that the output from the MLP has the same dimensions as the input vector, allowing for a consistent vector size across all layers. The output vector 2740 from this down-projection is then added back to the original modified vector from the attention layer, creating what's known as a residual connection 2750. This residual connection 2750 combines the newly refined features from the MLP with the original contextual information produced by the attention layer. This approach enhances stability during training and allows the model to retain both the relational context and the refined factual details within the token's representation.

In the broader architecture of LLMs, MLPs are often considered the component where “facts” are stored. While the attention mechanism focuses on identifying relationships and associations between tokens, essentially, contextualizing each word within the sentence structure, the MLPs focus on enriching each token's representation with more granular, content-specific details. Through the repeated application of MLPs across multiple layers, the model can accumulate and consolidate information, effectively “remembering” facts and attributes associated with different words or phrases. This allows LLMs to recall specifics about language usage, word meanings, and even broader real-world information encoded in the training data.

In contrast, the attention layers are where the “associations” are stored, focusing on dynamically adjusting each token's focus depending on its context within the input sequence. Attention layers determine how strongly each token should relate to others, capturing nuances like syntax, grammar, and context-sensitive meanings. While attention layers dynamically build context, MLPs hold onto factual representations that serve as the knowledge base within each layer. Together, the attention and MLP layers enable the model to balance understanding relationships with retaining concrete information, resulting in a robust representation of both context and knowledge.

In a number of embodiments, input data often passes through multiple rounds of attention filters and multi-layer perceptron (MLP) layers, forming a sequence of transformations that incrementally refine the model's understanding of the input before reaching the final output stage. Each layer in the transformer model, the architecture commonly used for LLMs, includes both an attention component and an MLP component, with these two parts working in tandem to progressively deepen the model's comprehension of the text. This sequence is repeated over numerous layers, allowing the model to develop a sophisticated representation of the entire input sequence through cumulative transformations. By the end of these repeated passes, each token vector holds a highly nuanced, multi-dimensional understanding of the prompt. Once all layers have processed the data, the final, refined vectors proceed to the unembedding stage, where they are mapped back to language tokens that represent the model's predicted output.

Although a specific embodiment for a multi-layer perceptron within a large language model suitable for carrying out the various steps, processes, methods, and operations described herein is discussed with respect to FIG. 27, any of a variety of systems and/or processes may be utilized in accordance with embodiments of the disclosure. For example, as those skilled in the art will recognize, the specific layout and structure of the MLP layer can vary depending on the specific application desired. The elements depicted in FIG. 27 may also be interchangeable with other elements of FIGS. 19-26 and 28 as required to realize a particularly desired embodiment.

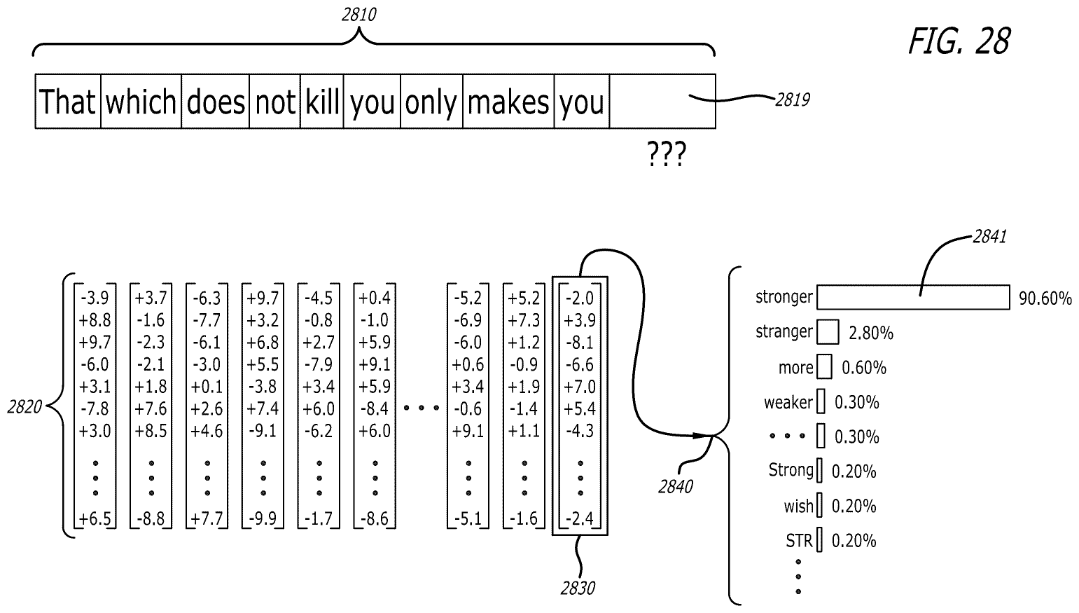

Referring to FIG. 28, a conceptual illustration of an unembedding process within a large language model in accordance with various embodiments of the disclosure is shown. In many embodiments, the final stage of a large language model's (LLM) processing is called unembedding, where it transforms the refined vectors from the last layer back into a probability distribution over potential output tokens. This stage is useful because it can allow the model to generate language tokens that represent the most likely continuations or responses to the input prompt. To achieve this, each vector (representing a token in the sequence) is mapped back to the model's vocabulary, which may contain tens of thousands of possible tokens. Unembedding utilizes a learned matrix, similar to the embedding matrix used at the input stage, but in reverse. Instead of converting tokens into vectors, it translates the processed vectors back into a set of potential language tokens that the model can output.

In a number of embodiments, the matrix output 2820 from the unembedding process is a final array 2830 where each entry corresponds to a probability score for a potential token. This probability distribution indicates how likely each word or phrase is to follow the input sequence, based on the context the model has built through its layers of attention and MLP processing. For instance, if the input prompt 2810, such as in the embodiment depicted in FIG. 28, is “That which does not kill you only makes you,” the unembedding process will produce a ranked list of possible next words. In this case, the word “stronger” might appear as the most probable continuation, with a high probability score. In FIG. 28, the probability of the “stronger” token response 2841 within the list of possible token responses 2840 is shown as 90.60 percent. This reflects the model's understanding of common phraseology and context, identifying “stronger” as a likely completion due to its frequency and relevance in similar contexts within the training data.

The ranked list produced during unembedding may include other potential outputs, each with an associated probability score that indicates its relative likelihood. For example, the word “stranger” could appear as a less probable continuation, with a probability of 2.80 percent, still present in the ranked list but much lower than “stronger.” This ranking reflects the model's capacity to recognize alternative continuations, including those that might follow less conventional but still possible language patterns. Other words, such as “more” or “weaker,” may also appear on this list, each with its own probability based on the contextual and semantic associations the model has learned. This probabilistic approach allows the model to produce flexible responses and make informed guesses about the next token in a way that mimics human language prediction.

The unembedding process may not only provide a ranked list of potential next words but also enable the model to maintain flexibility in generating responses. Depending on the application, the model might choose the highest-ranked token for a precise and likely output, or it could sample from the probability distribution to introduce variability, which can be useful in creative text generation or conversational applications. By examining the distribution of probabilities across potential tokens, the model can adapt its output strategy to different tasks, choosing the most probable word for accuracy or exploring lesser probable options for creative responses. This versatility is one of the reasons LLMs are effective across diverse language tasks, from completing sentences to generating open-ended stories.

The probability distribution generated in the unembedding phase reflects the culmination of all previous processing steps, encapsulating the context, associations, and factual information encoded within the model. Each token's probability is informed by the layers of attention and MLP transformations, which allow the model to build a nuanced understanding of the input. By ranking potential outputs, the model can provide a final “decision” on the next token based on its understanding, with the unembedding process acting as a bridge between the abstract, high-dimensional vector space within the model and the concrete language output we sec.

In further embodiments, the LLM can generate entire sequences of text by using its own output as the input for subsequent steps, allowing it to create a series of tokens that form coherent responses or passages. Once the model generates a probable next token, it can feed this token back into its input pipeline, treating it as the next part of the prompt. This iterative process enables the model to build on each newly generated token, maintaining continuity and context with each step. For example, if the initial prompt is “The sky is,” and the model predicts “blue” as the most probable next word, it can then take “The sky is blue” as the new input. By repeating this cycle, the LLM can produce extended responses, updating its understanding of context and adjusting its predictions as it goes along. This feedback loop allows the model to generate complex, contextually aligned sequences, whether for completing sentences, generating stories, or engaging in conversational responses, all by sequentially predicting and incorporating each token into its evolving context.

Although a specific embodiment for an unembedding process within a large language model suitable for carrying out the various steps, processes, methods, and operations described herein is discussed with respect to FIG. 28, any of a variety of systems and/or processes may be utilized in accordance with embodiments of the disclosure. For example, the output for other types of models can be token related to images, sounds, or other data format types. The elements depicted in FIG. 28 may also be interchangeable with other elements of FIGS. 19-27 as required to realize a particularly desired embodiment.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and may want information about the computing environment that can aid the entity in understanding whether the computing environment is operating efficiently and for its intended purpose.

Collection and analysis of the data from a computing environment can be performed by a data intake and query system such as is described herein. A data intake and query system can ingest and store data obtained from the components in a computing environment, and can enable an entity to search, analyze, and visualize the data. Through these and other capabilities, the data intake and query system can enable an entity to use the data for administration of the computing environment, to detect security issues, to understand how the computing environment is performing or being used, and/or to perform other analytics.

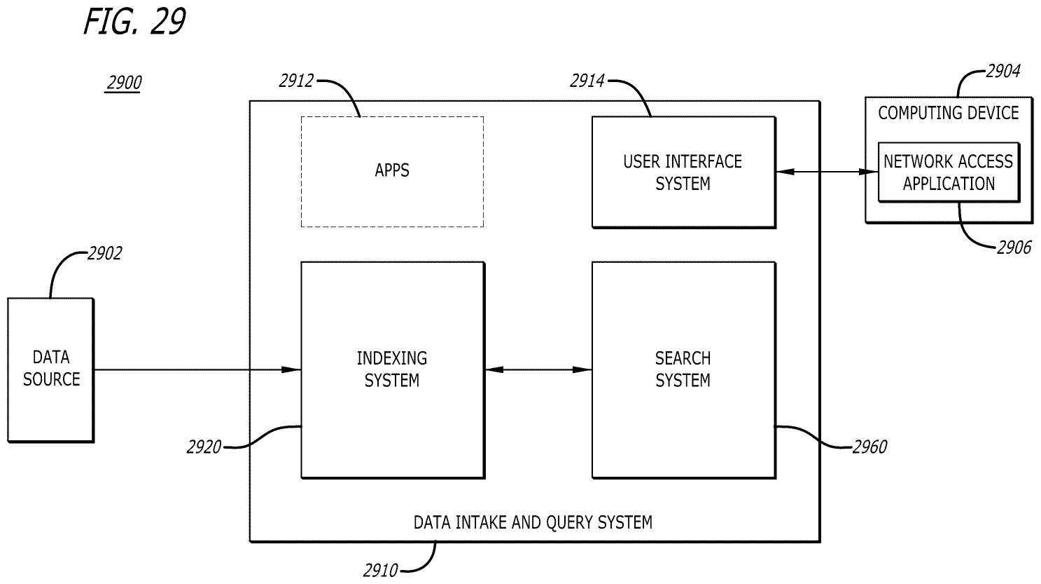

FIG. 29 is a block diagram illustrating an example computing environment 2900 that includes a data intake and query system 2910. The data intake and query system 2910 obtains data from a data source 2902 in the computing environment 2900 and ingests the data using an indexing system 2920. A search system 2960 of the data intake and query system 2910 enables users to navigate the indexed data. Though drawn with separate boxes in FIG. 29, in some implementations the indexing system 2920 and the search system 2960 can have overlapping components. A computing device 2904, running a network access application 2906, can communicate with the data intake and query system 2910 through a user interface system 2914 of the data intake and query system 2910. Using the computing device 2904, a user can perform various operations with respect to the data intake and query system 2910, such as administration of the data intake and query system 2910, management and generation of “knowledge objects,” (user-defined entities for enriching data, such as saved searches, event types, tags, field extractions, lookups, reports, alerts, data models, workflow actions, and fields), initiating of searches, and generation of reports, among other operations. The data intake and query system 2910 can further optionally include apps 2912 that extend the search, analytics, and/or visualization capabilities of the data intake and query system 2910.

The data intake and query system 2910 can be implemented using program code that can be executed using a computing device. A computing device is an electronic device that has a memory for storing program code instructions and a hardware processor for executing the instructions. The computing device can further include other physical components, such as a network interface or components for input and output. The program code for the data intake and query system 2910 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for the data intake and query system 2910 can be executed on a single computing device, or execution of the program code can be distributed over multiple computing devices. For example, the program code can include instructions for both indexing and search components (which may be part of the indexing system 2920 and/or the search system 2960, respectively), which can be executed on a computing device that also provides the data source 2902. As another example, the program code can be executed on one computing device, where execution of the program code provides both indexing and search components, while another copy of the program code executes on a second computing device that provides the data source 2902. As another example, the program code can be configured such that, when executed, the program code implements only an indexing component or only a search component. In this example, a first instance of the program code that is executing the indexing component and a second instance of the program code that is executing the search component can be executing on the same computing device or on different computing devices.

The data source 2902 of the computing environment 2900 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide the data source 2902 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 2920 obtains machine date from the data source 2902 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. The indexing system 2920 does not require prior knowledge of the structure of incoming data (e.g., the indexing system 2920 does not need to be provided with a schema describing the data). Additionally, the indexing system 2920 retains a copy of the data as it was received by the indexing system 2920 such that the original data is always available for searching (e.g., no data is discarded, though, in some examples, the indexing system 2920 can be configured to do so).

The search system 2960 searches the data stored by the indexing 2920 system. As discussed in greater detail below, the search system 2960 enables users associated with the computing environment 2900 (and possibly also other users) to navigate the data, generate reports, and visualize search results in “dashboards” output using a graphical interface. Using the facilities of the search system 2960, users can obtain insights about the data, such as retrieving events from an index, calculating metrics, searching for specific conditions within a rolling time window, identifying patterns in the data, and predicting future trends, among other examples. To achieve greater efficiency, the search system 2960 can apply map-reduce methods to parallelize searching of large volumes of data. Additionally, because the original data is available, the search system 2960 can apply a schema to the data at search time. This allows different structures to be applied to the same data, or for the structure to be modified if or when the content of the data changes. Application of a schema at search time may be referred to herein as a late-binding schema technique.

The user interface system 2914 provides mechanisms through which users associated with the computing environment 2900 (and possibly others) can interact with the data intake and query system 2910. These interactions can include configuration, administration, and management of the indexing system 2920, initiation and/or scheduling of queries that are to be processed by the search system 2960, receipt or reporting of search results, and/or visualization of search results. The user interface system 2914 can include, for example, facilities to provide a command line interface or a web-based interface.

Users can access the user interface system 2914 using a computing device 2904 that communicates with data intake and query system 2910, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with the computing environment 2900. For example, a person can log in as a particular user and, using the user's digital information, can access the data intake and query system 2910. A user can be associated with one or more people, meaning that one or more people may be able to use the same user's digital information. For example, an administrative user account may be used by multiple people who have been given access to the administrative user account. Alternatively or additionally, a user can be associated with another digital entity, such as a bot (e.g., a software program that can perform autonomous tasks). A user can also be associated with one or more entities. For example, a company can have associated with it a number of users. In this example, the company may control the users' digital information, including assignment of user identifiers, management of security credentials, control of which persons are associated with which users, and so on.

The computing device 2904 can provide a human-machine interface through which a person can have a digital presence in the computing environment 2900 in the form of a user. The computing device 2904 is an electronic device having one or more processors and a memory capable of storing instructions for execution by the one or more processors. The computing device 2904 can further include input/output (I/O) hardware and a network interface. Applications executed by the computing device 2904 can include a network access application 2906, such as a web browser, which can use a network interface of the client computing device 2904 to communicate, over a network, with the user interface system 2914 of the data intake and query system 2910. The user interface system 2914 can use the network access application 2906 to generate user interfaces that enable a user to interact with the data intake and query system 2910. A web browser is one example of a network access application. A shell tool can also be used as a network access application. In some examples, the data intake and query system 2910 is an application executing on the computing device 2906. In such examples, the network access application 2906 can access the user interface system 2914 without going over a network.

The data intake and query system 2910 can optionally include apps 2912. An app of the data intake and query system 2910 is a collection of configurations, knowledge objects (a user-defined entity that enriches the data in the data intake and query system 2910), views, and dashboards that may provide additional functionality, different techniques for searching the data, and/or additional insights into the data. The data intake and query system 2910 can execute multiple applications simultaneously. Example applications include an information technology service intelligence application, which can monitor and analyze the performance and behavior of the computing environment 2900, and an enterprise security application, which can include content and searches to assist security analysts in diagnosing and acting on anomalous or malicious behavior in the computing environment 2900.

Though FIG. 29 illustrates only one data source, in practical implementations, the computing environment 2900 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of the computing environment 2900, the data intake and query system 2910 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, the computing environment 2900 can include on-prem and cloud-based computing resources, or only cloud-based resources. For example, an entity may have on-prem computing devices and a private cloud. In this example, the entity operates the data intake and query system 2910 and can choose to execute the data intake and query system 2910 on an on-prem computing device or in the cloud. In another example, a provider entity operates the data intake and query system 2910 in a public cloud and provides the functionality of the data intake and query system 2910 as a service, for example under a Software-as-a-Service (SaaS) model, to entities that pay for the user of the service on a subscription basis. In this example, the provider entity can provision a separate tenant (or possibly multiple tenants) in the public cloud network for each subscriber entity, where each tenant executes a separate and distinct instance of the data intake and query system 2910. In some implementations, the entity providing the data intake and query system 2910 is itself subscribing to the cloud services of a cloud service provider. As an example, a first entity provides computing resources under a public cloud service model, a second entity subscribes to the cloud services of the first provider entity and uses the cloud computing resources to operate the data intake and query system 2910, and a third entity can subscribe to the services of the second provider entity in order to use the functionality of the data intake and query system 2910. In this example, the data sources are associated with the third entity, users accessing the data intake and query system 2910 are associated with the third entity, and the analytics and insights provided by the data intake and query system 2910 are for purposes of the third entity's operations.

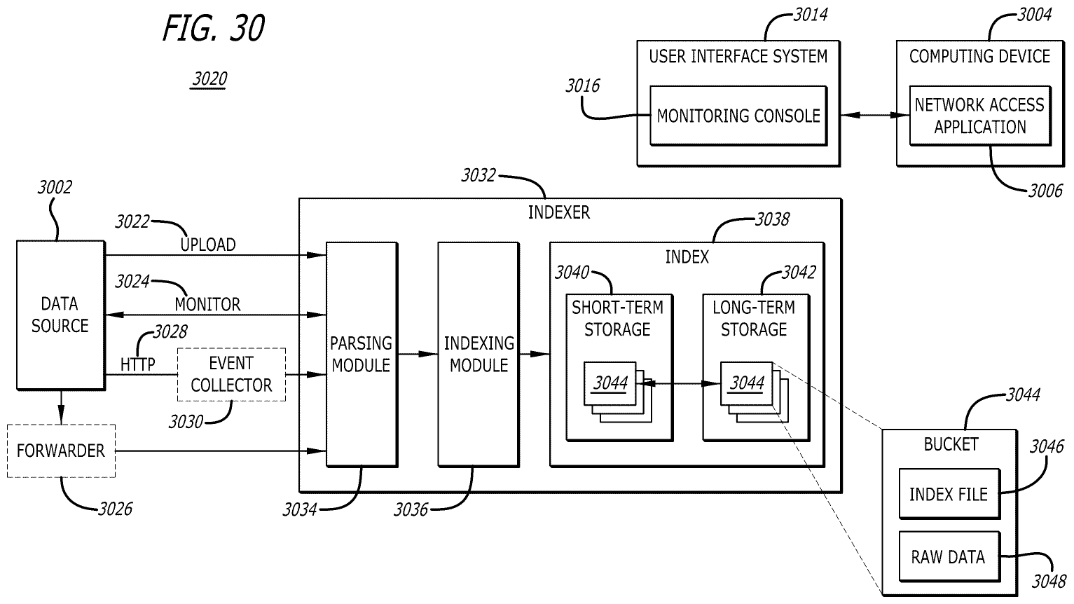

FIG. 30 is a block diagram illustrating in greater detail an example of an indexing system 3020 of a data intake and query system, such as the data intake and query system 2910 of FIG. 29. The indexing system 3020 of FIG. 30 uses various methods to obtain machine data from a data source 3002 and stores the data in an index 3038 of an indexer 3032. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 3020 enables the data intake and query system to obtain the machine data produced by the data source 3002 and to store the data for searching and retrieval.

Users can administer the operations of the indexing system 3020 using a computing device 3004 that can access the indexing system 3020 through a user interface system 3014 of the data intake and query system. For example, the computing device 3004 can be executing a network access application 3006, such as a web browser or a terminal, through which a user can access a monitoring console 3016 provided by the user interface system 3014. The monitoring console 3016 can enable operations such as: identifying the data source 3002 for data ingestion; configuring the indexer 3032 to index the data from the data source 3032; configuring a data ingestion method; configuring, deploying, and managing clusters of indexers; and viewing the topology and performance of a deployment of the data intake and query system, among other operations. The operations performed by the indexing system 3020 may be referred to as “index time” operations, which are distinct from “search time” operations that are discussed further below.

The indexer 3032, which may be referred to herein as a data indexing component, coordinates and performs most of the index time operations. The indexer 3032 can be implemented using program code that can be executed on a computing device. The program code for the indexer 3032 can be stored on a non-transitory computer-readable medium (e.g. a magnetic, optical, or solid state storage disk, a flash memory, or another type of non-transitory storage media), and from this medium can be loaded or copied to the memory of the computing device. One or more hardware processors of the computing device can read the program code from the memory and execute the program code in order to implement the operations of the indexer 3032. In some implementations, the indexer 3032 executes on the computing device 3004 through which a user can access the indexing system 3020. In some implementations, the indexer 3032 executes on a different computing device than the illustrated computing device 3004.

The indexer 3032 may be executing on the computing device that also provides the data source 3002 or may be executing on a different computing device. In implementations wherein the indexer 3032 is on the same computing device as the data source 3002, the data produced by the data source 3002 may be referred to as “local data.” In other implementations the data source 3002 is a component of a first computing device and the indexer 3032 executes on a second computing device that is different from the first computing device. In these implementations, the data produced by the data source 3002 may be referred to as “remote data.” In some implementations, the first computing device is “on-prem” and in some implementations the first computing device is “in the cloud.” In some implementations, the indexer 3032 executes on a computing device in the cloud and the operations of the indexer 3032 are provided as a service to entities that subscribe to the services provided by the data intake and query system.

For a given data produced by the data source 3002, the indexing system 3020 can be configured to use one of several methods to ingest the data into the indexer 3032. These methods include upload 3022, monitor 3024, using a forwarder 3026, or using HyperText Transfer Protocol (HTTP 3028) and an event collector 3030. These and other methods for data ingestion may be referred to as “getting data in” (GDI) methods.

Using the upload 3022 method, a user can specify a file for uploading into the indexer 3032. For example, the monitoring console 3016 can include commands or an interface through which the user can specify where the file is located (e.g., on which computing device and/or in which directory of a file system) and the name of the file. The file may be located at the data source 3002 or maybe on the computing device where the indexer 3032 is executing. Once uploading is initiated, the indexer 3032 processes the file, as discussed further below. Uploading is a manual process and occurs when instigated by a user. For automated data ingestion, the other ingestion methods are used.

The monitor 3024 method enables the indexing system 3002 to monitor the data source 3002 and continuously or periodically obtain data produced by the data source 3002 for ingestion by the indexer 3032. For example, using the monitoring console 3016, a user can specify a file or directory for monitoring. In this example, the indexing system 3002 can execute a monitoring process that detects whenever the file or directory is modified and causes the file or directory contents to be sent to the indexer 3032. As another example, a user can specify a network port for monitoring. In this example, a monitoring process can capture data received at or transmitting from the network port and cause the data to be sent to the indexer 3032. In various examples, monitoring can also be configured for data sources such as operating system event logs, performance data generated by an operating system, operating system registries, operating system directory services, and other data sources.

Monitoring is available when the data source 3002 is local to the indexer 3032 (e.g., the data source 3002 is on the computing device where the indexer 3032 is executing). Other data ingestion methods, including forwarding and the event collector 3030, can be used for either local or remote data sources.

A forwarder 3026, which may be referred to herein as a data forwarding component, is a software process that sends data from the data source 3002 to the indexer 3032. The forwarder 3026 can be implemented using program code that can be executed on the computer device that provides the data source 3002. A user launches the program code for the forwarder 3026 on the computing device that provides the data source 3002. The user can further configure the forwarder 3026, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 3026 can provide various capabilities. For example, the forwarder 3026 can send the data unprocessed or can perform minimal processing on the data before sending the data to the indexer 3032. Minimal processing can include, for example, adding metadata tags to the data to identify a source, source type, and/or host, among other information, dividing the data into blocks, and/or applying a timestamp to the data. In some implementations, the forwarder 3026 can break the data into individual events (event generation is discussed further below) and send the events to a receiver. Other operations that the forwarder 3026 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator).

The event collector 3030 provides an alternate method for obtaining data from the data source 3002. The event collector 3030 enables data and application events to be sent to the indexer 3032 using HTTP 3028. The event collector 3030 can be implemented using program code that can be executing on a computing device. The program code may be a component of the data intake and query system or can be a standalone component that can be executed independently of the data intake and query system and operates in cooperation with the data intake and query system.

To use the event collector 3030, a user can, for example using the monitoring console 3016 or a similar interface provided by the user interface system 3014, enable the event collector 3030 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by the data source 3002 as an alternative method to using a username and password for authentication.

To send data to the event collector 3030, the data source 3002 is supplied with a token and can then send HTTP 3028 requests to the event collector 3030. To send HTTP 3028 requests, the data source 3002 can be configured to use an HTTP client and/or to use logging libraries such as those supplied by Java, JavaScript, and .NET libraries. An HTTP client enables the data source 3002 to send data to the event collector 3030 by supplying the data, and a Uniform Resource Identifier (URI) for the event collector 3030 to the HTTP client. The HTTP client then handles establishing a connection with the event collector 3030, transmitting a request containing the data, closing the connection, and receiving an acknowledgment if the event collector 3030 sends one. Logging libraries enable HTTP 3028 requests to the event collector 3030 to be generated directly by the data source. For example, an application can include or link a logging library, and through functionality provided by the logging library manage establishing a connection with the event collector 3030, transmitting a request, and receiving an acknowledgement.

An HTTP 3028 request to the event collector 3030 can contain a token, a channel identifier, event metadata, and/or event data. The token authenticates the request with the event collector 3030. The channel identifier, if available in the indexing system 3020, enables the event collector 3030 to segregate and keep separate data from different data sources. The event metadata can include one or more key-value pairs that describe the data source 3002 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, the event collector 3030 extracts events from HTTP 3028 requests and sends the events to the indexer 3032. The event collector 3030 can further be configured to send events to one or more indexers. Extracting the events can include associating any metadata in a request with the event or events included in the request. In these implementations, event generation by the indexer 3032 (discussed further below) is bypassed, and the indexer 3032 moves the events directly to indexing. In some implementations, the event collector 3030 extracts event data from a request and outputs the event data to the indexer 3032, and the indexer generates events from the event data. In some implementations, the event collector 3030 sends an acknowledgement message to the data source 3002 to indicate that the event collector 3030 has received a particular request form the data source 3002, and/or to indicate to the data source 3002 that events in the request have been added to an index.

The indexer 3032 ingests incoming data and transforms the data into searchable knowledge in the form of events. In the data intake and query system, an event is a single piece of data that represents activity of the component represented in FIG. 30 by the data source 3002. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 3032 can include a parsing module 3034 and an indexing module 3036 for generating and storing the events. The parsing module 3034 and indexing module 3036 can be modular and pipelined, such that one component can be operating on a first set of data while the second component is simultaneously operating on a second sent of data. Additionally, the indexer 3032 may at any time have multiple instances of the parsing module 3034 and indexing module 3036, with each set of instances configured to simultaneously operate on data from the same data source or from different data sources. The parsing module 3034 and indexing module 3036 are illustrated in FIG. 30 to facilitate discussion, with the understanding that implementations with other components are possible to achieve the same functionality.

The parsing module 3034 determines information about incoming event data, where the information can be used to identify events within the event data. For example, the parsing module 3034 can associate a source type with the event data. A source type identifies the data source 3002 and describes a possible data structure of event data produced by the data source 3002. For example, the source type can indicate which fields to expect in events generated at the data source 3002 and the keys for the values in the fields, and possibly other information such as sizes of fields, an order of the fields, a field separator, and so on. The source type of the data source 3002 can be specified when the data source 3002 is configured as a source of event data. Alternatively, the parsing module 3034 can determine the source type from the event data, for example from an event field in the event data or using machine learning techniques applied to the event data.

Other information that the parsing module 3034 can determine includes timestamps. In some cases, an event includes a timestamp as a field, and the timestamp indicates a point in time when the action represented by the event occurred or was recorded by the data source 3002 as event data. In these cases, the parsing module 3034 may be able to determine from the source type associated with the event data that the timestamps can be extracted from the events themselves. In some cases, an event does not include a timestamp and the parsing module 3034 determines a timestamp for the event, for example from a name associated with the event data from the data source 3002 (e.g., a file name when the event data is in the form of a file) or a time associated with the event data (e.g., a file modification time). As another example, when the parsing module 3034 is not able to determine a timestamp from the event data, the parsing module 3034 may use the time at which it is indexing the event data. As another example, the parsing module 3034 can use a user-configured rule to determine the timestamps to associate with events.

The parsing module 3034 can further determine event boundaries. In some cases, a single line (e.g., a sequence of characters ending with a line termination) in event data represents one event while in other cases, a single line represents multiple events. In yet other cases, one event may span multiple lines within the event data. The parsing module 3034 may be able to determine event boundaries from the source type associated with the event data, for example from a data structure indicated by the source type. In some implementations, a user can configure rules the parsing module 3034 can use to identify event boundaries.

The parsing module 3034 can further extract data from events and possibly also perform transformations on the events. For example, the parsing module 3034 can extract a set of fields (key-value pairs) for each event, such as a host or hostname, source or source name, and/or source type. The parsing module 3034 may extract certain fields by default or based on a user configuration. Alternatively or additionally, the parsing module 3034 may add fields to events, such as a source type or a user-configured field. As another example of a transformation, the parsing module 3034 can anonymize fields in events to mask sensitive information, such as social security numbers or account numbers. Anonymizing fields can include changing or replacing values of specific fields. The parsing component 3034 can further perform user-configured transformations.

The parsing module 3034 outputs the results of processing incoming event data to the indexing module 3036, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. The indexer 3032 can be configured to identify searchable segments that are parts of fields, searchable segments that are entire fields, or both. The parsing module 3034 organizes the searchable segments into a lexicon or dictionary for the event data, with the lexicon including each searchable segment (e.g., the field “src=10.10.1.1”) and a reference to the location of each occurrence of the searchable segment within the event data (e.g., the location within the event data of each occurrence of “src=10.10.1.1”). As discussed further below, the search system can use the lexicon, which is stored in an index file 3046, to find event data that matches a search query. In some implementations, segmentation can alternatively be performed by the forwarder 3026. Segmentation can also be disabled, in which case the indexer 3032 will not build a lexicon for the event data. When segmentation is disabled, the search system searches the event data directly.

Building index data structures generates the index 3038. The index 3038 is a storage data structure on a storage device (e.g., a disk drive or other physical device for storing digital data). The storage device may be a component of the computing device on which the indexer 3032 is operating (referred to herein as local storage) or may be a component of a different computing device (referred to herein as remote storage) that the indexer 3038 has access to over a network. The indexer 3032 can manage more than one index and can manage indexes of different types. For example, the indexer 3032 can manage event indexes, which impose minimal structure on stored data and can accommodate any type of data. As another example, the indexer 3032 can manage metrics indexes, which use a highly structured format to handle the higher volume and lower latency demands associated with metrics data.

The indexing module 3036 organizes files in the index 3038 in directories referred to as buckets. The files in a bucket 3044 can include raw data files, index files, and possibly also other metadata files. As used herein, “raw data” means data as when the data was produced by the data source 3002, without alteration to the format or content. As noted previously, the parsing component 3034 may add fields to event data and/or perform transformations on fields in the event data. Event data that has been altered in this way is referred to herein as enriched data. A raw data file 3048 can include enriched data, in addition to or instead of raw data. The raw data file 3048 may be compressed to reduce disk usage. An index file 3046, which may also be referred to herein as a “time-series index” or tsidx file, contains metadata that the indexer 3032 can use to search a corresponding raw data file 3048. As noted above, the metadata in the index file 3046 includes a lexicon of the event data, which associates each unique keyword in the event data with a reference to the location of event data within the raw data file 3048. The keyword data in the index file 3046 may also be referred to as an inverted index. In various implementations, the data intake and query system can use index files for other purposes, such as to store data summarizations that can be used to accelerate searches.

A bucket 3044 includes event data for a particular range of time. The indexing module 3036 arranges buckets in the index 3038 according to the age of the buckets, such that buckets for more recent ranges of time are stored in short-term storage 3040 and buckets for less recent ranges of time are stored in long-term storage 3042. Short-term storage 3040 may be faster to access while long-term storage 3042 may be slower to access. Buckets may be moves from short-term storage 3040 to long-term storage 3042 according to a configurable data retention policy, which can indicate at what point in time a bucket is old enough to be moved.

A bucket's location in short-term storage 3040 or long-term storage 3042 can also be indicated by the bucket's status. As an example, a bucket's status can be “hot,” “warm,” “cold,” “frozen,” or “thawed.” In this example, hot bucket is one to which the indexer 3032 is writing data and the bucket becomes a warm bucket when the index 3032 stops writing data to it. In this example, both hot and warm buckets reside in short-term storage 3040. Continuing this example, when a warm bucket is moved to long-term storage 3042, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

The indexing system 3020 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can be configured (e.g., three copies of each buckets must exist within the cluster), and indexers to which buckets are copied may be selected to optimize distribution of data across the cluster.

A user can view the performance of the indexing system 3020 through the monitoring console 3016 provided by the user interface system 3014. Using the monitoring console 3016, the user can configure and monitor an index cluster, and see information such as disk usage by an index, volume usage by an indexer, index and volume size over time, data age, statistics for bucket types, and bucket settings, among other information.

FIG. 31 is a block diagram illustrating in greater detail an example of the search system 3160 of a data intake and query system, such as the data intake and query system 2910 of FIG. 29. The search system 3160 of FIG. 31 issues a query 3166 to a search head 3162, which sends the query 3166 to a search peer 3164. Using a map process 3170, the search peer 3164 searches the appropriate index 3138 for events identified by the query 3166 and sends events 3178 so identified back to the search head 3162. Using a reduce process 3182, the search head 3162 processes the events 3178 and produces results 3168 to respond to the query 3166. The results 3168 can provide useful insights about the data stored in the index 3138. These insights can aid in the administration of information technology systems, in security analysis of information technology systems, and/or in analysis of the development environment provided by information technology systems.

The query 3166 that initiates a search is produced by a search and reporting app 3116 that is available through the user interface system 3114 of the data intake and query system. Using a network access application 3106 executing on a computing device 3104, a user can input the query 3166 into a search field provided by the search and reporting app 3116. Alternatively or additionally, the search and reporting app 3116 can include pre-configured queries or stored queries that can be activated by the user. In some cases, the search and reporting app 3116 initiates the query 3166 when the user enters the query 3166. In these cases, the query 3166 maybe referred to as an “ad-hoc” query. In some cases, the search and reporting app 3116 initiates the query 3166 based on a schedule. For example, the search and reporting app 3116 can be configured to execute the query 3166 once per hour, once per day, at a specific time, on a specific date, or at some other time that can be specified by a date, time, and/or frequency. These types of queries maybe referred to as scheduled queries.

The query 3166 is specified using a search processing language. The search processing language includes commands or search terms that the search peer 3164 will use to identify events to return in the search results 3168. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 3166 to include sequential commands, where a subsequent command may operate on the results of a prior command. As an example, sequential commands may be separated in the query 3166 by a vertical line (“|” or “pipe”) symbol.

In addition to one or more search commands, the query 3166 includes a time indicator. The time indicator limits searching to events that have timestamps described by the indicator. For example, the time indicator can indicate a specific point in time (e.g., 10:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of the search query 3166 occurs in two broad phases: a map phase 3150 and a reduce phase 3152. The map phase 3150 takes place across one or more search peers. In the map phase 3150, the search peers locate event data that matches the search terms in the search query 3166 and sorts the event data into field-value pairs. When the map phase 3150 is complete, the search peers send events that they have found to one or more search heads for the reduce phase 3152. During the reduce phase 3152, the search heads process the events through commands in the search query 3166 and aggregate the events to produce the final search results 3168.

A search head, such as the search head 3162 illustrated in FIG. 31, is a component of the search system 3160 that manages searches. The search head 3162, which may also be referred to herein as a search management component, can be implemented using program code that can be executed on a computing device. The program code for the search head 3162 can be stored on a non-transitory computer-readable medium and from this medium can be loaded or copied to the memory of a computing device. One or more hardware processors of the computing device can read the program code from the memory and execute the program code in order to implement the operations of the search head 3162.

Upon receiving the search query 3166, the search head 3162 directs the query 3166 to one or more search peers, such as the search peer 3164 illustrated in FIG. 31. “Search peer” is an alternate name for “indexer” and a search peer may be largely similar to the indexer described previously. The search peer 3164 may be referred to as a “peer node” when the search peer 3164 is part of an indexer cluster. The search peer 3164, which may also be referred to as a search execution component, can be implemented using program code that can be executed on a computing device. In some implementations, one set of program code implements both the search head 3162 and the search peer 3164 such that the search head 3162 and the search peer 3164 form one component. In some implementations, the search head 3162 is an independent piece of code that performs searching and no indexing functionality. In these implementations, the search head 3162 may be referred to as a dedicated search head.

The search head 3162 may consider multiple criteria when determining whether to send the query 3166 to the particular search peer 3164. For example, the search system 3160 may be configured to include multiple search peers that each have duplicative copies of at least some of the event data and are implanted using different hardware resources q. In this example, the sending the search query 3166 to more than one search peer allows the search system 3160 to distribute the search workload across different hardware resources. As another example, search system 3160 may include different search peers for different purposes (e.g., one has an index storing a first type of data or from a first data source while a second has an index storing a second type of data or from a second data source). In this example, the search query 3166 may specify which indexes to search, and the search head 3162 will send the query 3166 to the search peers that have those indexes.

To identify events 3178 to send back to the search head 3162, the search peer 3164 performs a map process 3170 to obtain event data 3174 from the index 3138 that is maintained by the search peer 3164. During a first phase of the map process 3170, the search peer 3164 identifies buckets that have events that are described by the time indicator in the search query 3166. As noted above, a bucket contains events whose timestamps fall within a particular range of time. For each bucket 3144 whose events can be described by the time indicator, during a second phase of the map process 3170, the search peer 3164 performs a keyword search 3174 using search terms specified in the search query 3166. The search terms can be one or more of keywords, phrases, fields, Boolean expressions, and/or comparison expressions that in combination describe events being searched for. When segmentation is enabled at index time, the search peer 3164 performs the keyword search 3172 on the bucket's index file 3146. As noted previously, the index file 3146 includes a lexicon of the searchable terms in the events stored in the bucket's raw data 3148 file. The keyword search 3172 searches the lexicon for searchable terms that correspond to one or more of the search terms in the query 3166. As also noted above, the lexicon incudes, for each searchable term, a reference to each location in the raw data 3148 file where the searchable term can be found. Thus, when the keyword search identifies a searchable term in the index file 3146 that matches a search term in the query 3166, the search peer 3164 can use the location references to extract from the raw data 3148 file the event data 3174 for each event that include the searchable term.

In cases where segmentation was disabled at index time, the search peer 3164 performs the keyword search 3172 directly on the raw data 3148 file. To search the raw data 3148, the search peer 3164 may identify searchable segments in events in a similar manner as when the data was indexed. Thus, depending on how the search peer 3164 is configured, the search peer 3164 may look at event fields and/or parts of event fields to determine whether an event matches the query 3166. Any matching events can be added to the event data 3174 read from the raw data 3148 file. The search peer 3164 can further be configured to enable segmentation at search time, so that searching of the index 3138 causes the search peer 3164 to build a lexicon in the index file 3146.

The event data 3174 obtained from the raw data 3148 file includes the full text of each event found by the keyword search 3172. During a third phase of the map process 3170, the search peer 3164 performs event processing 3176 on the event data 3174, with the steps performed being determined by the configuration of the search peer 3164 and/or commands in the search query 3166. For example, the search peer 3164 can be configured to perform field discovery and field extraction. Field discovery is a process by which the search peer 3164 identifies and extracts key-value pairs from the events in the event data 3174. The search peer 3164 can, for example, be configured to automatically extract the first 1900 fields (or another number of fields) in the event data 3174 that can be identified as key-value pairs. As another example, the search peer 3164 can extract any fields explicitly mentioned in the search query 3166. The search peer 3164 can, alternatively or additionally, be configured with particular field extractions to perform.

Other examples of steps that can be performed during event processing 3176 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 3164 sends processed events 3178 to the search head 3162, which performs a reduce process 3180. The reduce process 3180 potentially receives events from multiple search peers and performs various results processing 3182 steps on the received events. The results processing 3182 steps can include, for example, aggregating the events received from different search peers into a single set of events, deduplicating and aggregating fields discovered by different search peers, counting the number of events found, and sorting the events by timestamp (e.g., newest first or oldest first), among other examples. Results processing 3182 can further include applying commands from the search query 3166 to the events. The query 3166 can include, for example, commands for evaluating and/or manipulating fields (e.g., to generate new fields from existing fields or parse fields that have more than one value). As another example, the query 3166 can include commands for calculating statistics over the events, such as counts of the occurrences of fields, or sums, averages, ranges, and so on, of field values. As another example, the query 3166 can include commands for generating statistical values for purposes of generating charts of graphs of the events.

The reduce process 3180 outputs the events found by the search query 3166, as well as information about the events. The search head 3162 transmits the events and the information about the events as search results 3168, which are received by the search and reporting app 3116. The search and reporting app 3116 can generate visual interfaces for viewing the search results 3168. The search and reporting app 3116 can, for example, output visual interfaces for the network access application 3106 running on a computing device 3104 to generate.

The visual interfaces can include various visualizations of the search results 3168, such as tables, line or area charts, Choropleth maps, or single values. The search and reporting app 3116 can organize the visualizations into a dashboard, where the dashboard includes a panel for each visualization. A dashboard can thus include, for example, a panel listing the raw event data for the events in the search results 3168, a panel listing fields extracted at index time and/or found through field discovery along with statistics for those fields, and/or a timeline chart indicating how many events occurred at specific points in time (as indicated by the timestamps associated with each event). In various implementations, the search and reporting app 3116 can provide one or more default dashboards. Alternatively or additionally, the search and reporting app 3116 can include functionality that enables a user to configure custom dashboards.

The search and reporting app 3116 can also enable further investigation into the events in the search results 3116. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 3166. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

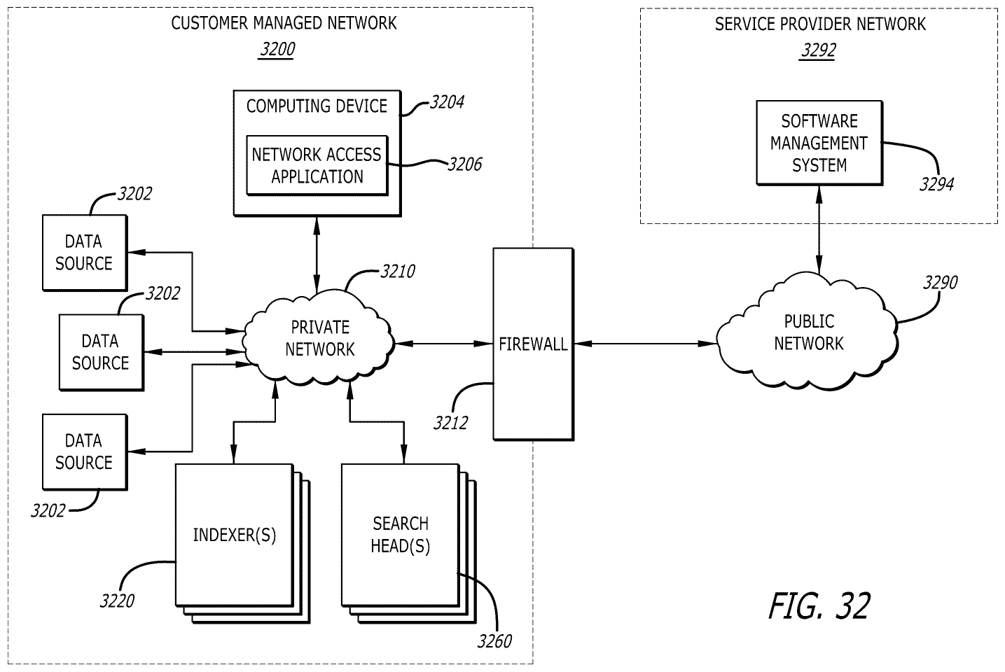

FIG. 32 illustrates an example of a self-managed network 3200 that includes a data intake and query system. “Self-managed” in this instance means that the entity that is operating the self-managed network 3200 configures, administers, maintains, and/or operates the data intake and query system using its own compute resources and people. Further, the self-managed network 3200 of this example is part of the entity's on-premise network and comprises a set of compute, memory, and networking resources that are located, for example, within the confines of a entity's data center. These resources can include software and hardware resources. The entity can, for example, be a company or enterprise, a school, government entity, or other entity. Since the self-managed network 3200 is located within the customer's on-prem environment, such as in the entity's data center, the operation and management of the self-managed network 3200, including of the resources in the self-managed network 3200, is under the control of the entity. For example, administrative personnel of the entity have complete access to and control over the configuration, management, and security of the self-managed network 3200 and its resources.

The self-managed network 3200 can execute one or more instances of the data intake and query system. An instance of the data intake and query system may be executed by one or more computing devices that are part of the self-managed network 3200. A data intake and query system instance can comprise an indexing system and a search system, where the indexing system includes one or more indexers 3220 and the search system includes one or more search heads 3260.

As depicted in FIG. 32, the self-managed network 3200 can include one or more data sources 3202. Data received from these data sources may be processed by an instance of the data intake and query system within self-managed network 3200. The data sources 3202 and the data intake and query system instance can be communicatively coupled to each other via a private network 3210.

Users associated with the entity can interact with and avail themselves of the functions performed by a data intake and query system instance using computing devices. As depicted in FIG. 32, a computing device 3204 can execute a network access application 3206 (e.g., a web browser), that can communicate with the data intake and query system instance and with data sources 3202 via the private network 3210. Using the computing device 3204, a user can perform various operations with respect to the data intake and query system, such as management and administration of the data intake and query system, generation of knowledge objects, and other functions. Results generated from processing performed by the data intake and query system instance may be communicated to the computing device 3204 and output to the user via an output system (e.g., a screen) of the computing device 3204.

The self-managed network 3200 can also be connected to other networks that are outside the entity's on-premise environment/network, such as networks outside the entity's data center. Connectivity to these other external networks is controlled and regulated through one or more layers of security provided by the self-managed network 3200. One or more of these security layers can be implemented using firewalls 3212. The firewalls 3212 form a layer of security around the self-managed network 3200 and regulate the transmission of traffic from the self-managed network 3200 to the other networks and from these other networks to the self-managed network 3200.

Networks external to the self-managed network can include various types of networks including public networks 3290, other private networks, and/or cloud networks provided by one or more cloud service providers. An example of a public network 3290 is the Internet. In the example depicted in FIG. 32, the self-managed network 3200 is connected to a service provider network 3292 provided by a cloud service provider via the public network 3290.

In some implementations, resources provided by a cloud service provider may be used to facilitate the configuration and management of resources within the self-managed network 3200. For example, configuration and management of a data intake and query system instance in the self-managed network 3200 may be facilitated by a software management system 3294 operating in the service provider network 3292. There are various ways in which the software management system 3294 can facilitate the configuration and management of a data intake and query system instance within the self-managed network 3200. As one example, the software management system 3294 may facilitate the download of software including software updates for the data intake and query system. In this example, the software management system 3294 may store information indicative of the versions of the various data intake and query system instances present in the self-managed network 3200. When a software patch or upgrade is available for an instance, the software management system 3294 may inform the self-managed network 3200 of the patch or upgrade. This can be done via messages communicated from the software management system 3294 to the self-managed network 3200.

The software management system 3294 may also provide simplified ways for the patches and/or upgrades to be downloaded and applied to the self-managed network 3200. For example, a message communicated from the software management system 3294 to the self-managed network 3200 regarding a software upgrade may include a Uniform Resource Identifier (URI) that can be used by a system administrator of the self-managed network 3200 to download the upgrade to the self-managed network 3200. In this manner, management resources provided by a cloud service provider using the service provider network 3292 and which are located outside the self-managed network 3200 can be used to facilitate the configuration and management of one or more resources within the entity's on-prem environment. In some implementations, the download of the upgrades and patches may be automated, whereby the software management system 3294 is authorized to, upon determining that a patch is applicable to a data intake and query system instance inside the self-managed network 3200, automatically communicate the upgrade or patch to self-managed network 3200 and cause it to be installed within self-managed network 3200.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A computer-implemented method, comprising:
receiving, by an orchestration agent, user input corresponding to a user question;
generating a response to the user question by:
generating, by the orchestration agent, a prompt instructing a first sub-large language model (LLM) to perform a first task, wherein the first sub-LLM is one of a plurality of sub-LLMs that may be invoked by the orchestration agent, wherein the first task includes one or more of generating, editing, or refining programming code,
in response to the prompt, generating, by the first sub-LLM, instructions for a second sub-LLM to perform a second task, wherein results of performing the second task by the second sub-LLM are provided to the first sub-LLM, and
performing, by the first sub-LLM, the first task utilizing the results of the second task generated by the second sub-LLM, wherein results of the first task include the programming code; and
generating, by the orchestration agent, a graphical user interface (GUI) that displays the response to the user question, wherein the response includes or is based on the programming code.

2. The computer-implemented method of claim 1, further comprising:
obtaining one or more metrics or metadata from a networking environment of a user that provided the user input, wherein the one or more metrics or metadata are included in the prompt generated by the orchestration agent.

3. The computer-implemented method of claim 1, wherein the second sub-LLM calls a first logic module to perform a third task, wherein results of performing the third task are utilized by the second sub-LLM in performing the second task.

4. The computer-implemented method of claim 1, wherein the second sub-LLM calls a first logic module to perform the second task.

5. The computer-implemented method of claim 1, further comprising:
executing, by either a third sub-LLM or a second logic module, the programming code.

6. The computer-implemented method of claim 5, wherein the response to the user question includes result of executing the programming code.

7. The computer-implemented method of claim 1, wherein the user question is received via a chat interface, and wherein the GUI includes a portion of the chat interface.

8. A computing device, comprising:
a processor; and
a non-transitory computer-readable medium having stored thereon instructions that, when executed by the processor, cause the processor to perform operations including:
receiving, by an orchestration agent, user input corresponding to a user question;
generating a response to the user question by:
generating, by the orchestration agent, a prompt instructing a first sub-large language model (LLM) to perform a first task, wherein the first sub-LLM is one of a plurality of sub-LLMs that may be invoked by the orchestration agent, wherein the first task includes one or more of generating, editing, or refining programming code,
in response to the prompt, generating, by the first sub-LLM, instructions for a second sub-LLM to perform a second task, wherein results of performing the second task by the second sub-LLM are provided to the first sub-LLM, and
performing, by the first sub-LLM, the first task utilizing the results of the second task generated by the second sub-LLM, wherein results of the first task include the programming code; and
generating, by the orchestration agent, a graphical user interface (GUI) that displays the response to the user question, wherein the response includes or is based on the programming code.

9. The computing device of claim 8, wherein the operations further comprise:
obtaining one or more metrics or metadata from a networking environment of a user that provided the user input, wherein the one or more metrics or metadata are included in the prompt generated by the orchestration agent.

10. The computing device of claim 8, wherein the second sub-LLM calls a first logic module to perform a third task, wherein results of performing the third task are utilized by the second sub-LLM in performing the second task.

11. The computing device of claim 8, wherein the second sub-LLM calls a first logic module to perform the second task.

12. The computing device of claim 11, wherein the operations further comprise:
executing, by either a third sub-LLM or a second logic module, the programming code.

13. The computing device of claim 12, wherein the response to the user question includes result of executing the programming code.

14. The computing device of claim 8, wherein the user question is received via a chat interface, and wherein the GUI includes a portion of the chat interface.

15. A non-transitory computer-readable medium having stored thereon instructions that, when executed by one or more processors, cause the one or more processor to perform operations including:
receiving, by an orchestration agent, user input corresponding to a user question;
generating a response to the user question by:
generating, by the orchestration agent, a prompt instructing a first sub-large language model (LLM) to perform a first task, wherein the first sub-LLM is one of a plurality of sub-LLMs that may be invoked by the orchestration agent, wherein the first task includes one or more of generating, editing, or refining programming code,
in response to the prompt, generating, by the first sub-LLM, instructions for a second sub-LLM to perform a second task, wherein results of performing the second task by the second sub-LLM are provided to the first sub-LLM, and
performing, by the first sub-LLM, the first task utilizing the results of the second task generated by the second sub-LLM, wherein results of the first task include the programming code; and
generating, by the orchestration agent, a graphical user interface (GUI) that displays the response to the user question, wherein the response includes or is based on the programming code.

16. The non-transitory computer-readable medium of claim 15, wherein the operations further comprise:
obtaining one or more metrics or metadata from a networking environment of a user that provided the user input, wherein the one or more metrics or metadata are included in the prompt generated by the orchestration agent.

17. The non-transitory computer-readable medium of claim 15, wherein the second sub-LLM calls a first logic module to perform a third task, wherein results of performing the third task are utilized by the second sub-LLM in performing the second task.

18. The non-transitory computer-readable medium of claim 15, wherein the second sub-LLM calls a first logic module to perform the second task.

19. The non-transitory computer-readable medium of claim 15, wherein the operations further comprise:
executing, by either a third sub-LLM or a second logic module, the programming code, and wherein the response to the user question includes result of executing the programming code.

20. The non-transitory computer-readable medium of claim 15, wherein the user question is received via a chat interface, and wherein the GUI includes a portion of the chat interface.
